(19) United States
(12) Patent Application Publication
(10) Pub. No.: US 2006/0069083 A1
(43) Pub. Date: Mar. 30, 2006

(54) Pesticidal dibenzo(hetero)azepine derivatives

(76) Inventors: Gerd Steiner, Kirchheim (DE); Livio Tedeschi, Mannheim (DE); Thomas Schmidt, Neustadt (DE); Ernst Baumann, Dudenhofen (DE); Wolfgang Von Deyn, Neustadt (DE); Markus Kordes, Frankenthal (DE); Michael Hofmann, Ludwigshafen (DE); Michael Puhl, Lampertheim (DE); Norbert Gotz, Worms (DE); Michael Rack, Heidelberg (DE); Liliana Parra Rapado, Mannheim (DE); Jacobus Jan De Kramer, Hochspeyer (DE); Gavin Heffernan, Florence, NJ (US); Deborah L Culbertson, Fuquay Varina, NC (US); Michael F Treacy, Corpus Christi, TX (US); Hassan Oloumi-Sadeghi, Raleigh, NC (US); Cecille Ebuenga, Laguna (PH); Toni Bucci, Fuquay Varina, NC (US)

Correspondence Address: HUTCHISON & MASON PLLC, PO BOX 31686, RALEIGH, NC, 27612, US

(21) Appl. No.: 10/539,643

(22) PCT Filed: Dec. 18, 2003
(86) PCT No.: PCT/EP03/14443

§ 371 Date: Jun. 16, 2005

Related U.S. Application Data
(60) Provisional application No. 60/434,801, filed on Dec. 20, 2002.

(51) Int. Cl. A01N 43/46; A01N 43/62; A01N 43/00

(52) U.S. Cl. 514/211.11; 514/220; 514/217

(57) ABSTRACT

Use of compounds of formula (I): 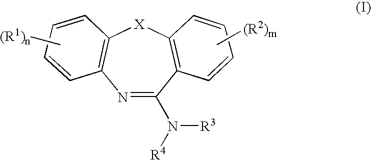 wherein
X is S, O, S═O, SO₂, NR^{a}, or CR^{b}R^{c};
R¹, R² are halogen, OH, SH, NH₂, CN, NO₂, alkyl, alkoxy, alkylamino, dialkylamino, alkylthio, alkenyl, alkenyloxy, alkenylamino, alkenylthio, alkynyl, alkynyloxy, alkynylamino, alkynylthio, alkylsulfonyl, alkylsulfoxyl, alkenylsulfonyl, alkynylsulfoxyl, formyl, alkylcarbonyl, hydroxycarbonyl, alkoxycarbonyl, carbonyloxy, alkylcarbonyloxy, phenyloxy, alkylcarbonylamino, C(O)NR^{d}R^{e}, or (SO₂)NR^{d}R^{e}, or C(═NOR^{f})-Gₚ-R^{f′}, or a mono- or bicyclic 5- to 10-membered aromatic or heteroaromatic ringsystem, optionally substituted, which is unfused or fused to the aromatic group to which it is bonded and which, when unfused, is bonded directly or through an O, S, alkyl, or alkoxy linkage, or cycloalkyl, wherein the carbon atoms in these groups may be substituted.
R³, R⁴ are each-independently H, alkyl, haloalkyl, alkylamino, alkoxy, cycloalkyl, wherein the carbon atoms in these groups may be substituted,
   or R³ and R⁴ together with the nitrogen atom to which they are attached form a saturated or partially saturated mono- or bicyclic 5- to 10-membered ringsystem or 5-membered hetaryl, phenyl or benzyl, wherein the rings are optionally substituted, or R³ and R⁴ together form the chains —(CH₂)₂N⁺(O—)(CH₂)₂— or —(CH₂)₃N⁺(O⁻)(CH₂)₂—;
   and R^{a}, R^{b}, R^{c}, R^{d}, R^{e}′ R^{f}, R^{f}′ G, and p are as defined in the description; m is 0, 1, 2, 3 or 4; n is 0, 1, 2, 3 or 4; or the enantiomers or diastereomers, salts or esters thereof for combatting insects, arachnids, or nematodes, methods for the control of these pests and of protecting growing plants from attack or infestation by these pests by applying a pesticidally effective amount of compounds of formula I, compounds of formula I, processes for preparing them, and compositions comprising them.

The present invention relates to the use of compounds of formula (I): 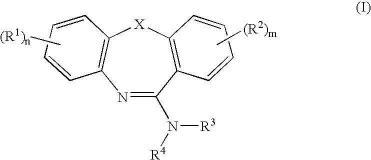
wherein

X is sulfur, oxygen, sulfinyl (S═O), sulfonyl (SO₂), NR^{a}, or CR^{b}R^{c};
R^{a} hydrogen, C₁-C₆-alkyl, C₂-C₆-alkenyl, or C₂-C₆-alkynyl wherein the carbon atoms in these groups may be substituted by 1 to 3 groups R^{#}
   R^{#} halogen, cyano, nitro, hydroxy, mercapto, amino, C₁-C₆-alkylcarbonyl-amino, carboxyl, C₁-C₆-alkyl, C₁-C₆-alkoxy, C₂-C₆-alkenyloxy, C₂-C₆-alkynyloxy, C₁-C₆-haloalkoxy, or C₁-C₆-alkylthio;
   phenyl or benzyl, each unsubstituted or substituted with any combination of 1 to 5 halogen, 1 to 3 C₁-C₆-alkyl, C₁-C₆-haloalkyl, C₁-C₆-alkylthio, C₁-C₆-haloalkylthio, C₁-C₆-alkoxy or C₁-C₆-haloalkoxy groups;
R^{b}, R^{c} are each independently hydrogen, C₁-C₆-alkyl, C₂-C₆-alkenyl, C₂-C₆-alkinyl, C₁-C₆-hydroxyalkyl, wherein the carbon atoms in these groups may be substituted by 1 to 3 groups R^{#}, or
   phenyl, unsubstituted or substituted with any combination of 1 to 5 halogen, 1 to 3 C₁-C₆-alkyl, C₁-C₆-haloalkyl, C₁-C₆-alkoxy or C₁-C₆-haloalkoxy groups, or
   CR^{b}R^{c} represents C═O or C═CR^{j}R^{k}, wherein R^{j} and R^{k} each independently are hydrogen, halogen, C₁-C₆-alkyl, C₁-C₆-haloalkyl, or C₃-C₆-cycloalkyl;

R¹, R² are each independently halogen, hydroxy, mercapto, amino, cyano, nitro,
C₁-C₆-alkyl, C₁-C₆-alkoxy, C₁-C₆-alkylamino, di(C₁-C₆-alkyl)amino, C₁-C₈-alkylthio, C₂-C₆-alkenyl, C₂-C₆-alkenyloxy, C₂-C₆-alkenylamino, C₂-C₆-alkenylthio, C₂-C₆-alkynyl, C₂-C₆-alkynyloxy, C₂-C₆-alkynylamino, C₂-C₆-alkynylthio, C₁-C₆-alkyl-sulfonyl, C₁-C₆-alkylsulfoxyl, C₂-C₆-alkenylsulfonyl, C₂-C₆-alkynylsulfoxyl, formyl, C₁-C₆-alkylcarbonyl, hydroxycarbonyl, C₁-C₆-alkoxycarbonyl, carbonyloxy, C₁-C₆-alkylcarbonyloxy, phenyloxy, C₁-C₆-alkylcarbonylamino, C(O)NR^{d}R^{e}, or (SO₂)NR^{d}R^{e},
wherein the carbon atoms in the aliphatic and aromatic groups may be substituted by 1 to 3 groups R^{#} and wherein R^{d} and R^{e} are each independently groups as listed for R^{a}; or
C(═NOR^{f})Gₚ-R^{f′}, wherein R^{f′} and R^{f} are each independently hydrogen or C₁-C₆-alkyl, G is oxygen, sulfur or NR^{f} and p is 0 or 1; or
a mono- or bicyclic 5- to 10-membered aromatic ring system which may contain 1 to 4 heteroatoms selected from oxygen, sulfur and nitrogen and which is unfused or fused to the aromatic group to which it is bonded and which, when unfused, is bonded directly or through an oxygen, sulfur, C₁-C₆-alkyl, or C₁-C₆-alkoxy linkage, and which is unsubstituted or substituted with any combination of 1 to 5 groups R^{#}; or
C₃-C₁₂-cycloalkyl, which is bonded directly or through an oxygen, sulfur or C₁-C₆-alkyl linkage, and which is unsubstituted or substituted with any combination of 1 to 5 groups R^{#};

R³, R⁴are each independently hydrogen, C₁-C₆-alkyl, C₁-C₆-haloalkyl, C₁-C₆-alkylamino, C₁-C₆-alkoxy, C₃-C₆-cycloalkyl, wherein the carbon atoms in these groups may be substituted with any combination of 1 to 3 groups R^{#}, or C(O)R^{g}, C(O)NR^{h}Rⁱ, or C(S)NR^{h}Rⁱ,
R^{g} hydrogen, C₁-C₆-alkyl, C₁-C₆-alkoxy, or
   phenyl or benzyl, each unsubstituted or substituted with any combination of 1 to 5 halogen, 1 to 3 C₁-C₆-alkyl, C₁-C₆-haloalkyl, C₁-C₆-alkylthio, C₁-C₆-haloalkylthio, C₁-C₆-alkoxy or C₁-C₆-haloalkoxy groups;
R^{h}, Rⁱ are each independently groups as listed for R^{a};
or R³ and R⁴ together with the nitrogen atom to which they are attached form a saturated or partially saturated mono- or bicyclic 5- to 1 0-membered ringsystem containing 1 to 3 heteroatoms selected from nitrogen and oxygen or 5-membered hetaryl containing 1 to 4 nitrogen atoms, wherein the carbon and/or nitrogen atoms in the saturated, partially saturated or aromatic rings are unsubstituted or substituted with any combination of 1 to 4 groups selected from amino, C₁-C₆-alkyl, C₂-C₆-alkenyl, C₂-C₆-alkynyl, C₁-C₆-alkoxy, C₂-C₆-alkenyloxy, C₂-C₆-alkynyloxy, C₁-C₆-alkylthio, C₂-C₆-alkenylthio, C₂-C₆-alkynylthio, C₁-C₆-alkylamino, di(C₁-C₆-alkyl)amino, C₂-C₆-alkenylamino, C₂-C₆-alkynylamino, C₁-C₆-hydroxyalkyl, hydroxycarbonyl-C₁-C₄-alkyl, C₁-C₆-alkoxycarbonyl-C₁-C₄-alkyl, formyl-C₁-C₄-alkyl, formyl-C₁-C₄-alkoxy, C₁-C₆-alkylcarbonyl-C₁-C₄-alkoxy, C₃-C₆-cycloalkyl, which is bonded directly or via an oxygen, sulfur or C₁-C₆-alkyl linkage, and C₅-C₈-cycloalkenyl, wherein the carbon atoms in these aliphatic groups can be substituted by 1 to 4 groups selected from halogen, cyano, hydroxy and nitro; or
phenyl or benzyl which may be substituted by halogen, C₁-C₄-alkyl or C₁-C₄-haloalkyl; or
R³ and R⁴ together form the chains —(CH₂)₂N⁺(O⁻)(CH₂)₂— or —(CH₂)₃N⁺(O⁻)(CH₂)₂—;

m is 0, 1, 2, 3 or 4;

n is 0, 1, 2, 3 or 4;

or the enantiomers or diastereomers, salts or esters thereof for combatting insects, arachnids, or nematodes.

In spite of the commercial insecticides, acaricides and nematicides available today, damage to crops, both growing and harvested, caused by insects, arachnids and nematodes still occurs. Therefor, there is continuing need to develop new insecticidal, acaricidal and nematicidal agents.

It was therefore an object of the present invention to provide new pesticidal compositions, new compounds and new methods for the control of insects, arachnids or nematodes and of protecting growing plants from attack or infestation by insects, arachnids or nematodes.

We have found that these objects are achieved by the compounds of formula I. Furthermore, we have found processes for preparing the compounds of formula I and compositions comprising them.

Some compounds of formula I have been described inter alia in EP-A 282 236, U.S. Pat. No. 3,412,193, DE 1 645 954, DE 1 280 879 and DE 1 470 427. However, an insecticidal, acaricidal or nematicidal activity of compounds of formula I has not been known yet.

Depending on the substitution pattern, the compounds of formula I can contain one or more chiral centers, in which case they are present as enantiomer or diastereomer mixtures. Subject-matter of this invention are not only compositions containing these mixtures but also those containing the pure enantiomers or diastereomers.

The compounds useful in the present invention may be readily synthesized using techniques generally known by synthetic organic chemists. Exemplary synthesis methods are described for example in Helv. Chim. Acta (1967), 50 (6), 1588.

Compounds of formula I wherein X is sulfur are for example obtainable according to the procedure described in EP-A 282 236 and U.S. Pat. No. 3,412,193. These processes-encompass four to five steps. It was therefore also an object of the present invention to provide a simpler process. Accordingly, the following process to compounds of formula I-A was found wherein R^{z} is hydrogen, amino, C₁-C₆-alkyl, C₂-C₆-alkenyl, C₂-C₆-alkynyl, C₁-C₆-alkoxy, C₂-C₆-alkenyloxy, C₂-C₆-alkynyloxy, C₁-C₆-hydroxyalkyl, hydroxycarbonyl-C₁-C₄-alkyl, C₁-C₆-alkoxycarbonyl-C₁-C₄-alkyl, formyl-C₁-C₄-alkyl, formyl-C₁-C₄-alkoxy, C₁-C₆-alkylcarbonyl-C₁-C₄-alkoxy, C₃-C₆-cycloalkyl, which is bonded directly or through an oxygen, sulfur or C₁-C₆-alkyl linkage, or C₅-C₈-cycloalkenyl, wherein the carbon atoms in these aliphatic groups can be substituted by 1 to 4 groups selected from halogen, cyano, hydroxy and nitro; or phenyl or benzyl which may be substituted by halogen, C₁-C₄-alkyl or C₁-C₄-haloalkyl; and wherein the group [N—R^{z}] may be present as amine oxide [N⁺(O⁻)Rz]; o is 1 or 2, and the further variables and the indices are as defined for formula I, 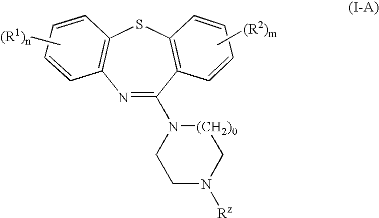
wherein in a first step o-amino-thiophenol derivatives of formula II are reacted with benzoic acid derivates III wherein Hal is halogen, preferably chloro or bromo, to give compounds IV, wherein the further variables and the indices of the compounds II, III and IV have the meanings as defined for formula I.

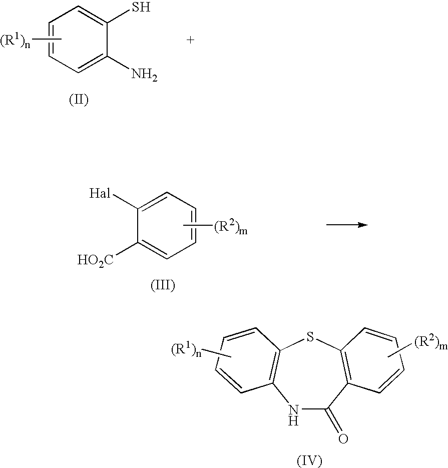

The reaction is usually carried out at temperatures of from 20° C. to 250° C., preferably from 150° C. to 210° C., in an inert organic solvent in the presence of a base, optionally in the pure base, and in the presence of a transition metal (I) oxide or—halogenid such as CuCl, CuBr, CuI or Cu₂O as a catalyst.

Suitable solvents are aromatic hydrocarbons such as toluolene, o-, m- and p-xylene, halogenated hydrocarbons, ethers, such as diglyme or anisol and also dimethyl sulfoxide, dimethyl formamide and dimethyl acetamide.

Suitable bases are organic bases, such as tertiary amines, such as triisopropyl ethyl amine, N-methyl-piperidine, and pyridine. Substituted pyridines are for example collidine, lutidine and 4-dimethyl amino pyridine as well as bicyclic amines such as quinoline or isoquinoline. Particular preference is given to pyridine and substituted pyridines, especially quinoline. It is also possible to use mixtures of the bases mentioned.

In general, the base is employed in equimolar amounts, in excess, or as a solvent.

Compounds of formula II and of formula III are obtainable by customary methods, or are commercially available (see e.g. Houben-Weyl, Methoden der organischen Chemie, 4^{th} edition, Volume IX, p. 7-33; Volume IV/1b, p. 583-589).

In a second step, compounds of formula IV are transformed into compounds of formula V, wherein the variables and the indices have the meanings as defined for formula I and Hal* is halogen, preferably chloro, by halogenation, preferably chlorination with a chlorinating agent such as POCl₃, PCl₅, SOCl₂, SO₂Cl₂, COCl₂, preferably POCl₃ or PCl₅ in POCl₃. The reaction is usually carried out at temperatures of from 20° C. to 200° C., preferably from 50° C. to 100° C., in an inert organic solvent, optionally in the pure halogenating/chlorinating agent, optionally in the presence of catalytic amounts of tertiary amines such as dimethyl aniline.

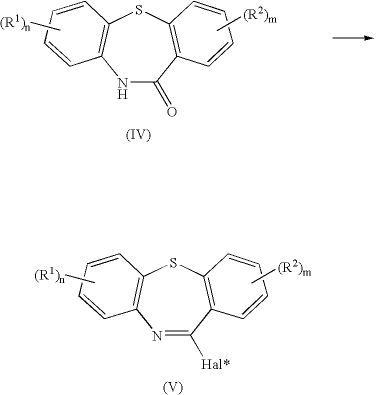

Suitable solvents are aromatic hydrocarbons such as toluolene, o-, m- and p-xylene and halogenated hydrocarbons. Preferred solvent is the pure halogenating agent, preferably POCl₃ or PCl₅ in POCl₃. It is also possible to use mixtures of the solvents mentioned.

In a last step, compounds of formula V are reacted with piperazine derivates VI, wherein o and R^{z} are as defined for formula I-A, to give compounds I-A.

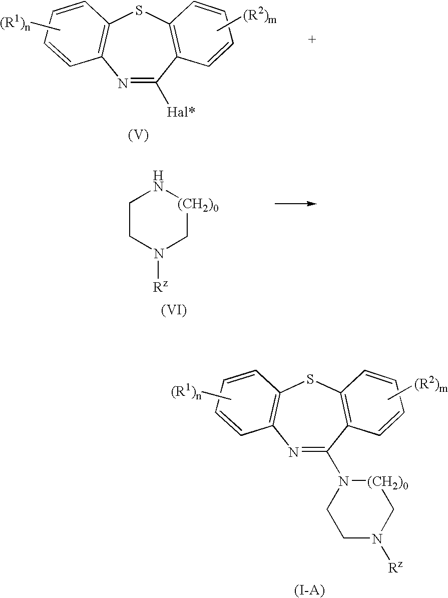

The reaction is usually carried out at temperatures of from 20° C. to 250° C., preferably from 80° C. to 120° C., in an inert organic solvent or pure compound VI.

Suitable solvents are aromatic hydrocarbons such as toluolene, o-, m- and p-xylene, halogenated hydrocarbons, such as methylene chloride, chloroform and chlorobenzene, ethers, such as diethylether, diisopropylether, tert.-butylmethylether, digylme, dioxane, anisol and tetrahydrofuran, and also dimethyl sulfoxide, dimethyl formamide and dimethyl acetamide. Preferred solvents are toluene, xylene and dioxane. It is also possible to use mixtures of the solvents mentioned.

Compounds of formula VI are commercially available or can be prepared following methods described in the literature [see e.g. J. Org. Chem. 31, p. 3867-3868 (1966)].

Compounds of formula I wherein X is oxygen are for example obtainable according to the procedure described in J. Med. Chem. (1992), 35, 1887 or DE 1 645 954. These processes encompass five to six steps. It was therefore also an object of the present invention to provide a simpler process. Accordingly, the following process to compounds of formula I-B wherein the variables and the indices have the meanings as defined for formula I-A was found 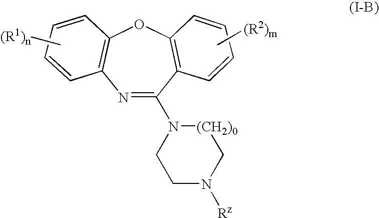
wherein in a first step o-amino-phenol derivatives of formula VII are reacted with benzoic acid derivates III wherein Hal is halogen, preferably chloro or bromo, and Y is hydroxy, halogen or C₁-C₆-alkoxy, preferably chloro or bromo, to give compounds VIII, wherein the variables and the indices of the compounds III*, VII and VIII have the meanings as defined for formula I.

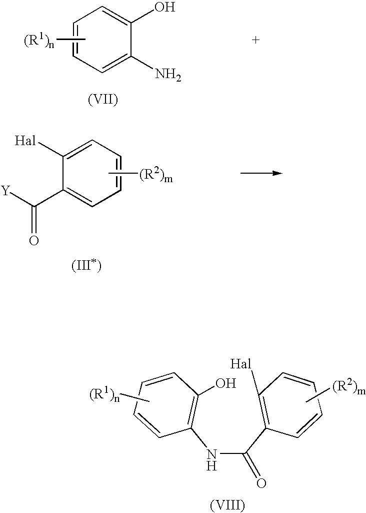

The reaction is usually carried out at temperatures of from 20° C. to 250° C., preferably from 20° C. to 100° C., in an inert organic solvent, in the presence of a water eliminating agent such as carbonyldiimidazol or dicyclohexylcarbodiimine if Y is hydroxy, and in the presence of a base such as a tertiary amine if Y is halogen.

Suitable solvents are aromatic hydrocarbons such as toluolene, o-, m- and p-xylene, halogenated hydrocarbons, such as methylene chloride, chloroform and chlorobenzene, ethers, such as diethylether, diisopropylether, tert.-butylmethylether, digylme, dioxane, anisol and tetrahydrofuran, and also dimethyl sulfoxide, dimethyl formamide and dimethyl acetamide. Preferred solvents are THF and toluene. It is also possible to use mixtures of the solvents mentioned.

Compounds of formula VII are obtainable by customary methods, or are commercially available [see e.g. Houben-Weyl, Methoden der organischen Chemie, 4^{th} edition, Volume VI/1c, p 53-54, p. 85-109, p. 477-480].

In a second step, compounds of formula VIII are transformed into compounds of formula IX, wherein the variables and the indices have the meanings as defined for formula I, by cyclization in the presence of a strong base.

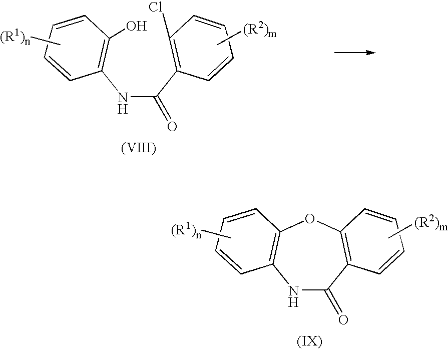

The reaction is usually carried out at temperatures of from 20° C. to 250° C., preferably from 20° C. to 180° C., in an inert organic solvent.

Suitable solvents are aromatic hydrocarbons such as toluene, o-, m- and p-xylene, halogenated hydrocarbons, ethers, such as digylme, and also dimethyl sulfoxide, dimethyl formamide and dimethyl acetamide. Preferred solvents are DMF, dimethyl acetamide or toluene, preferably dimethyl acetamide. It is also possible to use mixtures of the solvents mentioned.

Suitable bases are inorganic compounds, such as alkali metal and alkaline earth metal hydroxides, alkali metal and alkaline earth metal oxides, alkali metal and alkaline earth metal hydrides, such as lithium hydride, sodium hydride, potassium hydride, and calcium hydride, alkali metal and alkaline earth metal amides, and also alkali metal and earth alkali metal alcoholates. Particular preference is given to alkali and earth alkali metal hydrides such as sodium hydride.

In general, the base is employed in equimolar amounts or in excess.

In a third step, compounds of formula IX are transformed into compounds of formula X, wherein the variables and the indices have the meanings as defined for formula I and Hal* is halogen, preferably chloro, by halogenation, preferably chlorination with a chlorinating agent such as POCl₃, PCl₅, SOCl₂, SO₂Cl₂, COCl₂, preferably POCl₃ or PCl₅ in POCl₃.

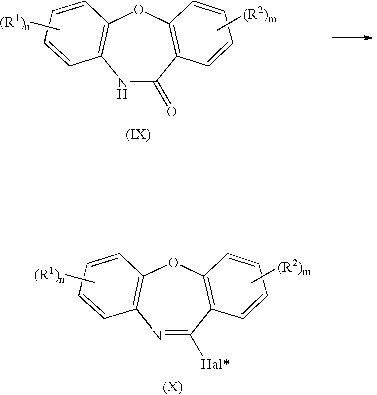

The reaction is usually carried out at temperatures of from 20° C. to 250° C., preferably from 20° C. to 150° C., in an inert organic solvent, optionally in the pure halogenating/chlorinating agent, optionally in the presence of catalytic amounts of tertiary amines such as dimethyl aniline.

Suitable solvents are aromatic hydrocarbons such as toluolene, o-, m- and p-xylene, or halogenated hydrocarbons, such as chlorobenzene. Preferred solvent is the pure halogenating agent, preferably POCl₃ or PCl₅ in POCl₃. It is also possible to use mixtures of the solvents mentioned.

In a last step, compounds of formula X are reacted with piperazine derivatives VI to give compounds I-B. The reaction conditions are analog to those described above for the reaction of compounds V wherein X is S with piperazines VI.

Compounds of formula I wherein X is NR^{a} are for example obtainable according to the procedure described in Synthesis (1985), 550 or DE 1 280 879.

Compounds of formula I wherein X is methylene are for example obtainable according to the procedure described in DE 1 470 427.

The reaction mixtures are worked up in a customary manner, for example by mixing with water, phase separation and, if appropriate, chromatographic purification of the crude products. In some cases, the intermediates and end products are obtained in the form of colorless or pale brown viscous oils, which are purified or freed from volatile components under reduced pressure and at moderately elevated temperature. If the intermediates and end products are obtained as solids, they can also be purified by recrystallization or digestion.

If individual compounds I are not obtainable by the route described above, they can be prepared by derivatization of other compounds I or by customary modifications of the synthesis routes described.

The preparation of the compounds of formula I may lead to them being obtained as isomer mixtures. If desired, these can be resolved by the methods customary for this purpose, such as crystallization or chromatography, also on optically active adsorbate, to give the pure isomers.

Agronomically acceptable salts of the compounds I can be formed in a customary manner, e.g. by reaction with an acid of the anion in question.

In this specification and in the claims, reference will be made to a number of terms that shall be defined to have the following meanings:

“Salt” as used herein includes adducts of compounds I with maleic acid, dimaleic acid, fumaric acid, difumaric acid, methane sulfenic acid, methane sulfonic acid, and succinic acid. Moreover, included as “salts” are those that can form with, for example, amines, metals, alkaline earth metal bases or quaternary ammonium bases, including zwitterions. Suitable metal and alkaline earth metal hydroxides as salt formers include the salts of barium, aluminum, nickel, copper, manganese, cobalt zinc, iron, silver, lithium, sodium, potassium, magnesium or calcium. Additional salt formers include chloride, sulfate, acetate, carbonate, hydride, and hydroxide. Desirable salts include adducts of compounds I with maleic acid, dimaleic acid, fumaric acid, difumaric acid, and methane sulfonic acid.

“Halogen” will be taken to mean fluoro, chloro, bromo and iodo.

The term “alkyl” as used herein refers to a branched or unbranched saturated hydrocarbon group having 1 to 8 carbon atoms, for example C₁-C₆-alkyl such as methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl and 1-ethyl-2-methylpropyl.

The term “haloalkyl” as used herein refers to a straight-chain or branched alkyl groups having 1 to 6 carbon atoms (as mentioned above), where some or all of the hydrogen atoms in these groups may be replaced by halogen atoms as mentioned above, for example C₁-C₂-haloalkyl, such as chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl and pentafluoroethyl;

“Alkylamino” refers to a straight-chain or branched alkyl group having 1 to 6 carbon atoms (as mentioned above) which is bonded through a nitrogen linkage.

Similarly, “alkoxy” and “alkylthio” refer to straight-chain or branched alkyl groups having 1 to 6 or 1 to 8 carbon atoms (as mentioned above) bonded through oxygen or sulfur linkages, respectively, at any bond in the alkyl group. Examples include methoxy, ethoxy, propoxy, isopropoxy, methylthio, ethylthio, propylthio, isopropylthio, and n-butylthio.

The term “alkenyl” as used herein intends a branched or unbranched unsaturated hydrocarbon group having 2 to 6 carbon atoms and a double bond in any position, such as ethenyl, 1-propenyl, 2-propenyl, 1-methyl-ethenyl, 1-butenyl, 2-butenyl, 3-butenyl, 1-methyl-1-propenyl, 2-methyl-1-propenyl, 1-methyl-2-propenyl, 2-methyl-2-propenyl; 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl and 1-ethyl-2-methyl-2-propenyl;

The term “alkynyl” as used herein refers to a branched or unbranched unsaturated hydrocarbon group containing at least one triple bond, such as ethynyl, propynyl, 1-butynyl, 2-butynyl, and the like.

Aryl: mono- or bicyclic 5- to 10-membered aromatic ringsystem, e.g. phenyl or naphthyl;

Hetaryl: a 5- to 10-membered heteroaromatic ring system containing 1 to 4 heteroatoms selected from oxygen, sulfur and nitrogen, e.g. 5-membered hetaryl, containing 1 to 4 nitrogen atoms, such as pyrrolyl, pyrazolyl, imidazolyl, triazolyl, and tetrazolyl; or 5-membered hetaryl, containing 1 to 4 nitrogen atoms or 1 to 3 nitrogen atoms and 1 sulfur or oxygen atom, e.g. furyl, thienyl, pyrrolyl, isoxazolyl, isothiazolyl, pyrazolyl, oxazolyl, thiazolyl, imidazolyl, oxadiazolyl, thiadiazolyl, oxadiazolyl, triazolyl, and tetrazolyl; or

5-membered hetaryl, containing 1 to 4 nitrogen atoms or 1 to 3 nitrogen atoms and 1 sulfur or oxygen atom, in which two adjacent ring carbon atoms or one nitrogen atom and an adjacent carbon atom can be bridged by buta-1,3-dien-1,4-diyl; or 6-membered hetaryl, containing 1 to 4 nitrogen atoms or 1 to 3 nitrogen atoms and 1 sulfur or oxygen atom, e.g. 2-pyridinyl, 3-pyridinyl, 4-pyridinyl, 3-pyridazinyl, 4-pyridazinyl, 2-pyrimidinyl, 4-pyrimidinyl, 5-pyrimidinyl, 2-pyrazinyl, 1,3,5-triazin-2-yl and 1,2,4-trazin-3-yl;

A saturated or partially saturated mono- or bicyclic 5- to 10-membered ringsystem containing 1 to 3 heteroatoms selected from nitrogen and oxygen intends e.g. a saturated monocyclic 5- to 7-membered ringsystem containing 1 to 3 heteroatoms selected from nitrogen and oxygen, such as pyridine, pyrimidine, pyrrolidine, piperazine, homopiperazine, morpholine, and piperidine; or

e.g. a saturated bicyclic 7- to 10-membered ringsystem containing 1 to 3 heteroatoms selected from nitrogen and oxygen, such as 1,4-diazabicyclo[4.3.0]nonane, 2,5-diazabicyclo[2.2.2]octane, and 2,5-diazabicyclo[2.2.1]heptane.

Cycloalkyl: monocyclic 3- to 6-, 8-, 10- or 12-membered saturated carbon atom rings, e.g. C₃-C₈-cycloalkyl such as cyclopropyl, cyclobutyl, cyclopentyl, cyclohexyl, cycloheptyl and cyclooctyl.

With respect to the intended use of the compounds of formula I, particular preference is given to the following meanings of the substituents, in each case on their own or in combination:

Preference is given to compounds of formula I wherein X is sulfur, oxygen, NH or CH₂, particularly sulfur, oxygen or NH.

Particular preference is given to compounds of formula I wherein X is sulfur or oxygen.

Furthermore, particular preference is given to compounds of formula I wherein X is sulfur.

Moreover, particular preference is given to compounds of formula I wherein X is oxygen.

Preference is given to compounds of formula I wherein R¹ is halogen, hydroxy, mercapto, cyano, nitro, C₁-C₆-alkyl, C₁-C₆-alkoxy, C₁-C₈-alkylthio, C₁-C₆-alkylsulfonyl, C₁-C₆-alkylsulfoxyl, C₁-C₆-alkoxycarbonyl, C₁-C₆-alkylcarbonylamino, C(O)NR^{d}R^{e}, (SO₂)NR^{d}R^{e}, wherein the carbon atoms in the aliphatic groups may be substituted by 1 to 3 groups R^{#}.

Particular preference is given to compounds of formula I wherein R¹ is hydroxy, mercapto, halogen, cyano, nitro, C₁-C₆-alkyl, C₁-C₆-haloalkyl, C₁-C₆-alkoxy, C₁-C₆-haloalkoxy, C₁-C₈-alkylthio, or C₁-C₆-haloalkylthio.

Furthermore, particular preference is given to compounds of formula I wherein R¹ is halogen, C₁-C₆-alkyl such as methyl or ethyl, C₁-C₆-haloalkyl such as trifluoromethyl, C₁-C₆-alkoxy such as methoxy or ethoxy, C₁-C₆-haloalkoxy such as halomethoxy, C₁-C₆-alkylthio such as methylthio, or C₁-C₆-haloalkylthio, such as halomethylthio.

Also, particular preference is given to compounds of formula I wherein R¹ is halogen, preferably fluoro or chloro, most preferably fluoro.

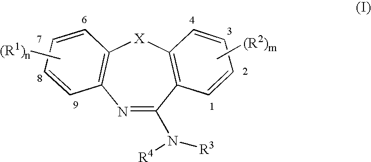

Furthermore, particular preference is given to compounds of formula I wherein R¹ is in the 6- ,7-, 8- or 9-position, particularly in the 7- or 8-position.

Preference is given to compounds of formula I wherein R² is halogen, hydroxy, mercapto, amino, cyano, nitro, C₁-C₆-alkyl, C₁-C₆-alkoxy, C₁-C₈-alkylthio, C₂-C₆-alkenyl, C₂-C₆-alkenyloxy, C₂-C₆-alkenylthio, C₂-C₆-alkynyl, C₂-C₆-alkynyloxy, C₂-C₆-alkynylthio, C₁-C₆-alkylsulfonyl, C₁-C₆-alkylsulfoxyl, C₂-C₆-alkenylsulfonyl, C₂-C₆-alkynylsulfoxyl, formyl, C₁-C₆-alkylcarbonyl, C₁-C₆-alkoxycarbonyl, carbonyloxy, C₁-C₆-alkylcarbonyloxy, C₃-C₆-cycloalkyl, C₃-C₆-cycloalkyl-C₁-C₄-alkyl, C₃-C₆-cycloalkylthio, C₃-C₆-cycloalkyl-C₁-C₄-alkylthio, wherein the carbon atoms in the aliphatic groups may be substituted by 1 to 3 groups R^{#}.

Particular preference is given to compounds of formula I wherein R² is hydroxy, mercapto, halogen, cyano, nitro, C₁-C₆-alkyl, C₁-C₆-haloalkyl, C₁-C₆-alkoxy, C₁-C₆-haloalkoxy, C₁-C₈-alkylthio, C₁-C₆-haloalkylthio, C₂-C₆-alkenyl, C₂-C₆-alkynyl, C₂-C₆-alkynylthio, C₁-C₆-alkylcarbonyl, C₁-C₆-alkoxycarbonyl, C₃-C₆-cycloalkyl, C₃-C₆-cycloalkyl-C₁-C₄-alkyl, C₃-C₆-cycloalkyl-thio, C₃-C₆-cycloalkyl-C₁-C₄-alkylthio.

Moreover, particular preference is given to compounds of formula I wherein R² is halogen, C₁-C₆-alkyl, such as methyl or ethyl C₁-C₆-haloalkyl, such as trifluoromethyl, C₁-C₆-alkoxy, such as methoxy or ethoxy, C₁-C₆-haloalkoxy, such as halomethoxy, C₁-C₆-alkylthio, such as methylthio or C₁-C₆-haloalkylthio, such as halomethylthio.

Also, particular preference is given to compounds of formula I wherein R² is halogen, preferably fluoro or chloro.

Also, particular preference is given to compounds of formula I wherein R² is C₁-C₆-alkylthio, preferably methylthio or ethylthio.

Moreover, particular preference is given to compounds of formula I wherein R² is in the 1-, 2-, 3-, or 4-position, particularly in the 2-position.

Preference is given to compounds of formula I wherein R^{a} is hydrogen.

Preference is given to compounds of formula I wherein R^{b} and R^{c} are hydrogen.

Preference is given to compounds of formula I wherein R³ and R⁴ together with the nitrogen atom to which they are attached form a saturated monocyclic 5- to 7-membered ringsystem containing 1 to 3 heteroatoms selected from nitrogen and oxygen, pyrrolidine, piperazine, homopiperazine, morpholine, or piperidine, wherein the carbon and/or nitrogen atoms are unsubstituted or substituted with any combination of C₁-C₆-alkyl, C₂-C₆-alkenyl, C₂-C₆-alkynyl, C₁-C₆-alkoxy, C₂-C₆-alkenyloxy, C₂-C₆-alkynyloxy, C₁-C₆-alkylthio, C₂-C₆-alkenylthio, C₂-C₆-alkynylthio, C₁-C₆-hydroxyalkyl, hydroxycarbonyl-C₁-C₄-alkyl, C₁-C₆-alkoxycarbonyl-C₁-C₄-alkyl, formyl-C₁-C₄-alkyl, formyl-C₁-C₄-alkoxy, C₁-C₆-alkylcarbonyl-C₁-C₄-alkoxy, C₃-C₆-cycloalkyl, or C₅-C₈-cycloalkenyl, wherein the carbon atoms in the aliphatic groups can be substituted by 1 to 2 groups selected from halogen, cyano, hydroxy and nitro; or R³ and R⁴ together form the chains —(CH₂)₂N⁺(O⁻)(CH₂)₂— or —(CH₂)₃N⁺(O⁻)(CH₂)₂—; or phenyl or benzyl which may be substituted by halogen, C₁-C₄-alkyl or C₁-C₄-haloalkyl.

Particular preference is given to compounds of formula I wherein R³ and R⁴ together with the nitrogen atom to which they are attached form a piperazine or homopiperazine ring of formula IX wherein R^{z} is hydrogen, C₁-C₆-alkyl, C₂-C₆-alkenyl, C₂-C₆-alkynyl, C₁-C₆-alkoxy, C₂-C₆-alkenyloxy, C₂-C₆-alkynyloxy, C₁-C₆-hydroxyalkyl, hydroxycarbonyl-C₁-C₄-alkyl, C₁-C₆-alkoxycarbonyl-C₁-C₄-alkyl, formyl-C₁-C₄-alkyl, formyl-C₁-C₄-alkoxy, C₁-C₆-alkylcarbonyl-C₁-C₄-alkoxy, C₃-C₆-cycloalkyl, C₃-C₆-cycloalkyl-C₁-C₆-alkyl, or C₅-C₈-cycloalkenyl, wherein the carbon atoms in these aliphatic groups can be substituted by 1 to 2 halogen atoms; or phenyl or benzyl which may be substituted by halogen, C₁-C₄-alkyl or C₁-C₄-haloalkyl; and wherein the group [N—R^{z}] may be present as amine oxide [N⁺(O⁻)Rz]; and o is 1 or 2; and # denotes the linkage to the dibenzoazepin backbone.

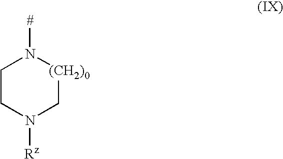

Particular preference further is given to compounds of formula I wherein R³ and R⁴ together with the nitrogen atom to which they are attached form a ring of formula IX wherein R^{z} is C₁-C₆-alkyl, C₁-C₆-haloalkyl, C₁-C₄-hydroxyalkyl, C₁-C₆-alkoxy-C₁-C₄-alkyl, C₂-C₆-alkenyl, C₂-C₆-alkynyl, or C₃-C₆-cycloalkyl.

Also, particular preference is given to compounds of formula I wherein R^{z} is C₁-C₆-alkyl, preferably methyl or ethyl.

Also, particular preference is given to compounds of formula I wherein R^{z} is C₁-C₆-haloalkyl, preferably 1,1,1-trifluoroeth-2-yl.

Moreover, particular preference is given to compounds of formula I wherein R³ and R⁴ together with the nitrogen atom to which they are attached form a ring of formula IX wherein o is 1.

Preference is given to compounds of formula I wherein m is 0, 1, or 2, particularly 1.

Preference is given to compounds of formula I wherein n is 0, 1, or 2, particularly 1.

Particular preference is given to compounds of formula I wherein m and n are each 1.

Furthermore, preference is given to compounds of formula I wherein R¹ is in the 8-position, R² is in the 2-position and n and m are each 1.

Besides, preference is given to compounds of formula I wherein R¹ is in the 7-position, R² is in the 2-position and n and m are each 1.

Particular preference is given to compounds of formula I wherein one of R¹ and R² is an electron drawing group such as fluoro, chloro or bromo, and the other is an electron donating group such as C₁-C₆-alkyl, C₁-C₆-alkyl or C₁-C₈-alkylthio.

Furthermore, particular preference is given to compounds of formula I-1 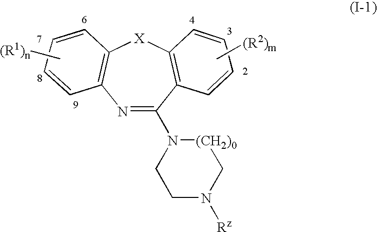
wherein

X is sulfur, oxygen, methylene or NH;

R¹ is halogen, hydroxy, mercapto, cyano, nitro, C₁-C₄-alkyl, C₁-C₄-haloalkyl, C₁-C₄-alkoxy, C₁-C₄-haloalkoxy, C₁-C₄-haloalkylthio and is in the 6-, 7- or 8-position;

R² is halogen, hydroxy, mercapto, C₁-C₄-alkyl, C₂-C₄-alkenyl, C₂-C₄-alkynyl, C₁-C₄-haloalkyl,

C₁-C₆-alkoxy, C₁-C₄-haloalkoxy, or C₁-C₆-alkylthio, C₁-C₆-haloalkylthio, C₃-C₆-cycloalkyl, C₃-C₆-cycloalkyl-C₁-C₂-alkyl, and is in the 2-, 3- or 4-position;

R^{z} is C₁-C₄-alkyl, C₁-C₄-haloalkyl, C₂-C₄-alkenyl, C₂-C₄-alkynyl, C₃-C₆-cycloalkyl, or C₃-C₆-cycloalkyl-C₁-C₂-alkyl;

m is 0, 1, or 2;

n is 0 or 1; and

o is 1 or 2.

Furthermore, particular preference is given to compounds of formula I-1 wherein X is sulfur or oxygen;

R¹ is halogen, C₁-C₆-alkyl or C₁-C₈-alkylthio and is in the 8-position;

R² is halogen, C₁-C₆-alkyl, C₁-C₆-alkoxy, or C₁-C₈-alkylthio and is in the 2-position;

R^{z} is C₁-C₆-alkyl, C₁-C₆-haloalkyl, C₂-C₆-alkenyl, C₃-C₆-alkynyl, or C₃-C₆-cycloalkyl;

m and n are each 0 or 1; and

0 is 1 or 2.

Moreover, particular preference is given to compounds of formula I-A 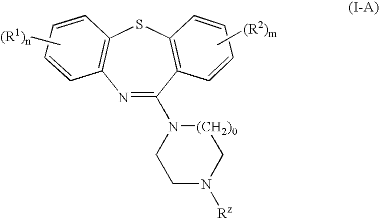
wherein

R¹, R²are each independently halogen, hydroxy, mercapto, amino, cyano, nitro, C₁-C₆-alkyl, C₁-C₆-alkoxy, C₁-C₆-alkylamino, di(C₁-C₆-alkyl)amino, C₁-C₈-alkylthio, C₂-C₆-alkenyl, C₂-C₆-alkenyloxy, C₂-C₆-alkenylamino, C₂-C₆-alkenylthio, C₂-C₆-alkynyl, C₂-C₆-alkynyloxy, C₂-C₆-alkynylamino, C₂-C₆-alkynylthio, C₁-C₆-alkylsulfonyl, C₂-C₆-alkenylsulfonyl, formyl, or C₁-C₆-alkylcarbonyl, wherein the carbon atoms in the aliphatic and aromatic groups may be substituted by 1 to 3 groups selected from halogen, cyano, nitro, hydroxy, mercapto, amino, C₁-C₆-alkyl, C₁-C₆-alkoxy, C₂-C₆-alkenyloxy, C₂-C₆-alkynyloxy, C₁-C₆-haloalkoxy, or C₁-C₆-alkylthio;

R^{z} is hydrogen, C₁-C₆-alkyl, C₂-C₆-alkenyl, C₂-C₆-alkynyl, C₁-C₆-hydroxyalkyl, C₃-C₆-cycloalkyl, C₃-C₆-cycloalkyl-C₁-C₆-alkyl, or C₅-C₈-cycloalkenyl, wherein the carbon atoms in these aliphatic groups can be substituted by 1 to 4 groups selected from halogen, cyano, hydroxy and nitro; and wherein the group [N—R^{z}] may be present as amine oxide [N⁺(O⁻)—R^{z}]; o is 1 or 2;

m is 1, 2, 3, or 4; and

n is 1, 2, 3, or 4;

Furthermore, particular preference is given to compounds of formula I-A wherein R¹ and R² each independently are halogen, C₁-C₆-alkyl, C₁-C₆-haloalkyl, methoxy, C₁-C₆-haloalkoxy, C₁-C₈-alkylthio, C₁-C₆-haloalkylthio, C₂-C₆-alkenylthio, or C₂-C₆-alkynylthio.

Moreover, particular preference is given to compounds of formula I-B 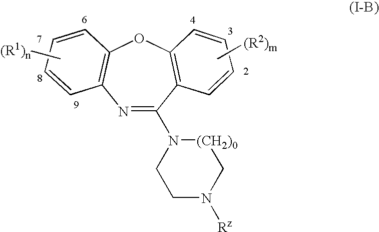
wherein R^{z} and the indices n, m, and o are as defined for formula I-A and R¹ and R² each independently are halogen, C₁-C₆-alkyl, C₁-C₆-haloalkyl, methoxy, C₁-C₆-haloalkoxy, C₁-C₈-alkylthio, C₁-C₆-haloalkylthio, C₂-C₆-alkenylthio, or C₂-C₆-alkynylthio, with the proviso that

when R¹ is 2-chloro then R² is not 8-chloro or 8-methoxy; and

when R¹ is 4-chloro then R² is not 8-chloro; and

when R¹ is 4-methyl then R² is not 7-, 8-, or 9-chloro.

Furthermore, particular preference is given to compounds of formula I-C 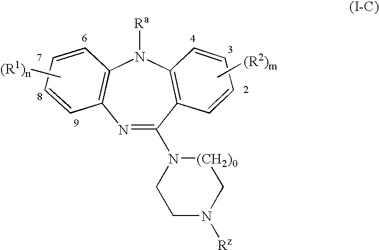
wherein R^{a} is hydrogen or C₁-C₆-alkyl and the further variables and indices are as defined for formula I-B, with the proviso that

not both of R¹ or R² are halogen and

when R¹ is 2-chloro then R² is not 8-methyl, 8-methylthio, or 8-methoxy; and

when R¹ is 2-methoxy, then R² is not 8-chloro; and

when R¹ is 2-methyl then R² is not 8-chloro.

Moreover, particular preference is given to compounds of formula I-D 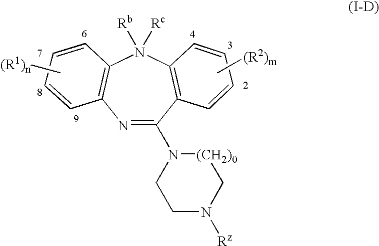
wherein R^{b} and R^{c} are each independently hydrogen, methyl or CR^{b}R^{c} represents C═CH₂, and the further variables and the indices are as defined for formula I-B.

With respect to their use, particular preference is given to the compounds I-1 compiled in the tables below. Moreover, the groups mentioned for a substituent in the tables are on their own, independently of the combination in which they are mentioned, a particularly preferred embodiment of the substituent in question.

With respect to their use, particular preference is also given to the maleic acid, dimaleic acid, fumaric acid, difumaric acid, methane sulfenic acid, methane sulfonic acid, and succinic acid adducts of the compounds of the tables below.

Table 1

Compounds of the formula I-1 wherein X is sulfur, n is zero, and the combination of (R²)ₘ, R^{z} and o corresponds in each case to a row of Table A.

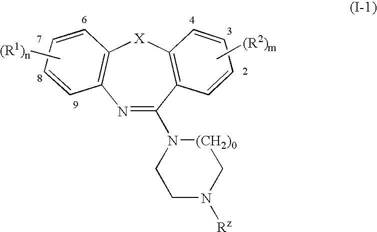

Table 2

Compounds of the formula I-1 wherein X is sulfur, n is 1, R¹ is 6-fluoro and the combination of (R²)ₘ, R^{z} and o corresponds in each case to a row of Table A.

Table 3

Compounds of the formula I-1 wherein X is sulfur, n is 1, R¹ is 6-chloro and the combination of (R²)ₘ, R^{z} and o corresponds in each case to a row of Table A.

Table 4

Compounds of the formula I-1 wherein X is sulfur, n is 1, R¹ is 6-bromo and the combination of (R²)ₘ, R^{z} and o corresponds in each case to a row of Table A.

Table 5

Compounds of the formula I-1 wherein X is sulfur, n is 1, R¹ is 6-hydroxy and the combination of (R²)ₘ, R^{z} and o corresponds in each case to a row of Table A.

Table 6

Compounds of the formula I-1 wherein X is sulfur, n is 1, R¹ is 6-mercapto and the combination of (R²)ₘ, R^{z} and o corresponds in each case to a row of Table A.

Table 7

Compounds of the formula I-1 wherein X is sulfur, n is 1, R¹ is 6-cyano and the combination of (R²)ₘ, R^{z} and o corresponds in each case to a row of Table A.

Table 8

Compounds of the formula I-1 wherein X is sulfur, n is 1, R¹ is 6-nitro and the combination of (R²)ₘ, R^{z} and o corresponds in each case to a row of Table A.

Table 9

Compounds of the formula I-1 wherein X is sulfur, n is 1, R¹ is 6-methyl and the combination of (R²)ₘ, R^{z} and o corresponds in each case to a row of Table A.

Table 10

Compounds of the formula I-1 wherein X is sulfur, n is 1, R¹ is 6-trifluoromethyl and the combination of (R²)ₘ, R^{z} and o corresponds in each case to a row of Table A.

Table 11

Compounds of the formula I-1 wherein X is sulfur, n is 1, R¹ is 6-methoxy and the combination of (R²)ₘ, R^{z} and o corresponds in each case to a row of Table A.

Table 12

Compounds of the formula I-1 wherein X is sulfur, n is 1, R¹ is 6-trifluoromethoxy and the combination of (R²)ₘ, R^{z} and o corresponds in each case to a row of Table A.

Table 13

Compounds of the formula I-1 wherein X is sulfur, n is 1, R¹ is 6-methylthio and the combination of (R²)ₘ, R^{z} and o corresponds in each case to a row of Table A.

Table 14

Compounds of the formula I-1 wherein X is sulfur, n is 1, R¹ is 6-trifluoromethylthio and the combination of (R²)ₘ, R^{z} and o corresponds in each case to a row of Table A.

Table 15

Compounds of the formula I-1 wherein X is sulfur, n is 1, R¹ is 7-fluoro and the combination of (R²)ₘ, R^{z} and o corresponds in each case to a row of Table A.

Table 16

Compounds of the formula I-1 wherein X is sulfur, n is 1, R¹ is 7-chloro and the combination of (R²)ₘ, R^{z} and o corresponds in each case to a row of Table A.

Table 17

Compounds of the formula I-1 wherein X is sulfur, n is 1, R¹ is 7-bromo and the combination of (R²)ₘ, R^{z} and o corresponds in each case to a row of Table A.

Table 18

Compounds of the formula I-1 wherein X is sulfur, n is 1, R¹ is 7-hydroxy and the combination of (R²)ₘ, R^{z} and o corresponds in each case to a row of Table A.

Table 19

Compounds of the formula I-1 wherein X is sulfur, n is 1, R¹ is 7-mercapto and the combination of (R²)ₘ, R^{z} and o corresponds in each case to a row of Table A.

Table 20

Compounds of the formula I-1 wherein X is sulfur, n is 1, R¹ is 7-cyano and the combination of (R²)ₘ, R^{z} and o corresponds in each case to a row of Table A.

Table 21

Compounds of the formula I-1 wherein X is sulfur, n is 1, R¹ is 7-nitro and the combination of (R²)ₘ, R^{z} and o corresponds in each case to a row of Table A.

Table 22

Compounds of the formula I-1 wherein X is sulfur, n is 1, R¹ is 7-methyl and the combination of (R²), R^{z} and o corresponds in each case to a row of Table A.

Table 23

Compounds of the formula I-1 wherein X is sulfur, n is 1, R¹ is 7-trifluoromethyl and the combination of (R²)ₘ, R^{z} and o corresponds in each case to a row of Table A.

Table 24

Compounds of the formula I-1 wherein X is sulfur, n is 1, R¹ is 7-methoxy and the combination of (R²)ₘ, R^{z} and o corresponds in each case to a row of Table A.

Table 25

Compounds of the formula I-1 wherein X is sulfur, n is 1, R¹ is 7-trifluoromethoxy and the combination of (R²)ₘ, R^{z} and o corresponds in each case to a row of Table A.

Table 26

Compounds of the formula I-1 wherein X is sulfur, n is 1, R¹ is 7-methylthio and the combination of (R²)ₘ, R^{z} and o corresponds in each case to a row of Table A.

Table 27

Compounds of the formula I-1 wherein X is sulfur, n is 1, R¹ is 7-trifluoromethylthio and the combination of (R²)ₘ, R^{z} and o corresponds in each case to a row of Table A.

Table 28

Compounds of the formula I-1 wherein X is sulfur, n is 1, R¹ is 8-fluoro and the combination of (R²)ₘ, R^{z} and o corresponds in each case to a row of Table A.

Table 29

Compounds of the formula I-1 wherein X is sulfur, n is 1, R¹ is 8-chloro and the combination of (R²)ₘ, R^{z} and o corresponds in each case to a row of Table A.

Table 30

Compounds of the formula I-1 wherein X is sulfur, n is 1, R¹ is 8-bromo and the combination of (R²)ₘ, R^{z} and o corresponds in each case to a row of Table A.

Table 31

Compounds of the formula I-1 wherein X is sulfur, n is 1, R¹ is 8-hydroxy and the combination of (R²)ₘ, R^{z} and o corresponds in each case to a row of Table A.

Table 32

Compounds of the formula I-1 wherein X is sulfur, n is 1, R¹ is 8-mercapto and the combination of (R²)ₘ, R^{z} and o corresponds in each case to a row of Table A.

Table 33

Compounds of the formula I-1 wherein X is sulfur, n is 1, R¹ is 8-cyano and the combination of (R²)ₘ, R^{z} and o corresponds in each case to a row of Table A.

Table 34

Compounds of the formula I-1 wherein X is sulfur, n is 1, R¹ is 8-nitro and the combination of (R²)ₘ, R^{z} and o corresponds in each case to a row of Table A.

Table 35

Compounds of the formula I-1 wherein X is sulfur, n is 1, R¹ is 8-methyl and the combination of (R²)ₘ, R^{z} and o corresponds in each case to a row of Table A.

Table 36

Compounds of the formula I-1 wherein X is sulfur, n is 1, R¹ is 8-trifluoromethyl and the combination of (R²)ₘ, R^{z} and o corresponds in each case to a row of Table A.

Table 37

Compounds of the formula I-1 wherein X is sulfur, n is 1, R¹ is 8-methoxy and the combination of (R²)ₘ, R^{z} and o corresponds in each case to a row of Table A.

Table 38

Compounds of the formula I-1 wherein X is sulfur, n is 1, R¹ is 8-trifluoromethoxy and the combination of (R²)ₘ, R^{z} and o corresponds in each case to a row of Table A.

Table 39

Compounds of the formula I-1 wherein X is sulfur, n is 1, R¹ is 8-methylthio and the combination of (R²)ₘ, R^{z} and o corresponds in each case to a row of Table A.

Table 40

Compounds of the formula I-1 wherein X is sulfur, n is 1, R¹ is 8-trifluoromethylthio and the combination of (R²)ₘ, R^{z} and o corresponds in each case to a row of Table A.

Table 41

Compounds of the formula I-1 wherein X is sulfur, n is 1, R¹ is 9-fluoro and the combination of (R²)ₘ, R^{z} and o corresponds in each case to a row of Table A.

Table 42

Compounds of the formula I-1 wherein X is sulfur, n is 1, R¹ is 9-chloro and the combination of (R²)ₘ, R^{z} and o corresponds in each case to a row of Table A.

Table 43

Compounds of the formula I-1 wherein X is sulfur, n is 1, R¹ is 9-bromo and the combination of (R²)ₘ, R^{z} and o corresponds in each case to a row of Table A.

Table 44

Compounds of the formula I-1 wherein X is sulfur, n is 1, R¹ is 9-hydroxy and the combination of (R²)ₘ, R^{z} and o corresponds in each case to a row of Table A.

Table 45

Compounds of the formula I-1 wherein X is sulfur, n is 1, R¹ is 9-mercapto and the combination of (R²)ₘ, R^{z} and o corresponds in each case to a row of Table A.

Table 46

Compounds of the formula I-1 wherein X is sulfur, n is 1, R¹ is 9-cyano and the combination of (R²)ₘ, R^{z} and o corresponds in each case to a row of Table A.

Table 47

Compounds of the formula I-1 wherein X is sulfur, n is 1, R¹ is 9-nitro and the combination of (R²)ₘ, R^{z} and o corresponds in each case to a row of Table A.

Table 48

Compounds of the formula I-1 wherein X is sulfur, n is 1, R¹ is 9-methyl and the combination of (R²)ₘ, R^{z} and o corresponds in each case to a row of Table A.

Table 49

Compounds of the formula I-1 wherein X is sulfur, n is 1, R¹ is 9-trifluoromethyl and the combination of (R²)ₘ, R^{z} and o corresponds in each case to a row of Table A.

Table 50

Compounds of the formula I-1 wherein X is sulfur, n is 1, R¹ is 9-methoxy and the combination of (R²)ₘ, R^{z} and o corresponds in each case to a row of Table A.

Table 51

Compounds of the formula I-1 wherein X is sulfur, n is 1, R¹ is 9-trifluoromethoxy and the combination of (R²)ₘ, R^{z} and o corresponds in each case to a row of Table A.

Table 52

Compounds of the formula I-1 wherein X is sulfur, n is 1, R¹ is 9-methylthio and the combination of (R²)ₘ, R^{z} and o corresponds in each case to a row of Table A.

Table 53

Compounds of the formula I-1 wherein X is sulfur, n is 1, R¹ is 9-trifluoromethylthio and the combination of (R²)ₘ, R^{z} and o corresponds in each case to a row of Table A.

Table 54

Compounds of the formula I-1 wherein X is sulfur, (R¹)n is 7,8-difluoro, and the combination of (R²)ₘ, R^{z} and o corresponds in each case to a row of Table A.

Table 55

Compounds of the formula I-1 wherein X is sulfur, (R¹)n is 7-fluoro-8-chloro, and the combination of (R²)ₘ, R^{z} and o corresponds in each case to a row of Table A.

Table 56

Compounds of the formula I-1 wherein X is sulfur, (R¹), is 7-chloro-8-fluoro, and the combination of (R²)ₘ, R^{z} and o corresponds in each case to a row of Table A.

Table 57

Compounds of the formula I-1 wherein X is sulfur, (R¹)n is 7,8-dimethoxy, and the combination of (R²)ₘ, R^{z} and o corresponds in each case to a row of Table A.

Table 58

Compounds of the formula I-1 wherein X is methylene, n is zero, and the combination of (R²)ₘ, R^{z} and o corresponds in each case to a row of Table A.

Table 59

Compounds of the formula I-1 wherein X is methylene, n is 1, R¹ is 6-fluoro and the combination of (R²)ₘ, R^{z} and o corresponds in each case to a row of Table A.

Table 60

Compounds of the formula I-1 wherein X is methylene, n is 1, R¹ is 6-chloro and the combination of (R²)ₘ, R^{z} and o corresponds in each case to a row of Table A.

Table 61

Compounds of the formula I-1 wherein X is methylene, n is 1, R¹ is 6-bromo and the combination of (R²)ₘ, R^{z} and o corresponds in each case to a row of Table A.

Table 62

Compounds of the formula I-1 wherein X is methylene, n is 1, R¹ is 6-hydroxy and the combination of (R²)ₘ, R^{z} and o corresponds in each case to a row of Table A.

Table 63

Compounds of the formula I-1 wherein X is methylene, n is 1, R¹ is 6-mercapto and the combination of (R²)ₘ, R^{z} and o corresponds in each case to a row of Table A.

Table 64

Compounds of the formula I-1 wherein X is methylene, n is 1, R¹ is 6-cyano and the combination of (R²)ₘ, R^{z} and o corresponds in each case to a row of Table A.

Table 65

Compounds of the formula I-1 wherein X is methylene, n is 1, R¹ is 6-nitro and the combination of (R²)ₘ, R^{z} and o corresponds in each case to a row of Table A.

Table 66

Compounds of the formula I-1 wherein X is methylene, n is 1, R¹ is 6-methyl and the combination of (R²)ₘ, R^{z} and o corresponds in each case to a row of Table A.

Table 67

Compounds of the formula I-1 wherein X is methylene, n is 1, R¹ is 6-trifluoromethyl and the combination of (R²)ₘ, R^{z} and o corresponds in each case to a row of Table A.

Table 68

Compounds of the formula I-1 wherein X-is methylene, n is 1, R¹ is 6-methoxy and the combination of (R²)ₘ, R^{z} and o corresponds in each case to a row of Table A.

Table 69

Compounds of the formula I-1 wherein X is methylene, n is 1, R¹ is 6-trifluoromethoxy and the combination of (R²)ₘ, R^{z} and o corresponds in-each case to a row of Table A.

Table 70

Compounds of the formula I-1 wherein X is methylene, n is 1, R¹ is 6-methylthio and the combination of (R²)ₘ, R^{z} and o corresponds in each case to a row of Table A.

Table 71

Compounds of the formula I-1 wherein X is methylene, n is 1, R¹ is 6-trifluoromethylthio and the combination of (R²)ₘ, R^{z} and o corresponds in each case to a row of Table A.

Table 72

Compounds of the formula I-1 wherein X is methylene, n is 1, R¹ is 7-fluoro and the combination of (R²)ₘ, R^{z} and o corresponds in each case to a row of Table A.

Table 73

Compounds of the formula I-1 wherein X is methylene, n is 1, R¹ is 7-chloro and the combination of (R²)ₘ, R^{z} and o corresponds in each case to a row of Table A.

Table 74

Compounds of the formula I-1 wherein X is methylene, n is 1, R¹ is 7-bromo and the combination of (R²)ₘ, R^{z} and o corresponds in each case to a row of Table A.

Table 75

Compounds of the formula I-1 wherein X is methylene, n is 1, R¹ is 7-hydroxy and the combination of (R²)ₘ, R^{z} and o corresponds in each case to a row of Table A.

Table 76

Compounds of the formula I-1 wherein X is methylene, n is 1, R¹ is 7-mercapto and the combination of (R²)ₘ, R^{z} and o corresponds in each case to a row of Table A.

Table 77

Compounds of the formula I-1 wherein X is methylene, n is 1, R¹ is 7-cyano and the combination of (R²)ₘ, R^{z} and o corresponds in each case to a row of Table A.

Table 78

Compounds of the formula I-1 wherein X is methylene, n is 1, R¹ is 7-nitro and the combination of (R²)ₘ, R^{z} and o corresponds in each case to a row of Table A.

Table 79

Compounds of the formula I-1 wherein X is methylene, n is 1, R¹ is 7-methyl and the combination of (R²)ₘ, R^{z} and o corresponds in each case to a row of Table A.

Table 80

Compounds of the formula I-1 wherein X is methylene, n is 1, R¹ is 7-trifluoromethyl and the combination of (R²)ₘ, R^{z} and o corresponds in each case to a row of Table A.

Table 81

Compounds of the formula I-1 wherein X is methylene, n is 1, R¹ is 7-methoxy and the combination of (R²)ₘ, R^{z} and o corresponds in each case to a row of Table A.

Table 82

Compounds of the formula I-1 wherein X is methylene, n is 1, R¹ is 7-trifluoromethoxy and the combination of (R²)ₘ, R^{z} and o corresponds in each case to a row of Table A.

Table 83

Compounds of the formula I-1 wherein X is methylene, n is 1, R¹ is 7-methylthio and the combination of (R²)ₘ, R^{z} and o corresponds in each case to a row of Table A.

Table 84

Compounds of the formula I-1 wherein X is methylene, n is 1, R¹ is 7-trifluoromethylthio and the combination of (R²)ₘ, R^{z} and o corresponds in each case to a row of Table A.

Table 85

Compounds of the formula I-1 wherein X is methylene, n is 1, R¹ is 8-fluoro and the combination of (R²)ₘ, R^{z} and o corresponds in each case to a row of Table A.

Table 86

Compounds of the formula I-1 wherein X is methylene, n is 1, R¹ is 8-chloro and the combination of (R²)ₘ, R^{z} and o corresponds in each case to a row of Table A.

Table 87

Compounds of the formula I-1 wherein X is methylene, n is 1, R¹ is 8-bromo and the combination of (R²)ₘ, R^{z} and o corresponds in each case to a row of Table A.

Table 88

Compounds of the formula I-1 wherein X is methylene, n is 1, R¹ is 8-hydroxy and the combination of (R²)ₘ, R^{z} and o corresponds in each case to a row of Table A.

Table 89

Compounds of the formula I-1 wherein X is methylene, n is 1, R¹ is 8-mercapto and the combination of (R²)ₘ, R^{z} and o corresponds in each case to a row of Table A.

Table 90

Compounds of the formula I-1 wherein X is methylene, n is 1, R¹ is 8-cyano and the combination of (R²)ₘ, R^{z} and o corresponds in each case to a row of Table A.

Table 91

Compounds of the formula I-1 wherein X is methylene, n is 1, R¹ is 8-nitro and the combination of (R²)ₘ, R^{z} and o corresponds in each case to a row of Table A.

Table 92

Compounds of the formula I-1 wherein X is methylene, n is 1, R¹ is 8-methyl and the combination of (R²)ₘ, R^{z} and o corresponds in each case to a row of Table A.

Table 93

Compounds of the formula I-1 wherein X is methylene, n is 1, R¹ is 8-trifluoromethyl and the combination of (R²)ₘ, R^{z} and o corresponds in each case to a row of Table A.

Table 94

Compounds of the formula I-1 wherein X is methylene, n is 1, R¹ is 8-methoxy and the combination of (R²)ₘ, R^{z} and o corresponds in each case to a row of Table A.

Table 95

Compounds of the formula I-1 wherein X is methylene, n is 1, R¹ is 8-trifluoromethoxy and the combination of (R²)ₘ, R^{z} and o corresponds in each case to a row of Table A.

Table 96

Compounds of the formula I-1 wherein X is methylene, n is 1, R¹ is 8-methylthio and the combination of (R²)ₘ, R^{z} and o corresponds in each case to a row of Table A.

Table 97

Compounds of the formula I-1 wherein X is methylene, n is 1, R¹ is 8-trifluoromethylthio and the combination of (R²)ₘ, R^{z} and o corresponds in each case to a row of Table A.

Table 98

Compounds of the formula I-1 wherein X is methylene, n is 1, R¹ is 9-fluoro and the combination of (R²)ₘ, R^{z} and o corresponds in each case to a row of Table A.

Table 99

Compounds of the formula I-1 wherein X is methylene, n is 1, R¹ is 9-chloro and the combination of (R²)ₘ, R^{z} and o corresponds in each case to a row of Table A.

Table 100

Compounds of the formula I-1 wherein X is methylene, n is 1, R¹ is 9-bromo and the combination of (R²)ₘ, R^{z} and o corresponds in each case to a row of Table A.

Table 101

Compounds of the formula I-1 wherein X is methylene, n is 1, R¹ is 9-hydroxy and the combination of (R²)ₘ, R^{z} and o corresponds in each case to a row of Table A.

Table 102

Compounds of the formula I-1 wherein X is methylene, n is 1, R¹ is 9-mercapto and the combination of (R²)ₘ, R^{z} and o corresponds in each case to a row of Table A.

Table 103

Compounds of the formula I-1 wherein X is methylene, n is 1, R¹ is 9-cyano and the combination of (R²)ₘ, R^{z} and o corresponds in each case to a row of Table A.

Table 104

Compounds of the formula I-1 wherein X is methylene, n is 1, R¹ is 9-nitro and the combination of (R²)ₘ, R^{z} and o corresponds in each case to a row of Table A.

Table 105

Compounds of the formula I-1 wherein X is methylene, n is 1, R¹ is 9-methyl and the combination of (R²)ₘ, R^{z} and o corresponds in each case to a row of Table A.

Table 106

Compounds of the formula I-1 wherein X is methylene, n is 1, R¹ is 9-trifluoromethyl and the combination of (R²)ₘ, R^{z} and o corresponds in each case to a row of Table A.

Table 107

Compounds of the formula I-1 wherein X is methylene, n is 1, R¹ is 9-methoxy and the combination of (R²)ₘ, R^{z} and o corresponds in each case to a row of Table A.

Table 108

Compounds of the formula I-1 wherein X is methylene, n is 1, R¹ is 9-trifluoromethoxy and the combination of (R²)ₘ, R^{z} and o corresponds in each case to a row of Table A.

Table 109

Compounds of the formula I-1 wherein X is methylene, n is 1, R¹ is 9-methylthio and the combination of (R²)ₘ, R^{z} and o corresponds in each case to a row of Table A.

Table 110

Compounds of the formula I-1 wherein X is methylene, n is 1, R¹ is 9-trifluoromethylthio and the combination of (R²)ₘ, R^{z} and o corresponds in each case to a row of Table A.

Table 111

Compounds of the formula I-1 wherein X is methylene, (R¹), is 7,8-difluoro, and the combination of (R²)ₘ, R^{z} and o corresponds in each case to a row of Table A.

Table 112

Compounds of the formula I-1 wherein X is methylene, (R¹)ₙ is 7-fluoro-8-chloro, and the combination of (R²)ₘ, R^{z} and o corresponds in each case to a row of Table A.

Table 113

Compounds of the formula I-1 wherein X is methylene, (R¹)ₙ is 7-chloro-8-fluoro, and the combination of (R²)ₘ, R^{z} and o corresponds in each case to a row of Table A.

Table 114

Compounds of the formula I-1 wherein X is methylene, (R¹)ₙ is 7,8-dimethoxy, and the combination of (R²)ₘ, R^{z} and o corresponds in each case to a row of Table A.

Table 115

Compounds of the formula I-1 wherein X is oxygen, n is zero, and the combination of (R²)ₘ, R^{z} and o corresponds in each case to a row of Table A.

Table 116

Compounds of the formula I-1 wherein X is oxygen, n is 1, R¹ is 6-fluoro and the combination of (R²)ₘ, R^{z} and o corresponds in each case to a row of Table A.

Table 117

Compounds of the formula I-1 wherein X is oxygen, n is 1, R¹ is 6-chloro and the combination of (R²)ₘ, R^{z} and o corresponds in each case to a row of Table A.

Table 118

Compounds of the formula I-1 wherein X is oxygen, n is 1, R¹ is 6-bromo and the combination of (R²)ₘ, R^{z} and o corresponds in each case to a row of Table A.

Table 119

Compounds of the formula I-1 wherein X is oxygen, n is 1, R¹ is 6-hydroxy and the combination of (R²)ₘ, R^{z} and o corresponds in each case to a row of Table A.

Table 120

Compounds of the formula I-1 wherein X is oxygen, n is 1, R¹ is 6-mercapto and the combination of (R²)ₘ, R^{z} and o corresponds in each case to a row of Table A.

Table 121

Compounds of the formula I-1 wherein X is oxygen, n is 1, R¹ is 6-cyano and the combination of (R²)ₘ, R^{z} and o corresponds in each case to a row of Table A.

Table 122

Compounds of the formula I-1 wherein X is oxygen, n is 1, R¹ is 6-nitro and the combination of (R²)ₘ, R^{z} and o corresponds in each case to a row of Table A.

Table 123

Compounds of the formula I-1 wherein X is oxygen, n is 1, R¹ is 6-methyl and the combination of (R²)ₘ, R^{z} and o corresponds in each case to a row of Table A.

Table 124

Compounds of the formula I-1 wherein X is oxygen, n is 1, R¹ is 6-trifluoromethyl and the combination of (R²)ₘ, R^{z} and o corresponds in each case to a row of Table A.

Table 125

Compounds of the formula I-1 wherein X is oxygen, n is 1, R¹ is 6-methoxy and the combination of (R²)ₘ, R^{z} and o corresponds in each case to a row of Table A.

Table 126

Compounds of the formula I-1 wherein X is oxygen, n is 1, R¹ is 6-trifluoromethoxy and the combination of (R²)ₘ, R^{z} and o corresponds in each case to a row of Table A.

Table 127

Compounds of the formula I-1 wherein X is oxygen, n is 1, R¹ is 6-methylthio and the combination of (R²)ₘ, R^{z} and o corresponds in each case to a row of Table A.

Table 128

Compounds of the formula I-1 wherein X is oxygen, n is 1, R¹ is 6-trifluoromethylthio and the combination of (R²)ₘ, R^{z} and o corresponds in each case to a row of Table A.

Table 129

Compounds of the formula I-1 wherein X is oxygen, n is 1, R¹ is 7-fluoro and the combination of (R²)ₘ, R^{z} and o corresponds in each case to a row of Table A.

Table 130

Compounds of the formula I-1 wherein X is oxygen, n is 1, R¹ is 7-chloro and the combination of (R²)ₘ, R^{z} and o corresponds in each case to a row of Table A.

Table 131

Compounds of the formula I-1 wherein X is oxygen, n is 1, R¹ is 7-bromo and the combination of (R²)ₘ, R^{z} and o corresponds in each case to a row of Table A.

Table 132

Compounds of the formula I-1 wherein X is oxygen, n is 1, R¹ is 7-hydroxy and the combination of (R²)ₘ, R^{z} and o corresponds in each case to a row of Table A.

Table 133

Compounds of the formula I-1 wherein X is oxygen, n is 1, R¹ is 7-mercapto and the combination of (R²)ₘ, R^{z} and o corresponds in each case to a row of Table A.

Table 134

Compounds of the formula I-1 wherein X is oxygen, n is 1, R¹ is 7-cyano and the combination of (R²)ₘ, R^{z} and o corresponds in each case to a row of Table A.

Table 135

Compounds of the formula I-1 wherein X is oxygen, n is 1, R¹ is 7-nitro and the combination of (R²)ₘ, R^{z} and o corresponds in each case to a row of Table A.

Table 136

Compounds of the formula I-1 wherein X is oxygen, n is 1, R¹ is 7-methyl and the combination of (R²)ₘ, R^{z} and o corresponds in each case to a row of Table A.

Table 137

Compounds of the formula I-1 wherein X is oxygen, n is 1, R¹ is 7-trifluoromethyl and the combination of (R²)ₘ, R^{z} and o corresponds in each case to a row of Table A.

Table 138

Compounds of the formula I-1 wherein X is oxygen, n is 1, R¹ is 7-methoxy and the combination of (R²)ₘ, R^{z} and o corresponds in each case to a row of Table A.

Table 139

Compounds of the formula I-1 wherein X is oxygen, n is 1, R¹ is 7-trifluoromethoxy and the combination of (R²)ₘ, R^{z} and o corresponds in each case to a row of Table A.

Table 140

Compounds of the formula I-1 wherein X is oxygen, n is 1, R¹ is 7-methylthio and the combination of (R²)ₘ, R^{z} and o corresponds in each case to a row of Table A.

Table 141

Compounds of the formula I-1 wherein X is oxygen, n is 1, R¹ is 7-trifluoromethylthio and the combination of (R²)ₘ, R^{z} and o corresponds in each case to a row of Table A.

Table 142

Compounds of the formula I-1 wherein X is oxygen, n is 1, R¹ is 8-fluoro and the combination of (R²)ₘ, R^{z} and o corresponds in each case to a row of Table A.

Table 143

Compounds of the formula I-1 wherein X is oxygen, n is 1, R¹ is 8-chloro and the combination of (R²)ₘ, R^{z} and o corresponds in each case to a row of Table A.

Table 144

Compounds of the formula I-1 wherein X is oxygen, n is 1, R¹ is 8-bromo and the combination of (R²)ₘ, R^{z} and o corresponds in each case to a row of Table A.

Table 145

Compounds of the formula I-1 wherein X is oxygen, n is 1, R¹ is 8-hydroxy and the combination of (R²)ₘ, R^{z} and o corresponds in each case to a row of Table A.

Table 146

Compounds of the formula I-1 wherein X is oxygen, n is 1, R¹ is 8-mercapto and the combination of (R²)ₘ, R^{z} and o corresponds in each case to a row of Table A.

Table 147

Compounds of the formula I-1 wherein X is oxygen, n is 1, R¹ is 8-cyano and the combination of (R²)ₘ, R^{z} and o corresponds in each case to a row of Table A.

Table 148

Compounds of the formula I-1 wherein X is oxygen, n is 1, R¹ is 8-nitro and the combination of (R²)ₘ, R^{z} and o corresponds in each case to a row of Table A.

Table 149

Compounds of the formula I-1 wherein X is oxygen, n is 1, R¹ is 8-methyl and the combination of (R²)ₘ, R^{z} and o corresponds in each case to a row of Table A.

Table 150

Compounds of the formula I-1 wherein X is oxygen, n is 1, R¹ is 8-trifluoromethyl and the combination of (R²)ₘ, R^{z} and o corresponds in each case to a row of Table A.

Table 151

Compounds of the formula I-1 wherein X is oxygen, n is 1, R¹ is 8-methoxy and the combination of (R²)ₘ, R^{z} and o corresponds in each case to a row of Table A.

Table 152

Compounds of the formula I-1 wherein X is oxygen, n is 1, R¹ is 8-trifluoromethoxy and the combination of (R²)ₘ, R^{z} and o corresponds in each case to a row of Table A.

Table 153

Compounds of the formula I-1 wherein X is oxygen, n is 1, R¹ is 8-methylthio and the combination of (R²)ₘ, R^{z} and o corresponds in each case to a row of Table A.

Table 154

Compounds of the formula I-1 wherein X is oxygen, n is 1, R¹ is 8-trifluoromethylthio and the combination of (R²)ₘ, R^{z} and o corresponds in each case to a row of Table A.

Table 155

Compounds of the formula I-1 wherein X is oxygen, n is 1, R¹ is 9-fluoro and the combination of (R²)ₘ, R^{z} and o corresponds in each case to a row of Table A.

Table 156

Compounds of the formula I-1 wherein X is oxygen, n is 1, R¹ is 9-chloro and the combination of (R²)ₘ, R^{z} and o corresponds in each case to a row of Table A.

Table 157

Compounds of the formula I-1 wherein X is oxygen, n is 1, R¹ is 9-bromo and the combination of (R²)ₘ, R^{z} and o corresponds in each case to a row of Table A.

Table 158

Compounds of the formula I-1 wherein X is oxygen, n is 1, R¹ is 9-hydroxy and the combination of (R²)ₘ, R^{z} and o corresponds in each case to a row of Table A.

Table 159

Compounds of the formula I-1 wherein X is oxygen, n is 1, R¹ is 9-mercapto and the combination of (R²)ₘ, R^{z} and o corresponds in each case to a row of Table A.

Table 160

Compounds of the formula I-1 wherein X is oxygen, n is 1, R¹ is 9-cyano and the combination of (R²)ₘ, R^{z} and o corresponds in each case to a row of Table A.

Table 161

Compounds of the formula I-1 wherein X is oxygen, n is 1, R¹ is 9-nitro and the combination of (R²)ₘ, R^{z} and o corresponds in each case to a row of Table A.

Table 162

Compounds of the formula I-1 wherein X is oxygen, n is 1, R¹ is 9-methyl and the combination of (R²)ₘ, R^{z} and o corresponds in each case to a row of Table A.

Table 163

Compounds of the formula I-1 wherein X is oxygen, n is 1, R¹ is 9-trifluoromethyl and the combination of (R²)ₘ, R^{z} and o corresponds in each case to a row of Table A.

Table 164

Compounds of the formula I-1 wherein X is oxygen, n is 1, R¹ is 9-methoxy and the combination of (R²)ₘ, R^{z} and o corresponds in each case to a row of Table A.

Table 165

Compounds of the formula I-1 wherein X is oxygen, n is 1, R¹ is 9-trifluoromethoxy and the combination of (R²)ₘ, R^{z} and o corresponds in each case to a row of Table A.

Table 166

Compounds of the formula I-1 wherein X is oxygen, n is 1, R¹ is 9-methylthio and the combination of (R²)ₘ, R^{z} and o corresponds in each case to a row of Table A.

Table 167

Compounds of the formula I-1 wherein X is oxygen, n is 1, R¹ is 9-trifluoromethylthio and the combination of (R²)ₘ, R^{z} and o corresponds in each case to a row of Table A.

Table 168

Compounds of the formula I-1 wherein X is oxygen, (R¹), is 7,8-difluoro, and the combination of (R²)ₘ, R^{z} and o corresponds in each case to a row of Table A.

Table 169

Compounds of the formula I-1 wherein X is oxygen, (R¹)ₙ is 7-fluoro-8-chloro, and the combination of (R²)ₘ, R^{z} and o corresponds in each case to a row of Table A.

Table 170

Compounds of the formula I-1 wherein X is oxygen, (R¹)ₙ is 7-chloro-8-fluoro, and the combination of (R²)ₘ, R^{z} and o corresponds in each case to a row of Table A.

Table 171

Compounds of the formula I-1 wherein X is oxygen, (R¹), is 7,8-dimethoxy, and the combination of (R²)ₘ, R^{z} and o corresponds in each case to a row of Table A.

Table 172

Compounds of the formula I-1 wherein X is NH, n is zero, and the combination of (R²)ₘ, R^{z} and o corresponds in each case to a row of Table A.

Table 173

Compounds of the formula I-1 wherein X is NH, n is 1, R¹ is 6-fluoro and the combination of (R²)ₘ, R^{z} and o corresponds in each case to a row of Table A.

Table 174

Compounds of the formula I-1 wherein X is NH, n is 1, R¹ is 6-chloro and the combination of (R²)ₘ, R^{z} and o corresponds in each case to a row of Table A.

Table 175

Compounds of the formula I-1 wherein X is NH, n is 1, R¹ is 6-bromo and the combination of (R²)ₘ, R^{z} and o corresponds in each case to a row of Table A.

Table 176

Compounds of the formula I-1 wherein X is NH, n is 1, R¹ is 6-hydroxy and the combination of (R²)ₘ, R^{z} and o corresponds in each case to a row of Table A.

Table 177

Compounds of the formula I-1 wherein X is NH, n is 1, R¹ is 6-mercapto and the combination of (R²)ₘ, R^{z} and o corresponds in each case to a row of Table A.

Table 178

Compounds of the formula I-1 wherein X is NH, n is 1, R¹ is 6-cyano and the combination of (R²)ₘ, R^{z} and o corresponds in each case to a row of Table A.

Table 179

Compounds of the formula I-1 wherein X is NH, n is 1, R¹ is 6-nitro and the combination of (R²)ₘ, R^{z} and o corresponds in each case to a row of Table A.

Table 180

Compounds of the formula I-1 wherein X is NH, n is 1, R¹ is 6-methyl and the combination of (R²)ₘ, R^{z} and o corresponds in each case to a row of Table A.

Table 181

Compounds of the formula I-1 wherein X is NH, n is 1, R¹ is 6-trifluoromethyl and the combination of (R²)ₘ, R^{z} and o corresponds in each case to a row of Table A.

Table 182

Compounds of the formula I-1 wherein X is NH, n is 1, R¹ is 6-methoxy and the combination of (R²)ₘ, R^{z} and o corresponds in each case to a row of Table A.

Table 183

Compounds of the formula I-1 wherein X is NH, n is 1, R¹ is 6-trifluoromethoxy and the combination of (R²)ₘ, R^{z} and o corresponds in each case to a row of Table A.

Table 184

Compounds of the formula I-1 wherein X is NH, n is 1, R¹ is 6-methylthio and the combination of (R²)ₘ, R^{z} and o corresponds in each case to a row of Table A.

Table 185

Compounds of the formula I-1 wherein X is NH, n is 1, R¹ is 6-trifluoromethylthio and the combination of (R²)ₘ, R^{z} and o corresponds in each case to a row of Table A.

Table 186

Compounds of the formula I-1 wherein X is NH, n is 1, R¹ is 7-fluoro and the combination of (R²)ₘ, R^{z} and o corresponds in each case to a row of Table A.

Table 187

Compounds of the formula I-1 wherein X is NH, n is 1, R¹ is 7-chloro and the combination of (R²)ₘ, R^{z} and o corresponds in each case to a row of Table A.

Table 188

Compounds of the formula I-1 wherein X is NH, n is 1, R¹ is 7-bromo and the combination of (R²)ₘ, R^{z} and o corresponds in each case to a row of Table A.

Table 189

Compounds of the formula I-1 wherein X is NH, n is 1, R¹ is 7-hydroxy and the combination of (R²)ₘ, R^{z} and o corresponds in each case to a row of Table A.

Table 190

Compounds of the formula I-1 wherein X is NH, n is 1, R¹ is 7-mercapto and the combination of (R²)ₘ, R^{z} and o corresponds in each case to a row of Table A.

Table 191

Compounds of the formula I-1 wherein X is NH, n is 1, R¹ is 7-cyano and the combination of (R²)ₘ, R^{z} and o corresponds in each case to a row of Table A.

Table 192

Compounds of the formula I-1 wherein X is NH, n is 1, R¹ is 7-nitro and the combination of (R²)ₘ, R^{z} and o corresponds in each case to a row of Table A.

Table 193

Compounds of the formula I-1 wherein X is NH, n is 1, R¹ is 7-methyl and the combination of (R²)ₘ, R^{z} and o corresponds in each case to a row of Table A.

Table 194

Compounds of the formula I-1 wherein X is NH, n is 1, R¹ is 7-trifluoromethyl and the combination of (R²)ₘ, R^{z} and o corresponds in each case to a row of Table A.

Table 195

Compounds of the formula I-1 wherein X is NH, n is 1, R¹ is 7-methoxy and the combination of (R²)ₘ, R^{z} and o corresponds in each case to a row of Table A.

Table 196

Compounds of the formula I-1 wherein X is NH, n is 1, R¹ is 7-trifluoromethoxy and the combination of (R²)ₘ, R^{z} and o corresponds in each case to a row of Table A.

Table 197

Compounds of the formula I-1 wherein X is NH, n is 1, R¹ is 7-methylthio and the combination of (R²)ₘ, R^{z} and o corresponds in each case to a row of Table A.

Table 198

Compounds of the formula I-1 wherein X is NH, n is 1, R¹ is 7-trifluoromethylthio and the combination of (R²)ₘ, R^{z} and o corresponds in each case to a row of Table A.

Table 199

Compounds of the formula I-1 wherein X is NH, n is 1, R¹ is 8-fluoro and the combination of (R²)ₘ, R^{z} and o corresponds in each case to a row of Table A.

Table 200

Compounds of the formula I-1 wherein X is NH, n is 1, R¹ is 8-chloro and the combination of (R²)ₘ, R^{z} and o corresponds in each case to a row of Table A.

Table 201

Compounds of the formula I-1 wherein X is NH, n is 1, R¹ is 8-bromo and the combination of (R²)ₘ, R^{z} and o corresponds in each case to a row of Table A.

Table 202

Compounds of the formula I-1 wherein X is NH, n is 1, R¹ is 8-hydroxy and the combination of (R²)ₘ, R^{z} and o corresponds in each case to a row of Table A.

Table 203

Compounds of the formula I-1 wherein X is NH, n is 1, R¹ is 8-mercapto and the combination of (R²)ₘ, R^{z} and o corresponds in each case to a row of Table A.

Table 204

Compounds of the formula I-1 wherein X is NH, n is 1, R¹ is 8-cyano and the combination of (R²)ₘ, R^{z} and o corresponds in each case to a row of Table A.

Table 205

Compounds of the formula I-1 wherein X is NH, n is 1, R¹ is 8-nitro and the combination of (R²)ₘ, R^{z} and o corresponds in each case to a row of Table A.

Table 206

Compounds of the formula I-1 wherein X is NH, n is 1, R¹ is 8-methyl and the combination of (R²)ₘ, R^{z} and o corresponds in each case to a row of Table A.

Table 207

Compounds of the formula I-1 wherein X is NH, n is 1, R¹ is 8-trifluoromethyl and the combination of (R²)ₘ, R^{z} and o corresponds in each case to a row of Table A.

Table 208

Compounds of the formula I-1 wherein X is NH, n is 1, R¹ is 8-methoxy and the combination of (R²)ₘ, R^{z} and o corresponds in each case to a row of Table A.

Table 209

Compounds of the formula I-1 wherein X is NH, n is 1, R¹ is 8-trifluoromethoxy and the combination of (R²)ₘ, R^{z} and o corresponds in each case to a row of Table A.

Table 210

Compounds of the formula I-1 wherein X is NH, n is 1, R¹ is 8-methylthio and the combination of (R²)ₘ, R^{z} and o corresponds in each case to a row of Table A.

Table 211

Compounds of the formula I-1 wherein X is NH, n is 1, R¹ is 8-trifluoromethylthio and the combination of (R²)ₘ, R^{z} and o corresponds in each case to a row of Table A.

Table 212

Compounds of the formula I-1 wherein X is NH, n is 1, R¹ is 9-fluoro and the combination of (R²)ₘ, R^{z} and o corresponds in each case to a row of Table A.

Table 213

Compounds of the formula I-1 wherein X is NH, n is 1, R¹ is 9-chloro and the combination of (R²)ₘ, R^{z} and o corresponds in each case to a row of Table A.

Table 214

Compounds of the formula I-1 wherein X is NH, n is 1, R¹ is 9-bromo and the combination of (R²)ₘ, R^{z} and o corresponds in each case to a row of Table A.

Table 215

Compounds of the formula I-1 wherein X is NH, n is 1, R¹ is 9-hydroxy and the combination of (R²)ₘ, R^{z} and o corresponds in each case to a row of Table A.

Table 216

Compounds of the formula I-1 wherein X is NH, n is 1, R¹ is 9-mercapto and the combination of (R²)ₘ, R^{z} and o corresponds in each case to a row of Table A.

Table 217

Compounds of the formula I-1 wherein X is NH, n is 1, R¹ is 9-cyano and the combination of (R²)ₘ, R^{z} and o corresponds in each case to a row of Table A.

Table 218

Compounds of the formula I-1 wherein X is NH, n is 1, R¹ is 9-nitro and the combination of (R²)ₘ, R^{z} and o corresponds in each case to a row of Table A.

Table 219

Compounds of the formula I-1 wherein X is NH, n is 1, R¹ is 9-methyl and the combination of (R²)ₘ, R^{z} and o corresponds in each case to a row of Table A.

Table 220

Compounds of the formula I-1 wherein X is NH, n is 1, R¹ is 9-trifluoromethyl and the combination of (R²)ₘ, R^{z} and o corresponds in each case to a row of Table A.

Table 221

Compounds of the formula I-1 wherein X is NH, n is 1, R¹ is 9-methoxy and the combination of (R²)ₘ, R^{z} and o corresponds in each case to a row of Table A.

Table 222

Compounds of the formula I-1 wherein X is NH, n is 1, R¹ is 9-trifluoromethoxy and the combination of (R²)ₘ, R^{z} and o corresponds in each case to a row of Table A.

Table 223

Compounds of the formula I-1 wherein X is NH, n is 1, R¹ is 9-methylthio and the combination of (R²)ₘ, R^{z} and o corresponds in each case to a row of Table A.

Table 224

Compounds of the formula I-1 wherein X is NH, n is 1, R¹ is 9-trifluoromethylthio and the combination of (R²)ₘ, R^{z} and o corresponds in each case to a row of Table A.

Table 225

Compounds of the formula I-1 wherein X is NH, (R¹), is 7,8-difluoro, and the combination of (R²)ₘ, R^{z} and o corresponds in each case to a row of Table A.

Table 226

Compounds of the formula I-1 wherein X is NH, (R¹)ₙ is 7-fluoro-8-chloro, and the combination of (R²)ₘ, R^{z} and o corresponds in each case to a row of Table A.

Table 227

Compounds of the formula I-1 wherein X is NH, (R¹)ₙ is 7-chloro-8-fluoro, and the combination of (R²)ₘ, R^{z} and o corresponds in each case to a row of Table A.

Table 228

Compounds of the formula I-1 wherein X is NH, (R¹)ₙ is 7,8-dimethoxy, and the combination of (R²)ₘ, R^{z} and o corresponds in each case to a row of Table A.

TABLE A

| No. | (R²)ₘ | R^{z} | o |
|---|---|---|---|
| A-1 | — | CH₃ | 1 |
| A-2 | — | CH₃ | 2 |
| A-3 | — | CH₂CH₃ | 1 |
| A-4 | — | CH₂CH₃ | 2 |
| A-5 | — | (CH₂)₂CH₃ | 1 |
| A-6 | — | CH(CH₃)₂ | 1 |
| A-7 | — | CH₂CHCH₂ | 1 |
| A-8 | — | CH₂CCH | 1 |
| A-9 | — | cyclo-C₃H₅ | 1 |
| A-10 | — | CH₂-cyclo-C₃H₅ | 1 |
| A-11 | — | C(CH₃)₃ | 1 |
| A-12 | — | CH₂CF₃ | 1 |
| A-13 | 4-OH | CH₃ | 1 |
| A-14 | 4-OH | CH₃ | 2 |
| A-15 | 4-OH | CH₂CH₃ | 1 |
| A-16 | 4-OH | CH₂CH₃ | 2 |
| A-17 | 4-OH | (CH₂)₂CH₃ | 1 |
| A-18 | 4-OH | CH(CH₃)₂ | 1 |
| A-19 | 4-OH | CH₂CHCH₂ | 1 |
| A-20 | 4-OH | CH₂CCH | 1 |
| A-21 | 4-OH | cyclo-C₃H₅ | 1 |
| A-22 | 4-OH | CH₂-cyclo-C₃H₅ | 1 |
| A-23 | 4-OH | C(CH₃)₃ | 1 |
| A-24 | 4-OH | CH₂CF₃ | 1 |
| A-25 | 3-OH | CH₃ | 1 |
| A-26 | 3-OH | CH₃ | 2 |
| A-27 | 3-OH | CH₂CH₃ | 1 |
| A-28 | 3-OH | CH₂CH₃ | 2 |
| A-29 | 3-OH | (CH₂)₂CH₃ | 1 |
| A-30 | 3-OH | CH(CH₃)₂ | 1 |
| A-31 | 3-OH | CH₂CHCH₂ | 1 |
| A-32 | 3-OH | CH₂CCH | 1 |
| A-33 | 3-OH | cyclo-C₃H₅ | 1 |
| A-34 | 3-OH | CH₂-cyclo-C₃H₅ | 1 |
| A-35 | 3-OH | C(CH₃)₃ | 1 |
| A-36 | 3-OH | CH₂CF₃ | 1 |
| A-37 | 2-OH | CH₃ | 1 |
| A-38 | 2-OH | CH₃ | 2 |
| A-39 | 2-OH | CH₂CH₃ | 1 |
| A-40 | 2-OH | CH₂CH₃ | 2 |
| A-41 | 2-OH | (CH₂)₂CH₃ | 1 |
| A-42 | 2-OH | CH(CH₃)₂ | 1 |
| A-43 | 2-OH | CH₂CHCH₂ | 1 |
| A-44 | 2-OH | CH₂CCH | 1 |
| A-45 | 2-OH | cyclo-C₃H₅ | 1 |
| A-46 | 2-OH | CH₂-cyclo-C₃H₅ | 1 |
| A-47 | 2-OH | C(CH₃)₃ | 1 |
| A-48 | 2-OH | CH₂CF₃ | 1 |
| A-49 | 4-SH | CH₃ | 1 |
| A-50 | 4-SH | CH₃ | 2 |
| A-51 | 4-SH | CH₂CH₃ | 1 |
| A-52 | 4-SH | CH₂CH₃ | 2 |
| A-53 | 4-SH | (CH₂)₂CH₃ | 1 |
| A-54 | 4-SH | CH(CH₃)₂ | 1 |
| A-55 | 4-SH | CH₂CHCH₂ | 1 |
| A-56 | 4-SH | CH₂CCH | 1 |
| A-57 | 4-SH | cyclo-C₃H₅ | 1 |
| A-58 | 4-SH | CH₂-cyclo-C₃H₅ | 1 |
| A-59 | 4-SH | C(CH₃)₃ | 1 |
| A-60 | 4-SH | CH₂CF₃ | 1 |
| A-61 | 3-SH | CH₃ | 1 |
| A-62 | 3-SH | CH₃ | 2 |
| A-63 | 3-SH | CH₂CH₃ | 1 |
| A-64 | 3-SH | CH₂CH₃ | 2 |
| A-65 | 3-SH | (CH₂)₂CH₃ | 1 |
| A-66 | 3-SH | CH(CH₃)₂ | 1 |
| A-67 | 3-SH | CH₂CHCH₂ | 1 |
| A-68 | 3-SH | CH₂CCH | 1 |
| A-69 | 3-SH | cyclo-C₃H₅ | 1 |
| A-70 | 3-SH | CH₂-cyclo-C₃H₅ | 1 |
| A-71 | 3-SH | C(CH₃)₃ | 1 |
| A-72 | 3-SH | CH₂CF₃ | 1 |
| A-73 | 2-SH | CH₃ | 1 |
| A-74 | 2-SH | CH₃ | 2 |
| A-75 | 2-SH | CH₂CH₃ | 1 |
| A-76 | 2-SH | CH₂CH₃ | 2 |
| A-77 | 2-SH | (CH₂)₂CH₃ | 1 |
| A-78 | 2-SH | CH(CH₃)₂ | 1 |
| A-79 | 2-SH | CH₂CHCH₂ | 1 |
| A-80 | 2-SH | CH₂CCH | 1 |
| A-81 | 2-SH | cyclo-C₃H₅ | 1 |
| A-82 | 2-SH | CH₂-cyclo-C₃H₅ | 1 |
| A-83 | 2-SH | C(CH₃)₃ | 1 |
| A-84 | 2-SH | CH₂CF₃ | 1 |
| A-85 | 4-F | CH₃ | 1 |
| A-86 | 4-F | CH₃ | 2 |
| A-87 | 4-F | CH₂CH₃ | 1 |
| A-88 | 4-F | CH₂CH₃ | 2 |
| A-89 | 4-F | (CH₂)₂CH₃ | 1 |
| A-90 | 4-F | CH(CH₃)₂ | 1 |
| A-91 | 4-F | CH₂CHCH₂ | 1 |
| A-92 | 4-F | CH₂CCH | 1 |
| A-93 | 4-F | cyclo-C₃H₅ | 1 |
| A-94 | 4-F | CH₂-cyclo-C₃H₅ | 1 |
| A-95 | 4-F | C(CH₃)₃ | 1 |
| A-96 | 4-F | CH₂CF₃ | 1 |
| A-97 | 3-F | CH₃ | 1 |
| A-98 | 3-F | CH₃ | 2 |
| A-99 | 3-F | CH₂CH₃ | 1 |
| A-100 | 3-F | CH₂CH₃ | 2 |
| A-101 | 3-F | (CH₂)₂CH₃ | 1 |
| A-102 | 3-F | CH(CH₃)₂ | 1 |
| A-103 | 3-F | CH₂CHCH₂ | 1 |
| A-104 | 3-F | CH₂CCH | 1 |
| A-105 | 3-F | cyclo-C₃H₅ | 1 |
| A-106 | 3-F | CH₂-cyclo-C₃H₅ | 1 |
| A-107 | 3-F | C(CH₃)₃ | 1 |
| A-108 | 3-F | CH₂CF₃ | 1 |
| A-109 | 2-F | CH₃ | 1 |
| A-110 | 2-F | CH₃ | 2 |
| A-111 | 2-F | CH₂CH₃ | 1 |
| A-112 | 2-F | CH₂CH₃ | 2 |
| A-113 | 2-F | (CH₂)₂CH₃ | 1 |
| A-114 | 2-F | CH(CH₃)₂ | 1 |
| A-115 | 2-F | CH₂CHCH₂ | 1 |
| A-116 | 2-F | CH₂CCH | 1 |
| A-117 | 2-F | cyclo-C₃H₅ | 1 |
| A-118 | 2-F | CH₂-cyclo-C₃H₅ | 1 |
| A-119 | 2-F | C(CH₃)₃ | 1 |
| A-120 | 2-F | CH₂CF₃ | 1 |
| A-121 | 4-Cl | CH₃ | 1 |
| A-122 | 4-Cl | CH₃ | 2 |
| A-123 | 4-Cl | CH₂CH₃ | 1 |
| A-124 | 4-Cl | CH₂CH₃ | 2 |
| A-125 | 4-Cl | (CH₂)₂CH₃ | 1 |
| A-126 | 4-Cl | CH(CH₃)₂ | 1 |
| A-127 | 4-Cl | CH₂CHCH₂ | 1 |
| A-128 | 4-Cl | CH₂CCH | 1 |
| A-129 | 4-Cl | cyclo-C₃H₅ | 1 |
| A-130 | 4-Cl | CH₂-cyclo-C₃H₅ | 1 |
| A-131 | 4-Cl | C(CH₃)₃ | 1 |
| A-132 | 4-Cl | CH₂CF₃ | 1 |
| A-133 | 3-Cl | CH₃ | 1 |
| A-134 | 3-Cl | CH₃ | 2 |
| A-135 | 3-Cl | CH₂CH₃ | 1 |
| A-136 | 3-Cl | CH₂CH₃ | 2 |
| A-137 | 3-Cl | (CH₂)₂CH₃ | 1 |
| A-138 | 3-Cl | CH(CH₃)₂ | 1 |
| A-139 | 3-Cl | CH₂CHCH₂ | 1 |
| A-140 | 3-Cl | CH₂CCH | 1 |
| A-141 | 3-Cl | cyclo-C₃H₅ | 1 |
| A-142 | 3-Cl | CH₂-cyclo-C₃H₅ | 1 |
| A-143 | 3-Cl | C(CH₃)₃ | 1 |
| A-144 | 3-Cl | CH₂CF₃ | 1 |
| A-145 | 2-Cl | CH₃ | 1 |
| A-146 | 2-Cl | CH₃ | 2 |
| A-147 | 2-Cl | CH₂CH₃ | 1 |
| A-148 | 2-Cl | CH₂CH₃ | 2 |
| A-149 | 2-Cl | (CH₂)₂CH₃ | 1 |
| A-150 | 2-Cl | CH(CH₃)₂ | 1 |
| A-151 | 2-Cl | CH₂CHCH₂ | 1 |
| A-152 | 2-Cl | CH₂CCH | 1 |
| A-153 | 2-Cl | cyclo-C₃H₅ | 1 |
| A-154 | 2-Cl | CH₂-cyclo-C₃H₅ | 1 |
| A-155 | 2-Cl | C(CH₃)₃ | 1 |
| A-156 | 2-Cl | CH₂CF₃ | 1 |
| A-157 | 4-Br | CH₃ | 1 |
| A-158 | 4-Br | CH₃ | 2 |
| A-159 | 4-Br | CH₂CH₃ | 1 |
| A-160 | 4-Br | CH₂CH₃ | 2 |
| A-161 | 4-Br | (CH₂)₂CH₃ | 1 |
| A-162 | 4-Br | CH(CH₃)₂ | 1 |
| A-163 | 4-Br | CH₂CHCH₂ | 1 |
| A-164 | 4-Br | CH₂CCH | 1 |
| A-165 | 4-Br | cyclo-C₃H₅ | 1 |
| A-166 | 4-Br | CH₂-cyclo-C₃H₅ | 1 |
| A-167 | 4-Br | C(CH₃)₃ | 1 |
| A-168 | 4-Br | CH₂CF₃ | 1 |
| A-169 | 3-Br | CH₃ | 1 |
| A-170 | 3-Br | CH₃ | 2 |
| A-171 | 3-Br | CH₂CH₃ | 1 |
| A-172 | 3-Br | CH₂CH₃ | 2 |
| A-173 | 3-Br | (CH₂)₂CH₃ | 1 |
| A-174 | 3-Br | CH(CH₃)₂ | 1 |
| A-175 | 3-Br | CH₂CHCH₂ | 1 |
| A-176 | 3-Br | CH₂CCH | 1 |
| A-177 | 3-Br | cyclo-C₃H₅ | 1 |
| A-178 | 3-Br | CH₂-cyclo-C₃H₅ | 1 |
| A-179 | 3-Br | C(CH₃)₃ | 1 |
| A-180 | 3-Br | CH₂CF₃ | 1 |
| A-181 | 2-Br | CH₃ | 1 |
| A-182 | 2-Br | CH₃ | 2 |
| A-183 | 2-Br | CH₂CH₃ | 1 |
| A-184 | 2-Br | CH₂CH₃ | 2 |
| A-185 | 2-Br | (CH₂)₂CH₃ | 1 |
| A-186 | 2-Br | CH(CH₃)₂ | 1 |
| A-187 | 2-Br | CH₂CHCH₂ | 1 |
| A-188 | 2-Br | CH₂CCH | 1 |
| A-189 | 2-Br | cyclo-C₃H₅ | 1 |
| A-190 | 2-Br | CH₂-cyclo-C₃H₅ | 1 |
| A-191 | 2-Br | C(CH₃)₃ | 1 |
| A-192 | 2-Br | CH₂CF₃ | 1 |
| A-193 | 2-I | CH₃ | 1 |
| A-194 | 2-I | CH₃ | 2 |
| A-195 | 2-I | CH₂CH₃ | 1 |
| A-196 | 2-I | CH₂CH₃ | 2 |
| A-197 | 2-I | (CH₂)₂CH₃ | 1 |
| A-198 | 2-I | CH(CH₃)₂ | 1 |
| A-199 | 2-I | CH₂CHCH₂ | 1 |
| A-200 | 2-I | CH₂CCH | 1 |
| A-201 | 2-I | cyclo-C₃H₅ | 1 |
| A-202 | 2-I | CH₂-cyclo-C₃H₅ | 1 |
| A-203 | 2-I | C(CH₃)₃ | 1 |
| A-204 | 2-I | CH₂CF₃ | 1 |
| A-205 | 4-CH₃ | CH₃ | 1 |
| A-206 | 4-CH₃ | CH₃ | 2 |
| A-207 | 4-CH₃ | CH₂CH₃ | 1 |
| A-208 | 4-CH₃ | CH₂CH₃ | 2 |
| A-209 | 4-CH₃ | (CH₂)₂CH₃ | 1 |
| A-210 | 4-CH₃ | CH(CH₃)₂ | 1 |
| A-211 | 4-CH₃ | CH₂CHCH₂ | 1 |
| A-212 | 4-CH₃ | CH₂CCH | 1 |
| A-213 | 4-CH₃ | cyclo-C₃H₅ | 1 |
| A-214 | 4-CH₃ | CH₂-cyclo-C₃H₅ | 1 |
| A-215 | 4-CH₃ | C(CH₃)₃ | 1 |
| A-216 | 4-CH₃ | CH₂CF₃ | 1 |
| A-217 | 3-CH₃ | CH₃ | 1 |
| A-218 | 3-CH₃ | CH₃ | 2 |
| A-219 | 3-CH₃ | CH₂CH₃ | 1 |
| A-220 | 3-CH₃ | CH₂CH₃ | 2 |
| A-221 | 3-CH₃ | (CH₂)₂CH₃ | 1 |
| A-222 | 3-CH₃ | CH(CH₃)₂ | 1 |
| A-223 | 3-CH₃ | CH₂CHCH₂ | 1 |
| A-224 | 3-CH₃ | CH₂CCH | 1 |
| A-225 | 3-CH₃ | cyclo-C₃H₅ | 1 |
| A-226 | 3-CH₃ | CH₂-cyclo-C₃H₅ | 1 |
| A-227 | 3-CH₃ | C(CH₃)₃ | 1 |
| A-228 | 3-CH₃ | CH₂CF₃ | 1 |
| A-229 | 2-CH₃ | CH₃ | 1 |
| A-230 | 2-CH₃ | CH₃ | 2 |
| A-231 | 2-CH₃ | CH₂CH₃ | 1 |
| A-232 | 2-CH₃ | CH₂CH₃ | 2 |
| A-233 | 2-CH₃ | (CH₂)₂CH₃ | 1 |
| A-234 | 2-CH₃ | CH(CH₃)₂ | 1 |
| A-235 | 2-CH₃ | CH₂CHCH₂ | 1 |
| A-236 | 2-CH₃ | CH₂CCH | 1 |
| A-237 | 2-CH₃ | cyclo-C₃H₅ | 1 |
| A-238 | 2-CH₃ | CH₂-cyclo-C₃H₅ | 1 |
| A-239 | 2-CH₃ | C(CH₃)₃ | 1 |
| A-240 | 2-CH₃ | CH₂CF₃ | 1 |
| A-241 | 2-CH₂CH₃ | CH₃ | 1 |
| A-242 | 2-CH₂CH₃ | CH₃ | 2 |
| A-243 | 2-CH₂CH₃ | CH₂CH₃ | 1 |
| A-244 | 2-CH₂CH₃ | CH₂CH₃ | 2 |
| A-245 | 2-CH₂CH₃ | (CH₂)₂CH₃ | 1 |
| A-246 | 2-CH₂CH₃ | CH(CH₃)₂ | 1 |
| A-247 | 2-CH₂CH₃ | CH₂CHCH₂ | 1 |
| A-248 | 2-CH₂CH₃ | CH₂CCH | 1 |
| A-249 | 2-CH₂CH₃ | cyclo-C₃H₅ | 1 |
| A-250 | 2-CH₂CH₃ | CH₂-cyclo-C₃H₅ | 1 |
| A-251 | 2-CH₂CH₃ | C(CH₃)₃ | 1 |
| A-252 | 2-CH₂CH₃ | CH₂CF₃ | 1 |
| A-253 | 2-(CH₂)₂CH₃ | CH₃ | 1 |
| A-254 | 2-(CH₂)₂CH₃ | CH₃ | 2 |
| A-255 | 2-(CH₂)₂CH₃ | CH₂CH₃ | 1 |
| A-256 | 2-(CH₂)₂CH₃ | CH₂CH₃ | 2 |
| A-257 | 2-(CH₂)₂CH₃ | (CH₂)₂CH₃ | 1 |
| A-258 | 2-(CH₂)₂CH₃ | CH(CH₃)₂ | 1 |
| A-259 | 2-(CH₂)₂CH₃ | CH₂CHCH₂ | 1 |
| A-260 | 2-(CH₂)₂CH₃ | CH₂CCH | 1 |
| A-261 | 2-(CH₂)₂CH₃ | cyclo-C₃H₅ | 1 |
| A-262 | 2-(CH₂)₂CH₃ | CH₂-cyclo-C₃H₅ | 1 |
| A-263 | 2-(CH₂)₂CH₃ | C(CH₃)₃ | 1 |
| A-264 | 2-(CH₂)₂CH₃ | CH₂CF₃ | 1 |
| A-265 | 2-CH(CH₃)₂ | CH₃ | 1 |
| A-266 | 2-CH(CH₃)₂ | CH₃ | 2 |
| A-267 | 2-CH(CH₃)₂ | CH₂CH₃ | 1 |
| A-268 | 2-CH(CH₃)₂ | CH₂CH₃ | 2 |
| A-269 | 2-CH(CH₃)₂ | (CH₂)₂CH₃ | 1 |
| A-270 | 2-CH(CH₃)₂ | CH(CH₃)₂ | 1 |
| A-271 | 2-CH(CH₃)₂ | CH₂CHCH₂ | 1 |
| A-272 | 2-CH(CH₃)₂ | CH₂CCH | 1 |
| A-273 | 2-CH(CH₃)₂ | cyclo-C₃H₅ | 1 |
| A-274 | 2-CH(CH₃)₂ | CH₂-cyclo-C₃H₅ | 1 |
| A-275 | 2-CH(CH₃)₂ | C(CH₃)₃ | 1 |
| A-276 | 2-CH(CH₃)₂ | CH₂CF₃ | 1 |
| A-277 | 2-(CH₂)₃CH₃ | CH₃ | 1 |
| A-278 | 2-(CH₂)₃CH₃ | CH₃ | 2 |
| A-279 | 2-(CH₂)₃CH₃ | CH₂CH₃ | 1 |
| A-280 | 2-(CH₂)₃CH₃ | CH₂CH₃ | 2 |
| A-281 | 2-(CH₂)₃CH₃ | (CH₂)₂CH₃ | 1 |
| A-282 | 2-(CH₂)₃CH₃ | CH(CH₃)₂ | 1 |
| A-283 | 2-(CH₂)₃CH₃ | CH₂CHCH₂ | 1 |
| A-284 | 2-(CH₂)₃CH₃ | CH₂CCH | 1 |
| A-285 | 2-(CH₂)₃CH₃ | cyclo-C₃H₅ | 1 |
| A-286 | 2-(CH₂)₃CH₃ | CH₂-cyclo-C₃H₅ | 1 |
| A-287 | 2-(CH₂)₃CH₃ | C(CH₃)₃ | 1 |
| A-288 | 2-(CH₂)₃CH₃ | CH₂CF₃ | 1 |
| A-289 | 2-C(CH₃)₃ | CH₃ | 1 |
| A-290 | 2-C(CH₃)₃ | CH₃ | 2 |
| A-291 | 2-C(CH₃)₃ | CH₂CH₃ | 1 |
| A-292 | 2-C(CH₃)₃ | CH₂CH₃ | 2 |
| A-293 | 2-C(CH₃)₃ | (CH₂)₂CH₃ | 1 |
| A-294 | 2-C(CH₃)₃ | CH(CH₃)₂ | 1 |
| A-295 | 2-C(CH₃)₃ | CH₂CHCH₂ | 1 |
| A-296 | 2-C(CH₃)₃ | CH₂CCH | 1 |
| A-297 | 2-C(CH₃)₃ | cyclo-C₃H₅ | 1 |
| A-298 | 2-C(CH₃)₃ | CH₂-cyclo-C₃H₅ | 1 |
| A-299 | 2-C(CH₃)₃ | C(CH₃)₃ | 1 |
| A-300 | 2-C(CH₃)₃ | CH₂CF₃ | 1 |
| A-301 | 2-CH₂CHCH₂ | CH₃ | 1 |
| A-302 | 2-CH₂CHCH₂ | CH₃ | 2 |
| A-303 | 2-CH₂CHCH₂ | CH₂CH₃ | 1 |
| A-304 | 2-CH₂CHCH₂ | CH₂CH₃ | 2 |
| A-305 | 2-CH₂CHCH₂ | (CH₂)₂CH₃ | 1 |
| A-306 | 2-CH₂CHCH₂ | CH(CH₃)₂ | 1 |
| A-307 | 2-CH₂CHCH₂ | CH₂CHCH₂ | 1 |
| A-308 | 2-CH₂CHCH₂ | CH₂CCH | 1 |
| A-309 | 2-CH₂CHCH₂ | cyclo-C₃H₅ | 1 |
| A-310 | 2-CH₂CHCH₂ | CH₂-cyclo-C₃H₅ | 1 |
| A-311 | 2-CH₂CHCH₂ | C(CH₃)₃ | 1 |
| A-312 | 2-CH₂CHCH₂ | CH₂CF₃ | 1 |
| A-313 | 2-CH₂CCH | CH₃ | 1 |
| A-314 | 2-CH₂CCH | CH₃ | 2 |
| A-315 | 2-CH₂CCH | CH₂CH₃ | 1 |
| A-316 | 2-CH₂CCH | CH₂CH₃ | 2 |
| A-317 | 2-CH₂CCH | (CH₂)₂CH₃ | 1 |
| A-318 | 2-CH₂CCH | CH(CH₃)₂ | 1 |
| A-319 | 2-CH₂CCH | CH₂CHCH₂ | 1 |
| A-320 | 2-CH₂CCH | CH₂CCH | 1 |
| A-321 | 2-CH₂CCH | cyclo-C₃H₅ | 1 |
| A-322 | 2-CH₂CCH | CH₂-cyclo-C₃H₅ | 1 |
| A-323 | 2-CH₂CCH | C(CH₃)₃ | 1 |
| A-324 | 2-CH₂CCH | CH₂CF₃ | 1 |
| A-325 | 4-CF₃ | CH₃ | 1 |
| A-326 | 4-CF₃ | CH₃ | 2 |
| A-327 | 4-CF₃ | CH₂CH₃ | 1 |
| A-328 | 4-CF₃ | CH₂CH₃ | 2 |
| A-329 | 4-CF₃ | (CH₂)₂CH₃ | 1 |
| A-330 | 4-CF₃ | CH(CH₃)₂ | 1 |
| A-331 | 4-CF₃ | CH₂CHCH₂ | 1 |
| A-332 | 4-CF₃ | CH₂CCH | 1 |
| A-333 | 4-CF₃ | cyclo-C₃H₅ | 1 |
| A-334 | 4-CF₃ | CH₂-cyclo-C₃H₅ | 1 |
| A-335 | 4-CF₃ | C(CH₃)₃ | 1 |
| A-336 | 4-CF₃ | CH₂CF₃ | 1 |
| A-337 | 3-CF₃ | CH₃ | 1 |
| A-338 | 3-CF₃ | CH₃ | 2 |
| A-339 | 3-CF₃ | CH₂CH₃ | 1 |
| A-340 | 3-CF₃ | CH₂CH₃ | 2 |
| A-341 | 3-CF₃ | (CH₂)₂CH₃ | 1 |
| A-342 | 3-CF₃ | CH(CH₃)₂ | 1 |
| A-343 | 3-CF₃ | CH₂CHCH₂ | 1 |
| A-344 | 3-CF₃ | CH₂CCH | 1 |
| A-345 | 3-CF₃ | cyclo-C₃H₅ | 1 |
| A-346 | 3-CF₃ | CH₂-cyclo-C₃H₅ | 1 |
| A-347 | 3-CF₃ | C(CH₃)₃ | 1 |
| A-348 | 3-CF₃ | CH₂CF₃ | 1 |
| A-349 | 2-CF₃ | CH₃ | 1 |
| A-350 | 2-CF₃ | CH₃ | 2 |
| A-351 | 2-CF₃ | CH₂CH₃ | 1 |
| A-352 | 2-CF₃ | CH₂CH₃ | 2 |
| A-353 | 2-CF₃ | (CH₂)₂CH₃ | 1 |
| A-354 | 2-CF₃ | CH(CH₃)₂ | 1 |
| A-355 | 2-CF₃ | CH₂CHCH₂ | 1 |
| A-356 | 2-CF₃ | CH₂CCH | 1 |
| A-357 | 2-CF₃ | cyclo-C₃H₅ | 1 |
| A-358 | 2-CF₃ | CH₂-cyclo-C₃H₅ | 1 |
| A-359 | 2-CF₃ | C(CH₃)₃ | 1 |
| A-360 | 2-CF₃ | CH₂CF₃ | 1 |
| A-361 | 4-OCH₃ | CH₃ | 1 |
| A-362 | 4-OCH₃ | CH₃ | 2 |
| A-363 | 4-OCH₃ | CH₂CH₃ | 1 |
| A-364 | 4-OCH₃ | CH₂CH₃ | 2 |
| A-365 | 4-OCH₃ | (CH₂)₂CH₃ | 1 |
| A-366 | 4-OCH₃ | CH(CH₃)₂ | 1 |
| A-367 | 4-OCH₃ | CH₂CHCH₂ | 1 |
| A-368 | 4-OCH₃ | CH₂CCH | 1 |
| A-369 | 4-OCH₃ | cyclo-C₃H₅ | 1 |
| A-370 | 4-OCH₃ | CH₂-cyclo-C₃H₅ | 1 |
| A-371 | 4-OCH₃ | C(CH₃)₃ | 1 |
| A-372 | 4-OCH₃ | CH₂CF₃ | 1 |
| A-373 | 3-OCH₃ | CH₃ | 1 |
| A-374 | 3-OCH₃ | CH₃ | 2 |
| A-375 | 3-OCH₃ | CH₂CH₃ | 1 |
| A-376 | 3-OCH₃ | CH₂CH₃ | 2 |
| A-377 | 3-OCH₃ | (CH₂)₂CH₃ | 1 |
| A-378 | 3-OCH₃ | CH(CH₃)₂ | 1 |
| A-379 | 3-OCH₃ | CH₂CHCH₂ | 1 |
| A-380 | 3-OCH₃ | CH₂CCH | 1 |
| A-381 | 3-OCH₃ | cyclo-C₃H₅ | 1 |
| A-382 | 3-OCH₃ | CH₂-cyclo-C₃H₅ | 1 |
| A-383 | 3-OCH₃ | C(CH₃)₃ | 1 |
| A-384 | 3-OCH₃ | CH₂CF₃ | 1 |
| A-385 | 2-OCH₃ | CH₃ | 1 |
| A-386 | 2-OCH₃ | CH₃ | 2 |
| A-387 | 2-OCH₃ | CH₂CH₃ | 1 |
| A-388 | 2-OCH₃ | CH₂CH₃ | 2 |
| A-389 | 2-OCH₃ | (CH₂)₂CH₃ | 1 |
| A-390 | 2-OCH₃ | CH(CH₃)₂ | 1 |
| A-391 | 2-OCH₃ | CH₂CHCH₂ | 1 |
| A-392 | 2-OCH₃ | CH₂CCH | 1 |
| A-393 | 2-OCH₃ | cyclo-C₃H₅ | 1 |
| A-394 | 2-OCH₃ | CH₂-cyclo-C₃H₅ | 1 |
| A-395 | 2-OCH₃ | C(CH₃)₃ | 1 |
| A-396 | 2-OCH₃ | CH₂CF₃ | 1 |
| A-397 | 4-OCF₃ | CH₃ | 1 |
| A-398 | 4-OCF₃ | CH₃ | 2 |
| A-399 | 4-OCF₃ | CH₂CH₃ | 1 |
| A-400 | 4-OCF₃ | CH₂CH₃ | 2 |
| A-401 | 4-OCF₃ | (CH₂)₂CH₃ | 1 |
| A-402 | 4-OCF₃ | CH(CH₃)₂ | 1 |
| A-403 | 4-OCF₃ | CH₂CHCH₂ | 1 |
| A-404 | 4-OCF₃ | CH₂CCH | 1 |
| A-405 | 4-OCF₃ | cyclo-C₃H₅ | 1 |
| A-406 | 4-OCF₃ | CH₂-cyclo-C₃H₅ | 1 |
| A-407 | 4-OCF₃ | C(CH₃)₃ | 1 |
| A-408 | 4-OCF₃ | CH₂CF₃ | 1 |
| A-409 | 3-OCF₃ | CH₃ | 1 |
| A-410 | 3-OCF₃ | CH₃ | 2 |
| A-411 | 3-OCF₃ | CH₂CH₃ | 1 |
| A-412 | 3-OCF₃ | CH₂CH₃ | 2 |
| A-413 | 3-OCF₃ | (CH₂)₂CH₃ | 1 |
| A-414 | 3-OCF₃ | CH(CH₃)₂ | 1 |
| A-415 | 3-OCF₃ | CH₂CHCH₂ | 1 |
| A-416 | 3-OCF₃ | CH₂CCH | 1 |
| A-417 | 3-OCF₃ | cyclo-C₃H₅ | 1 |
| A-418 | 3-OCF₃ | CH₂-cyclo-C₃H₅ | 1 |
| A-419 | 3-OCF₃ | C(CH₃)₃ | 1 |
| A-420 | 3-OCF₃ | CH₂CF₃ | 1 |
| A-421 | 2-OCF₃ | CH₃ | 1 |
| A-422 | 2-OCF₃ | CH₃ | 2 |
| A-423 | 2-OCF₃ | CH₂CH₃ | 1 |
| A-424 | 2-OCF₃ | CH₂CH₃ | 2 |
| A-425 | 2-OCF₃ | (CH₂)₂CH₃ | 1 |
| A-426 | 2-OCF₃ | CH(CH₃)₂ | 1 |
| A-427 | 2-OCF₃ | CH₂CHCH₂ | 1 |
| A-428 | 2-OCF₃ | CH₂CCH | 1 |
| A-429 | 2-OCF₃ | cyclo-C₃H₅ | 1 |
| A-430 | 2-OCF₃ | CH₂-cyclo-C₃H₅ | 1 |
| A-431 | 2-OCF₃ | C(CH₃)₃ | 1 |
| A-432 | 2-OCF₃ | CH₂CF₃ | 1 |
| A-433 | 2-SCH₃ | CH₃ | 1 |
| A-434 | 2-SCH₃ | CH₃ | 2 |
| A-435 | 2-SCH₃ | CH₂CH₃ | 1 |
| A-436 | 2-SCH₃ | CH₂CH₃ | 2 |
| A-437 | 2-SCH₃ | (CH₂)₂CH₃ | 1 |
| A-438 | 2-SCH₃ | CH(CH₃)₂ | 1 |
| A-439 | 2-SCH₃ | CH₂CHCH₂ | 1 |
| A-440 | 2-SCH₃ | CH₂CCH | 1 |
| A-441 | 2-SCH₃ | cyclo-C₃H₅ | 1 |
| A-442 | 2-SCH₃ | CH₂-cyclo-C₃H₅ | 1 |
| A-443 | 2-SCH₃ | C(CH₃)₃ | 1 |
| A-444 | 2-SCH₃ | CH₂CF₃ | 1 |
| A-445 | 3-SCH₃ | CH₃ | 1 |
| A-446 | 3-SCH₃ | CH₃ | 2 |
| A-447 | 3-SCH₃ | CH₂CH₃ | 1 |
| A-448 | 3-SCH₃ | CH₂CH₃ | 2 |
| A-449 | 3-SCH₃ | (CH₂)₂CH₃ | 1 |
| A-450 | 3-SCH₃ | CH(CH₃)₂ | 1 |
| A-451 | 3-SCH₃ | CH₂CHCH₂ | 1 |
| A-452 | 3-SCH₃ | CH₂CCH | 1 |
| A-453 | 3-SCH₃ | cyclo-C₃H₅ | 1 |
| A-454 | 3-SCH₃ | CH₂-cyclo-C₃H₅ | 1 |
| A-455 | 3-SCH₃ | C(CH₃)₃ | 1 |
| A-456 | 3-SCH₃ | CH₂CF₃ | 1 |
| A-457 | 4-SCH₃ | CH₃ | 1 |
| A-458 | 4-SCH₃ | CH₃ | 2 |
| A-459 | 4-SCH₃ | CH₂CH₃ | 1 |
| A-460 | 4-SCH₃ | CH₂CH₃ | 2 |
| A-461 | 4-SCH₃ | (CH₂)₂CH₃ | 1 |
| A-462 | 4-SCH₃ | CH(CH₃)₂ | 1 |
| A-463 | 4-SCH₃ | CH₂CHCH₂ | 1 |
| A-464 | 4-SCH₃ | CH₂CCH | 1 |
| A-465 | 4-SCH₃ | cyclo-C₃H₅ | 1 |
| A-466 | 4-SCH₃ | CH₂-cyclo-C₃H₅ | 1 |
| A-467 | 4-SCH₃ | C(CH₃)₃ | 1 |
| A-468 | 4-SCH₃ | CH₂CF₃ | 1 |
| A-469 | 2-SCH₂CH₃ | CH₃ | 1 |
| A-470 | 2-SCH₂CH₃ | CH₃ | 2 |
| A-471 | 2-SCH₂CH₃ | CH₂CH₃ | 1 |
| A-472 | 2-SCH₂CH₃ | CH₂CH₃ | 2 |
| A-473 | 2-SCH₂CH₃ | (CH₂)₂CH₃ | 1 |
| A-474 | 2-SCH₂CH₃ | CH(CH₃)₂ | 1 |
| A-475 | 2-SCH₂CH₃ | CH₂CHCH₂ | 1 |
| A-476 | 2-SCH₂CH₃ | CH₂CCH | 1 |
| A-477 | 2-SCH₂CH₃ | cyclo-C₃H₅ | 1 |
| A-478 | 2-SCH₂CH₃ | CH₂-cyclo-C₃H₅ | 1 |
| A-479 | 2-SCH₂CH₃ | C(CH₃)₃ | 1 |
| A-480 | 2-SCH₂CH₃ | CH₂CF₃ | 1 |
| A-481 | 2-SCH(CH₃)₂ | CH₃ | 1 |
| A-482 | 2-SCH(CH₃)₂ | CH₃ | 2 |
| A-483 | 2-SCH(CH₃)₂ | CH₂CH₃ | 1 |
| A-484 | 2-SCH(CH₃)₂ | CH₂CH₃ | 2 |
| A-485 | 2-SCH(CH₃)₂ | (CH₂)₂CH₃ | 1 |
| A-486 | 2-SCH(CH₃)₂ | CH(CH₃)₂ | 1 |
| A-487 | 2-SCH(CH₃)₂ | CH₂CHCH₂ | 1 |
| A-488 | 2-SCH(CH₃)₂ | CH₂CCH | 1 |
| A-489 | 2-SCH(CH₃)₂ | cyclo-C₃H₅ | 1 |
| A-490 | 2-SCH(CH₃)₂ | CH₂-cyclo-C₃H₅ | 1 |
| A-491 | 2-SCH(CH₃)₂ | C(CH₃)₃ | 1 |
| A-492 | 2-SCH(CH₃)₂ | CH₂CF₃ | 1 |
| A-493 | 2-SCH₂CCH | CH₃ | 1 |
| A-494 | 2-SCH₂CCH | CH₃ | 2 |
| A-495 | 2-SCH₂CCH | CH₂CH₃ | 1 |
| A-496 | 2-SCH₂CCH | CH₂CH₃ | 2 |
| A-497 | 2-SCH₂CCH | (CH₂)₂CH₃ | 1 |
| A-498 | 2-SCH₂CCH | CH(CH₃)₂ | 1 |
| A-499 | 2-SCH₂CCH | CH₂CHCH₂ | 1 |
| A-500 | 2-SCH₂CCH | CH₂CCH | 1 |
| A-501 | 2-SCH₂CCH | cyclo-C₃H₅ | 1 |
| A-502 | 2-SCH₂CCH | CH₂-cyclo-C₃H₅ | 1 |
| A-503 | 2-SCH₂CCH | C(CH₃)₃ | 1 |
| A-504 | 2-SCH₂CCH | CH₂CF₃ | 1 |
| A-505 | 4-SCF₃ | CH₃ | 1 |
| A-506 | 4-SCF₃ | CH₃ | 2 |
| A-507 | 4-SCF₃ | CH₂CH₃ | 1 |
| A-508 | 4-SCF₃ | CH₂CH₃ | 2 |
| A-509 | 4-SCF₃ | (CH₂)₂CH₃ | 1 |
| A-510 | 4-SCF₃ | CH(CH₃)₂ | 1 |
| A-511 | 4-SCF₃ | CH₂CHCH₂ | 1 |
| A-512 | 4-SCF₃ | CH₂CCH | 1 |
| A-513 | 4-SCF₃ | cyclo-C₃H₅ | 1 |
| A-514 | 4-SCF₃ | CH₂-cyclo-C₃H₅ | 1 |
| A-515 | 4-SCF₃ | C(CH₃)₃ | 1 |
| A-516 | 4-SCF₃ | CH₂CF₃ | 1 |
| A-517 | 3-SCF₃ | CH₃ | 1 |
| A-518 | 3-SCF₃ | CH₃ | 2 |
| A-519 | 3-SCF₃ | CH₂CH₃ | 1 |
| A-520 | 3-SCF₃ | CH₂CH₃ | 2 |
| A-521 | 3-SCF₃ | (CH₂)₂CH₃ | 1 |
| A-522 | 3-SCF₃ | CH(CH₃)₂ | 1 |
| A-523 | 3-SCF₃ | CH₂CHCH₂ | 1 |
| A-524 | 3-SCF₃ | CH₂CCH | 1 |
| A-525 | 3-SCF₃ | cyclo-C₃H₅ | 1 |
| A-526 | 3-SCF₃ | CH₂-cyclo-C₃H₅ | 1 |
| A-527 | 3-SCF₃ | C(CH₃)₃ | 1 |
| A-528 | 3-SCF₃ | CH₂CF₃ | 1 |
| A-529 | 2-SCF₃ | CH₃ | 1 |
| A-530 | 2-SCF₃ | CH₃ | 2 |
| A-531 | 2-SCF₃ | CH₂CH₃ | 1 |
| A-532 | 2-SCF₃ | CH₂CH₃ | 2 |
| A-533 | 2-SCF₃ | (CH₂)₂CH₃ | 1 |
| A-534 | 2-SCF₃ | CH(CH₃)₂ | 1 |
| A-535 | 2-SCF₃ | CH₂CHCH₂ | 1 |
| A-536 | 2-SCF₃ | CH₂CCH | 1 |
| A-537 | 2-SCF₃ | cyclo-C₃H₅ | 1 |
| A-538 | 2-SCF₃ | CH₂-cyclo-C₃H₅ | 1 |
| A-539 | 2-SCF₃ | C(CH₃)₃ | 1 |
| A-540 | 2-SCF₃ | CH₂CF₃ | 1 |
| A-541 | 2-cyclo-C₃H₅ | CH₃ | 1 |
| A-542 | 2-cyclo-C₃H₅ | CH₃ | 2 |
| A-543 | 2-cyclo-C₃H₅ | CH₂CH₃ | 1 |
| A-544 | 2-cyclo-C₃H₅ | CH₂CH₃ | 2 |
| A-545 | 2-cyclo-C₃H₅ | (CH₂)₂CH₃ | 1 |
| A-546 | 2-cyclo-C₃H₅ | CH(CH₃)₂ | 1 |
| A-547 | 2-cyclo-C₃H₅ | CH₂CHCH₂ | 1 |
| A-548 | 2-cyclo-C₃H₅ | CH₂CCH | 1 |
| A-549 | 2-cyclo-C₃H₅ | cyclo-C₃H₅ | 1 |
| A-550 | 2-cyclo-C₃H₅ | CH₂-cyclo-C₃H₅ | 1 |
| A-551 | 2-cyclo-C₃H₅ | C(CH₃)₃ | 1 |
| A-552 | 2-cyclo-C₃H₅ | CH₂CF₃ | 1 |
| A-553 | 2-CH₂-cyclo-C₃H₅ | CH₃ | 1 |
| A-554 | 2-CH₂-cyclo-C₃H₅ | CH₃ | 2 |
| A-555 | 2-CH₂-cyclo-C₃H₅ | CH₂CH₃ | 1 |
| A-556 | 2-CH₂-cyclo-C₃H₅ | CH₂CH₃ | 2 |
| A-557 | 2-CH₂-cyclo-C₃H₅ | (CH₂)₂CH₃ | 1 |
| A-558 | 2-CH₂-cyclo-C₃H₅ | CH(CH₃)₂ | 1 |
| A-559 | 2-CH₂-cyclo-C₃H₅ | CH₂CHCH₂ | 1 |
| A-560 | 2-CH₂-cyclo-C₃H₅ | CH₂CCH | 1 |
| A-561 | 2-CH₂-cyclo-C₃H₅ | cyclo-C₃H₅ | 1 |
| A-562 | 2-CH₂-cyclo-C₃H₅ | CH₂-cyclo-C₃H₅ | 1 |
| A-563 | 2-CH₂-cyclo-C₃H₅ | C(CH₃)₃ | 1 |
| A-564 | 2-CH₂-cyclo-C₃H₅ | CH₂CF₃ | 1 |
| A-565 | 2,4-Cl₂ | CH₃ | 1 |
| A-566 | 2,4-Cl₂ | CH₂CH₃ | 1 |
| A-567 | 2,4-Cl₂ | CH₂CHCH₂ | 1 |
| A-568 | 2,4-Cl₂ | CH₂CCH | 1 |
| A-569 | 2,4-Cl₂ | cyclo-C₃H₅ | 1 |
| A-570 | 2,4-Cl₂ | CH₂-cyclo-C₃H₅ | 1 |
| A-571 | 2,4-Cl₂ | CH₂CF₃ | 1 |
| A-572 | 2,4-(CH₃)₂ | CH₃ | 1 |
| A-573 | 2,4-(CH₃)₂ | CH₂CH₃ | 1 |
| A-574 | 2,4-(CH₃)₂ | CH₂CHCH₂ | 1 |
| A-575 | 2,4-(CH₃)₂ | CH₂CCH | 1 |
| A-576 | 2,4-(CH₃)₂ | cyclo-C₃H₅ | 1 |
| A-577 | 2,4-(CH₃)₂ | CH₂-cyclo-C₃H₅ | 1 |
| A-578 | 2,4-(CH₃)₂ | CH₂CF₃ | 1 |

The compounds of the formula I are suitable for efficiently controlling nematodes, insects, and arachnids in crop protection. In particular, they are suitable for controlling the following animal pests:

insects from the order of the lepidopterans (Lepidoptera), for example Agrotis ypsilon, Agrotis segetum, Alabama argillacea, Anticarsia gemmatalis, Argyresthia conjugella, Autographa gamma, Bupalus piniarius, Cacoecia murinana, Capua reticulana, Cheimatobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sftotroga cerealella, Sparganothis pilleriana, Spodoptera frugiperda, Spodoptera eridania, Spodoptera littoralis, Spodoptera litura, Thaumatopoea pityocampa, Tortrix viridana, Trichoplusia ni and Zeiraphera canadensis,

beetles (Coleoptera), for example Agrilus sinuatus, Agriotes lineatus, Agriotes obscurus, Amphimallus solstitialis, Anisandrus dispar, Anthonomus grandis, Anthonomus pomorum, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Ceuthorrhynchus assimilis, Ceuthorrhynchus napi, Chaetocnema tibialis, Conoderus vespertinus, Crioceris asparagi, Diabrotica longicornis, Diabrotica 12-punctata, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus, Lissorhoptrus oryzophilus, Melanotus communis, Meligethes aeneus, Melolontha hippocastani, Melolontha melolontha, Oulema oryzae, Ortiorrhynchus sulcatus, Otiorrhynchus ovatus, Phaedon cochleariae, Phyllotreta chrysocephala, Phyllophaga sp., Phyllopertha horticola, Phyllotreta nemorum, Phyllotreta striolata, Popillia japonica, Sitona lineatus and Sitophilus granaria,

dipterans (Diptera), for example Aedes aegypti, Aedes vexans, Anastrepha ludens, Anopheles maculipennis, Ceratitis capitata, Chrysomya bezziana, Chrysomya hominivorax, Chrysomya macellaria, Contarinia sorghicola, Cordylobia anthropophaga, Culex pipiens, Dacus cucurbitae, Dacus oleae, Dasineura brassicae, Fannia canicularis, Gasterophilus intestinalis, Glossina morsitans, Haematobia initans, Haplodiplosis equestris, Hylemyia platura, Hypoderma lineata, Liriomyza sativae, Liriomyza trifolii, Lucilia caprina, Lucilia cuprina, Lucilia sericata, Lycoria pectoralis, Mayetiola destructor, Musca domestica, Muscina stabulans, Oestrus ovis, Oscinella frit, Pegomya hysocyami, Phorbia antiqua, Phorbia brassicae, Phorbia coarctata, Rhagoletis cerasi, Rhagoletis pomonella, Tabanus bovinus, Tipula oleracea and Tipula paludosa,

thrips (Thysanoptera), e.g. Frankliniella fusca, Frankliniella occidentalis, Frankliniella tritici, Scirtothrips citri, Thrips oryzae, Thrips palmi and Thrips tabaci,

hymenopterans (Hymenoptera), e.g. Athalia rosae, Atta cephalotes, Atta sexdens, Atta texana, Hoplocampa minuta, Hoplocampa testudinea, Monomorium pharaonis, Solenopsis geminata and Solenopsis invicta,

heteropterans (Heteroptera), e.g. Acrosternum hilare, Blissus leucopterus, Cyrtopeltis notatus, Dysdercus cingulatus, Dysdercus intermedius, Eurygaster integriceps, Euschistus impictiventris, Leptoglossus phyllopus, Lygus lineolaris, Lygus pratensis, Nezara viridula, Piesma quadrata, Solubea insularis and Thyanta perditor,

homopterans (Homoptera), e.g. Acyrthosiphon onobrychis, Adelges laricis, Aphidula nasturtli, Aphis fabae, Aphis forbesi, Aphis pomi, Aphis gossypii, Aphis grossulariae, Aphis schneideri, Aphis spiraecola, Aphis sambuci, Acyrthosiphon pisum, Aulacorthum solani, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzodes persicae, Myzus ascalonicus, Myzus cerasi, Myzus varians, Nasonovia ribis-nigri, Nilaparvata lugens, Pemphigus bursarius, Perkinsiella saccharicida, Phorodon humuli, Psylla mali, Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Trialeurodes vaporariorum, Toxoptera aurantiiand, and Viteus vitifolii.

termites (Isoptera), e.g. Calotermes flavicollis, Leucotermes flavipes, Reticulitermes lucifugus und Termes natalensis,

orthopterans (Orthoptera), e.g. Acheta domestica, Blatta orientalis, Blaftella germanica, Forficula auricularia, Gryllotalpa gryllotalpa, Locusta migratoria, Melanoplus bivittatus, Melanoplus femur-rubrum, Melanoplus mexicanus, Melanoplus sanguinipes, Melanoplus spretus, Nomadacris septemfasciata, Periplaneta americana, Schistocerca americana, Schistocerca peregrina, Stauronotus maroccanus and Tachycines asynamorus,

Arachnoidea, such as arachnids (Acarina), e.g. of the families Argasidae, lxodidae and Sarcoptidae, such as Amblyomma americanum, Amblyomma variegatum, Argas persicus, Boophilus annulatus, Boophilus decoloratus, Boophilus microplus, Dermacentor silvarum, Hyalomma truncatum, Ixodes ricinus, Ixodes rubicundus, Ornithodorus moubata, Otobius megnini, Dermanyssus gallinae, Psoroptes ovis, Rhipicephalus appendiculatus, Rhipicephalus evertsi, Sarcoptes scabiei, and Eriophyidae spp. such as Aculus schlechtendali, Phyllocoptrata oleivora and Eriophyes sheldoni; Tarsonemidae spp. such as Phytonemus pallidus and Polyphagotarsonemus latus; Tenuipalpidae spp. such as Brevipalpus phoenicis; Tetranychidae spp. such as Tetranychus cinnabarinus, Tetranychus kanzawai, Tetranychus pacificus, Tetranychus telarius and Tetranychus urticae, Panonychus ulmi, Panonychus citri, and oligonychus pratensis;

Nematodes, including plant parasitic nematodes and nematodes living in the soil. Plant parasitic nematodes include, such as root knot nematodes, Meloidogyne hapla, Meloidogyne incognita, Meloidogyne javanica, and other Meloidogyne species; cyst-forming nematodes, Globodera rostochiensis and other Globodera species; Heterodera avenae, Heterodera glycines, Heterodera schachtii, Heterodera trifolii, and other Heterodera species; Seed gall nematodes, Anguina species; Stem and foliar nematodes, Aphelenchoides species; Sting nematodes, Belonolaimus longicaudatus and other Belonolaimus species; Pine nematodes, Bursaphelenchus xylophilus and other Bursaphelenchus species; Ring nematodes, Criconema species, Criconemella species, Criconemoides species, Mesocriconema species; Stem and bulb nematodes, Ditylenchus destructor, Ditylenchus dipsaci and other Ditylenchus species; Awl nematodes, Dolichodorus species; Spiral nematodes, Heliocotylenchus multicinctus and other Helicotylenchus species; Sheath and sheathoid nematodes, Hemicycliophora species and Hemicriconemoides species; Hirshmanniella species; Lance nematodes, Hoploaimus species; false rootknot nematodes, Nacobbus species; Needle nematodes, Longidorus elongatus and other Longidorus species; Pin nematodes, Paratylenchus species; Lesion nematodes, Pratylenchus neglectus, Pratylenchus penetrans, Pratylenchus curvitatus, Pratylenchus goodeyi and other Pratylenchus species; Burrowing nematodes, Radopholus similis and other Radopholus species; Reniform nematodes, Rotylenchus robustus and other Rotylenchus species; Scutellonema species; Stubby root nematodes, Trichodorus primitivus and other Trichodorus species, Paratrichodorus species; Stunt nematodes, Tylenchorhynchus claytoni, Tylenchorhynchus dubius and other Tylenchorhynchus species; Citrus nematodes, Tylenchulus species; Dagger nematodes, Xiphinema species; and other plant parasitic nematode species.

The compounds I and compositions containing them are especially useful for the control of insects and nematodes.

Moreover, the compounds I and compositions containing them are especially useful for the control of pests selected from the orders Homoptera, Lepidoptera, Diptera, Thysanoptera, and Nematoda.

Furthermore compounds I and compositions containing them are especially useful for the control of insects, preferably of the orders Homoptera, Lepidoptera, Diptera, and Thysanoptera.

The compounds of formula (I) may be used to protect growing plants from attack or infestation by insects, arachnids or nematodes by contacting the plant with a pesticidally effective amount of compounds of formula (I).

The insect, arachnid, nematode, plant and/or soil or water in which the plant is growing can be contacted with the present compound(s) or composition(s) by any application method known in the art. As such “contacting” includes both direct contact (applying the compounds/compositions directly on the insect, arachnid, nematode, and/or plant—typically to the foliage, stem or roots of the plant) and indirect contact (applying the compounds/compositions to the locus of the insect, arachnid, nematode, and/or plant).

Moreover, insects, arachnids or nematodes may be controlled by contacting the target parasite/pest, its food supply or its locus with a pesticidally effective amount of compounds of formula (I). As such, the application may be carried out before or after the infection of the locus, growing crops, or harvested crops by the pest.

“Locus” means a habitat, breeding ground, plant, seed, soil, area, material or environment in which a pest or parasite is growing or may grow.

In general, for use in treating crop plants, the rate of application of the compounds and/or compositions of this invention may be in the range of about 0.1 g to about 4000 g per hectare, desirably from about 25 g to about 600 g per hectare, more desirably from about 50 g to about 500 g per hectare. For use in treating seeds, the typical rate of application is of from about 1 g to about 500 g per kilogram of seeds, desirably from about 2 g to about 300 g per kilogram of seeds, more desirably from about 10 g to about 200 g per kilogram of seeds. Customary application rates in the protection of materials are, for example, from about 0.001 g to about 2 kg, desirably from about 0.005 g to about 1 kg, of active compound per cubic meter of treated material.

The compounds I can be converted into the customary formulations, e.g. solutions, emulsions, microemulsions, suspensions, flowable concentrates, dusts, powders, pastes and granules. The use form depends on the particular purpose; in any case, it should guarantee a fine and uniform distribution of the compound according to the invention.

The formulations are prepared in a known manner, e.g. by extending the active ingredient with solvents and/or carriers, if desired using emulsifiers and dispersants, it also being possible to use other organic solvents as auxiliary solvents if water is used as the diluent. Auxiliaries which are suitable are essentially: solvents such as aromatics (e.g. xylene), chlorinated aromatics (e.g. chlorobenzenes), paraffins (e.g. mineral oil fractions), alcohols (e.g. methanol, butanol), ketones (e.g. cyclohexanone), amines (e.g. ethanolamine, dimethylformamide) and water; carriers such as ground natural minerals (e.g. kaolins, clays, talc, chalk) and ground synthetic minerals (e.g. highly-disperse silica, silicates); emulsifiers such as non-ionic and anionic emulsifiers (e.g. polyoxyethylene fatty alcohol ethers, alkylsulfonates and arylsulfonates) and dispersants such as lignin-sulfite waste liquors and methylcellulose.

Suitable surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates and fatty acids and their alkali metal and alkaline earth metal salts, salts of sulfated fatty alcohol glycol ether, condensates of sulfonated naphthalene and naphthalene derivatives with formaldehyde, condensates of naphthalene or of napthalenesulfonic acid with phenol or formaldehyde, polyoxyethylene octylphenyl ether, ethoxylated isooctylphenol, octylphenol, nonylphenol, alkylphenol polyglycol ethers, tributylphenyl polyglycol ethers, alkylaryl polyether alcohols, isotridecyl alcohol, fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, e.g. benzene, toluene, xylene, paraffin, tetrahydronaphthalene, alkylated naphthalenes or their derivatives, methanol, ethanol, propanol, butanol, chloroform, carbon tetrachloride, cyclohexanol, cyclohexanone, chlorobenzene, isophorone, strongly polar solvents, e.g. dimethylformamide, dimethyl sulfoxide, N-methylpyrrolidone and water.

Powders, materials for scattering and dusts can be prepared by mixing or concomitantly grinding the active substances with a solid carrier.

Granules, e.g. coated granules, compacted granules, impregnated granules and homogeneous granules, can be prepared by binding the active ingredients to solid carriers. Examples of solid carriers are mineral earths, such as silicas, silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, e.g. ammonium sulfate, ammonium phosphate, ammonium nitrate, ureas, and products of vegetable origin, such as cereal meal, tree bark meal, wood meal and nutshell meal, cellulose powders and other solid carriers.

Such formulations or compositions of the present invention include a formula I compound of this invention (or combinations thereof) admixed with one or more agronomically acceptable inert, solid or liquid carriers. Those compositions contain a pesticidally effective amount of said compound or compounds, which amount may vary depending upon the particular compound, target pest, and method of use.

In general, the formulations comprise of from 0.01 to 95% by weight, preferably from 0.1 to 90% by weight, of the active ingredient. The active ingredients are employed in a purity of from 90% to 100%, preferably 95% to 100% (according to NMR spectrum).

The following are exemplary formulations:

I. 5 parts by weight of a compound according to the invention are mixed intimately with 95 parts by weight of finely divided kaolin. This gives a dust which comprises 5% by weight of the active ingredient.

II. 30 parts by weight of a compound according to the invention are mixed intimately with a mixture of 92 parts by weight of pulverulent silica gel and 8 parts by weight of paraffin oil which had been sprayed onto the surface of this silica gel. This gives a formulation of the active ingredient with good adhesion properties (comprises 23% by weight of active ingredient).

III. 10 parts by weight of a compound according to the invention are dissolved in a mixture composed of 90 parts by weight of xylene, 6 parts by weight of the adduct of 8 to 10 mol of ethylene oxide and 1 mol of oleic acid N-monoethanolamide, 2 parts by weight of calcium dodecylbenzenesulfonate and 2 parts by weight of the adduct of 40 mol of ethylene oxide and 1 mol of castor oil (comprises 9% by weight of active ingredient).

IV. 20 parts by weight of a compound according to the invention are dissolved in a mixture composed of 60 parts by weight of cyclohexanone, 30 parts by weight of isobutanol, 5 parts by weight of the adduct of 7 mol of ethylene oxide and 1 mol of isooctylphenol and 5 parts by weight of the adduct of 40 mol of ethylene oxide and 1 mol of castor oil (comprises 16% by weight of active ingredient).

V. 80 parts by weight of a compound according to the invention are mixed thoroughly with 3 parts by weight of sodium diisobutylnaphthalene-alpha-sulfonate, 10 parts by weight of the sodium salt of a lignosulfonic acid from a sulfite waste liquor and 7 parts by weight of pulverulent silica gel, and the mixture is ground in a hammer mill (comprises 80% by weight of active ingredient).

VI. 90 parts by weight of a compound according to the invention are mixed with 10 parts by weight of N-methyl-a-pyrrolidone, which gives a solution which is suitable for use in the form of microdrops (comprises 90% by weight of active ingredient).

VII. 20 parts by weight of a compound according to the invention are dissolved in a mixture composed of 40 parts by weight of cyclohexanone, 30 parts by weight of isobutanol, 20 parts by weight of the adduct of 7 mol of ethylene oxide and 1 mol of isooctylphenol and 10 parts by weight of the adduct of 40 mol of ethylene oxide and 1 mol of castor oil. Pouring the solution into 100000 parts by weight of water and finely distributing it therein gives an aqueous dispersion which comprises 0.02% by weight of the active ingredient.

VIII. 20 parts by weight of a compound according to the invention are mixed thoroughly with 3 parts by weight of sodium diisobutylnaphthalene-a-sulfonate, 17 parts by weight of the sodium salt of a lignosulfonic acid from a sulfite waste liquor and 60 parts by weight of pulverulent silica gel, and the mixture is ground in a hammer mill. Finely distributing the mixture in 20000 parts by weight of water gives a spray mixture which comprises 0.1% by weight of the active ingredient.

The active ingredients can be used as such, in the form of their formulations or the use forms prepared therefrom, e.g. in the form of directly sprayable solutions, powders, suspensions or dispersions, emulsions, oil dispersions, pastes, dusts, materials for spreading, or granules, by means of spraying, atomizing, dusting, scattering or pouring. The use forms depend entirely on the intended purposes; in any case, this is intended to guarantee the finest possible distribution of the active ingredients according to the invention.

Aqueous use forms can be prepared from emulsion concentrates, pastes or wettable powders (sprayable powders, oil dispersions) by adding water. To prepare emulsions, pastes or oil dispersions, the substances as such or dissolved in an oil or solvent, can be homogenized in water by means of wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active ingredient concentrations in the ready-to-use products can be varied within substantial ranges. In general, they are from 0.0001 to 10%, preferably from 0.01 to 1%.

The active ingredients may also be used successfully in the ultra-low-volume process (ULV), it being possible to apply formulations comprising over 95% by weight of active ingredient, or even the active ingredient without additives.

Compositions of this invention may also contain other active ingredients, for example other pesticides, insecticides, herbicides, fertilizers such as ammonium nitrate, urea, potash, and superphosphate, phytotoxicants and plant growth regulators, safeners and nematicides. These additional ingredients may be used sequentially or in combination with the above-described compositions, if appropriate also added only immediately prior to use (tank mix). For example, the plant(s) may be sprayed with a composition of this invention either before or after being treated with other active ingredients.

These agents can be admixed with the agents according to the invention in a weight ratio of 1:10 to 10:1. Mixing the compounds I or the compositions comprising them in the use form as pesticides with other pesticides frequently results in a broader pesticidal spectrum of action.

The following list of pesticides together with which the compounds according to the invention can be used, is intended to illustrate the possible combinations, but not to impose any limitation:

Organophosphates: Acephate, Azinphos-methyl, Chlorpyrifos, Chlorfenvinphos, Diazinon, Dichlorvos, Dicrotophos, Dimethoate, Disulfoton, Ethion, Fenitrothion, Fenthion, Isoxathion, Malathion, Methamidophos, Methidathion, Methyl-Parathion, Mevinphos, Monocrotophos, Oxydemeton-methyl, Paraoxon, Parathion, Phenthoate, Phosalone, Phosmet, Phosphamidon, Phorate, Phoxim, Pirimiphos-methyl, Profenofos, Prothiofos, Sulprophos, Triazophos, Trichlorfon;

Carbamates: Alanycarb, Benfuracarb, Carbaryl, Carbosulfan, Fenoxycarb, Furathiocarb, Indoxacarb, Methiocarb, Methomyl, Oxamyl, Pirimicarb, Propoxur, Thiodicarb, Triazamate;

Pyrethroids: Bifenthrin, Cyfluthrin, Cypermethrin, Deltamethrin, Esfenvalerate, Ethofenprox, Fenpropathrin, Fenvalerate, Cyhalothrin, Lambda-Cyhalothrin, Permethrin, Silafluofen, Tau-Fluvalinate, Tefluthrin, Tralomethrin, Zeta-Cypermethrin;

Arthropod growth regulators: a) chitin synthesis inhibitors: benzoylureas: Chlorfluazuron, Diflubenzuron, Flucycloxuron, Flufenoxuron, Hexaflumuron, Lufenuron, Novaluron, Teflubenzuron, Triflumuron; Buprofezin, Diofenolan, Hexythiazox, Etoxazole, Clofentazine; b) ecdysone antagonists: Halofenozide, Methoxyfenozide, Tebufenozide; c) juvenoids: Pyriproxyfen, Methoprene, Fenoxycarb; d) lipid biosynthesis inhibitors: Spirodiclofen;

Various: Abamectin, Acequinocyl, Amitraz, Azadirachtin, Bifenazate, Cartap, Chlorfenapyr, Chlordimeform, Cyromazine, Diafenthiuron, Dinetofuran, Diofenolan, Emamectin, Endosulfan, Ethiprole, Fenazaquin, Fipronil, Formetanate, Formetanate hydrochloride, Hydramethylnon, Imidacloprid, Indoxacarb, Pyridaben, Pymetrozine, Spinosad, Sulfur, Tebufenpyrad, Thiamethoxam, and Thiocyclam.

### SYNTHESIS EXAMPLES

The compounds I-A, I-B, I-C and I-D obtained according to the protocols shown in the synthesis examples below and by customary preparation methods together with their physical data are listed in Table I which follows.

### Example 1

### Preparation of 2-methylsulfanyl-8-trifluoromethyl-11-(4-methyl-1-piperazinyl)-dibenzo[b,f][1,4]thiazepine (I-A.11 of Table I)

a) 2-(methylsulfanyl)-8-(trifluoromethyl)-dibenzo[b,f][1,4]thiazepin-11 (10H)-one

A mixture of 4.1 g 2-amino-4-trifluoromethyl-benzothiol, 3.6 g 2-chloro-5-methyl-sulfanyl-benzoic acid and 1.4 g Cu₂O in 20 ml of quinoline and 20 ml of pyridine was heated for 3 hours at 180° C. under nitrogen. After cooling to 20-25° C., the reaction mixture was poored into ice/water and acidified with conc. HCl. After stirring for 2 hours the precipitate was filtered off and washed with water. The raw material was stirred in etylacetat, filtered off and dried to yield 5.8 g of the title compound.

b) 2-methylsulfanyl-8-trifluoromethyl-11-(4-methyl-1-piperazinyl)-dibenzo[b,f][1,4]thiazepine

1.5 g 2-(methylsulfanyl)-8-(trifluoromethyl)-dibenzo[b,f][1,4]thiazepin-11(10H)-one in 20 ml POCl₃ was heated under reflux for 1 hour. After cooling to 20-25° C., POCl₃ was distilled off. The residue was extracted with CH₂Cl₂ after acidifying with aqueous HCl. The organic layer was dried with Na₂SO₄ and concentrated in vacuo to yield 1.8 g of 11-chloro-2-methylsulfanyl-8-trifluoromethyl-dibenzo[b,f][1,4]thiazepine as a dark oil. This product was mixed with 10 ml 1-methyl-piperazine, and the reaction mixture was stirred for 2 hours at 110° C. After cooling to 20-25° C., the reaction mixture was poored into ice/water. After stirring for 1 hour the raw material was filtered off and purified by column chromatography (silica gel, eluent CH₂Cl₂/CH₃OH 93/7) to yield 1.0 g of the title compound.

### Example 2

### Preparation of 2-chloro-7-methyl-11-(4-methyl-1-piperazinyl)-dibenzo[b,f][1,4]oxazepine (I-B.20 of Table I)

a) 2,5-dichloro-N-(2-hydroxy-4-methyl-phenyl)-benzamide

5.0 g 2,5-dichloro benzoic acid was dissolved in 80 ml THF, and 5.1 g carbonyldiimidazole was added. After stirring for 15 min at reflux temperature, 3.2 g 2-hydroxy-4-methyl-aniline was added and the reaction mixture was stirred for 4 hours at reflux temperature. After stirring overnight at 20-25° C. the reaction mixture was concentrated in vacuo. The residue was diluted with 70 ml 1 n NaOH and afterwards conc. NH₄Cl solution was added until a precipitate appeared. After stirring for 2 hours at pH=9-10 the precipitate was filtered off and washed with water. After drying in vacuo at 50° C. the yield was 6.75 g.

b) 2-chloro-7-methyl-dibenzo[b,f][1,4]oxazepin-11(10H)-one

To a solution of 6.75 g 2,5-dichloro-N-(2-hydroxy-4-methyl-phenyl)-benzamide in 60 ml dimethylacetamide was added 1.0 g NaH (60%) in two portions. Afterwards the reaction mixture was heated to 170° C. under reflux for 8 hours. After cooling to 20-25° C., the reaction mixture was poored into ice/water. After stirring for 2 hours the precipitate was filtered off, washed with water and dried at 50° C. in vacuo to yield 5.4 g of the title compound.

c) 2-chloro-7-methyl-11-(4-methyl-1-piperazinyl)-dibenzo[b,f][1,4]oxazepine

2.0 g 2-chloro-7-methyl-dibenzo[b,f][1,4]oxazepin-11(10H)-one in 25 ml POCl₃ was heated under reflux for 3 hours after the addition of about 1 ml N,N-dimethylaniline. After cooling to 20-25° C. POCl₃ was distilled off. The residue was extracted with CH₂Cl₂ after acidifying with aqueous HCl. The organic layer was dried with Na₂SO₄ and concentrated in vacuo to yield 1.8 g of crude 2,11-dichloro-7-methyl-dibenzo[b,f][1,4]oxazepine. This product was dissolved in 100 ml xylene and 15 ml dioxane under addition of 3.1 g 1-methyl-piperazine, and the reaction mixture was stirred for 3 hours at 110° C. After cooling to 20-25° C., the reaction mixture was concentrated in vacuo. The residue was extracted with ethylacetate after addition of conc. aqueous NH₃ until the pH was alkaline. The organic phase was washed with aqueous NH₃ and concentrated in vacuo. The raw material (2.5 g) was purified by column chromatography (silica gel, eluent CH₂Cl₂/CH₃OH 93/7) to yield 1.5 g 2-chloro-7-methyl-11-(4-methyl-1-pipera-zinyl)-dibenzo[b,f][1,4]oxazepine.

### Example 3

### Preparation of 2-methoxy-11-(4-methyl-1-piperazinyl)-5H-dibenzo[b,e][1,4]diazepine (1-C.7 of table I)

a) 2-methoxy-5,10-dihydro-11H-dibenzo[b,e][1,4]diazepin-11-one

A mixture of 5.4 g o-phenylendiamine, 11.55 g 2-bromo-5-methoxy-benzoic acid and 3.15 g Cu powder in 200 ml of chlorobenzene was refluxed under nitrogen for 8 hours with the concurrent separation of water. The solid were filtered off while the reaction mixture was still hot and washed with toluene. The filtrate was concentrated in vacuo to yield 10.4 g of crude product which was recrystallized from CH₃OH to yield 2.8 g of 2-methoxy-5,10-dihydro-11H-dibenzo[b,e][1,4]diazepin-11-one (m.p. 216-218° C.).

b) 2-methoxy-11-(4-methyl-1-piperazinyl)-5H-dibenzo[b,e][1,4]diazepine

4.8 g 1-methyl-piperazine was added dropwise to a solution of 1.17 ml TiCl₄ in 60 ml toluene and 2.4 ml anisol with stirring under nitrogen. 1.4 g 2-methoxy-5,10-dihydro-11H-dibenzo[b,e][1,4]diazepin-11-one was added and the reaction mixture was heated under reflux for 3 hours. The cold reaction mixture was extracted with ethylacetate after addition of conc. aqueous NH₃ solution. The combined organic layers were dried with Na₂SO₄ and concentrated in vacuo to yield 2.4 g of the crude product which was purified by column chromatography (silica gel, eluent CH₂Cl₂/CH₃OH 93/7) to yield 1.6 g 2-methoxy-11-(4-methyl-1-piperazinyl)-5H-dibenzo[b,e][1,4]diazepine.

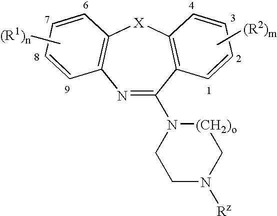

| X | compounds of formula |
|---|---|
| X═S: | I-A |
| X═O: | I-B |
| X═NR^{a}: | I-C |
| X═CR^{b}R^{c}: | I-D |

TABLE I

| | | | | | | Physical data |
|---|---|---|---|---|---|---|
| No. | X | (R¹)ₙ | (R²)ₘ | o | R^{z} | (m.p.[° C.]/¹H-NMR (CDCl₃): δ[ppm])/MS: m/z [M + H]⁺ |
| I-A.1 | S | H | H | 1 | CH₃ | 7.5(d), 7.4(d), 7.3(m), 7.2(t), 7.1(d), |
| | | | | | | 6.9(t), 3.6(m), 2.5(m), 2.3(t) |
| I-A.2 | S | 7-Cl | H | 1 | CH₃ | 88-90 |
| I-A.3 | S | H | 3-Cl | 1 | CH₂CHCH₂ | hydrochloric acid adduct: 204-206 |
| I-A.4 | S | H | 3-Cl | 1 | CH₂CH₂OH | hydrochloric acid adduct: 208-210 |
| I-A.5 | S | 8-CF₃ | H | 1 | CH₃ | hydrochloric acid adduct: 176-178 |
| I-A.6 | S | H | 2-NO₂ | 1 | cyclo-C₆H₁₁ | hydrochloric acid adduct: 219-221 |
| I-A.7 | S | H | 3-Cl | 1 | (CH₂)₂CH₃ | hydrochloric acid adduct: 285-287 |
| I-A.8 | S | H | 3-NO₂ | 1 | CH₃ | hydrochloric acid adduct: 205-208 |
| I-A.9 | S | H | 2-SCH₃ | 1 | CH₃ | 78-80 |
| I-A.10 | S | H | 2-SCH₃ | 1 | CH₂CH₃ | 64-66 |
| I-A.11 | S | 8-CF₃ | 2-SCH₃ | 1 | CH₃ | 80-82 |
| I-A.12 | S | 8-CF₃ | 2-SCH₃ | 1 | CH₂CH₃ | 79-81 |
| I-A.13 | S | H | 2-NO₂ | 1 | CH₃, O⁻ | 172-174 |
| | | | | | (amine oxide) | |
| I-A.14 | S | 8-CF₃ | H | 1 | CH₃ | 76-79 |
| I-A.15 | S | 8-SCH₃ | 2-F | 1 | CH₃ | 125-126 |
| I-A.16 | S | 8-SCH₃ | 2-Cl | 1 | CH₃ | 139-140 |
| I-A.17 | S | 8-SCH₃ | 2-CH₃ | 1 | CH₃ | 73-74 |
| I-A.18 | S | 8-SCH₃ | 2-CH₃ | 1 | CH₂CH₃ | 70-71 |
| I-A.19 | S | 8-SCH₃ | 2-OCH₃ | 1 | CH₂CH₃ | 7.4(d), 7.3(d), 6.9(s), 6.8(m), 6.7(d), |
| | | | | | | 3.7(s), 3.6(m), 2.5(m), 2.5(q), |
| | | | | | | 2.4(s), 1.1(t) |
| I-A.20 | S | 8-CF₃ | 2-CH₃ | 1 | CH₃ | 7.5(d), 7.4(d), 7.3(s), 7.2(d), 7.1(s), |
| | | | | | | 7.1(d), 3.6(m), 2.5(m), 2.4(s), |
| | | | | | | 2.3(s) |
| I-A.21 | S | 8-SCH₂ | 2-OCH₃ | 1 | CH₃ | 91-92 |
| I-A.22 | S | 8-CF₃ | 2-CH₃ | 1 | CH₂CH₃ | 7.5(d), 7.4(d), 7.3(s), 7.2(d), 7.1(s), |
| | | | | | | 7.1(d), 3.7(m), 2.6(m), 2.5(q), |
| | | | | | | 2.3(s), 1.2(t) |
| I-A.23 | S | 7-Cl | 2-SCH₃ | 1 | CH₃ | 75-76 |
| I-A.24 | S | 7-Cl | 2-SCH₃ | 1 | CH₂CH₃ | 73-74 |
| I-A.25 | S | 8-CF₃ | 2-OCH₃ | 1 | CH₃ | 71-72 |
| I-A.26 | S | 8-CF₃ | 2-OCH₃ | 1 | CH₂CH₃ | 65-66 |
| I-A.27 | S | H | 4-Cl | 1 | CH₃ | 125-127 |
| I-A.28 | S | H | 2,3-Cl₂ | 1 | CH₃ | 92-94 |
| I-A.29 | S | 8-CF₃ | 3-OCH₂CH₃ | 1 | CH₃ | 74-76 |
| I-A.30 | S | H | 1-Cl | 1 | CH₃ | 58-60 |
| I-A.31 | S | 8-CF₃ | 2-F | 1 | CH₃ | 7.5(m), 7.3(s), 7.1(m), 3.7(m), 2.5(m), |
| | | | | | | 2.3(s) |
| I-A.32 | S | 8-CF₃ | 2-F | 1 | CH₂CH₃ | 7.5(m), 7.3(s), 7.1(m), 3.7(m), 2.5(m), |
| | | | | | | 2.5(q), 1.1(t) |
| I-A.33 | S | 7-Cl | 2-CH₃ | 1 | CH₃ | 74-76 |
| I-A.34 | S | 7-Cl | 2-CH₃ | 1 | CH₂CH₃ | MS: 372 |
| I-A.35 | S | 7-Cl | 2-OCH₃ | 1 | CH₃ | 92-94 |
| I-A.36 | S | 7-Cl | 2-OCH₃ | 1 | CH₂CH₃ | 7.5(m), 7.2(d), 7.0(d), 6.8(d), 6.7(s), |
| | | | | | | 3.8(m), 3.8(s), 2.5(m), 2.5(q), |
| | | | | | | 1.1(t) |
| I-A.37 | S | 7-Cl | 3-OCH₃ | 1 | CH₃ | 72-74 |
| I-A.38 | S | 7-Cl | 3-OCH₃ | 1 | CH₂CH₃ | 7.4(s), 7.2(d), 7.1(d), 7.0(s), 7.0(d), |
| | | | | | | 6.8(d), 3.8(s), 3.5(m), 2.5(m), |
| | | | | | | 2.5(q), 1.1(t) |
| I-A.39 | S | H | 2-OCH₃ | 1 | CH₃ | 126-128 |
| I-A.40 | S | H | 2-CH₃ | 1 | CH₃ | 66-68 |
| I-A.41 | S | 7-Cl | H | 1 | CH₂CH₃ | 64-66 |
| I-A.42 | S | 8-Cl | H | 1 | CH₃ | 161-163 |
| I-A.43 | S | 8-Cl | 2-SCH₃ | 1 | CH₃ | 132-134 |
| I-A.44 | S | 8-SCH₃ | 3-Cl | 1 | CH₃ | 75-77 |
| I-A.45 | S | 8-SCH₃ | 3-CF₃ | 1 | CH₃ | 66-68 |
| I-A.46 | S | 8-SCH₃ | 1-CF₃ | 1 | CH₃ | 148-150 |
| I-A.47 | S | H | 2-Br | 1 | CH₃ | 136-138 |
| I-A.48 | S | H | 2-CF₃ | 1 | CH₃ | 77-87 |
| I-A.49 | S | H | 2-CF₃ | 1 | CH(CH₃)₂ | 58-60 |
| I-A.50 | S | H | 2-CF₃ | 1 | CH₂CH₃ | 93-96 |
| I-A.51 | S | H | 2-CF₃ | 1 | C₆H₅ | 73-75 |
| I-A.52 | S | H | 2-F | 1 | CH₃ | 64-66 |
| I-A.53 | S | 8-CH₃ | 2-Cl | 1 | CH₃ | 130-133 |
| I-A.54 | S | 8-CH₃ | 2-Cl | 1 | CH₂CH₃ | 7.4(d), 7.2(m), 6.8(s), 6.7(d), 3.5(s), |
| | | | | | | 2.6(s), 2.5(q), 2.2(s), 1.1(t) |
| I-A.55 | S | 8-CF | 2-SCH₃ | 1 | CH₃ | 7.4(d), 7.3(dd), 7.2(d), 7.1(s), |
| | | | | | | 6.7(dd), 6.6(m), 3.5(s), 2.5(s), |
| | | | | | | 2.5(s), 2.3(s). |
| I-A.56 | S | 8-F | 2-SCH₃ | 1 | CH₂CH₃ | 7.3(d), 7.2(dd), 7.2(d), 7.1(s), |
| | | | | | | 6.7(dd), 6.6(dt), 3.5(s), 2.5(s), 2.5(q), |
| | | | | | | 2.5(s), 1.1(t) |
| I-A.57 | S | 8-Cl | 2-SCH₂CH₃ | 1 | CH₃ | 62-64 |
| I-A.58 | S | 8-Br | 2-SCH₃ | 1 | CH₃ | 146-148 |
| I-A.59 | S | 8-Br | 2-SCH₃ | 1 | CH₂CH₃ | 133-135 |
| I-A.60 | S | H | 2-Br | 1 | CH₃ | 136-138 |
| I-A.61 | S | H | 2-Br | 1 | CH₂CH₃ | 78-80 |
| I-A.62 | S | H | 2-CF₃ | 1 | (CH₂)₂CH₃ | 58-60 |
| I-A.63 | S | H | 2-CF₃ | 1 | CH₂CF₃ | 7.6(d), 7.5(dd), 7.4(d), 7.2(m), 7.1(d), |
| | | | | | | 6.9(t), 4.5(s), 3.0(q), 2.8(s), |
| | | | | | | 2.7(m) |
| I-A.64 | S | 8-Cl | 2-CF₃ | 1 | CH₃ | 130-132 |
| I-A.65 | S | 8-Cl | 2-CF₃ | 1 | (CH₂)₂CH₃ | 7.6(m), 7.3(d), 7.1(s), 6.8(dd), 3.5(s), |
| | | | | | | 2.5(s), 2.5(m), 2.4(t), 1.5(m), |
| | | | | | | 0.9(t) |
| I-A.66 | S | 8-CH₃ | 2-F | 1 | CH₃ | 7.5(m), 7.2(d), 7.0(m), 6.9(s), 6.7(d), |
| | | | | | | 3.5(s), 2.6(s), 2.5(m), 2.3(s), |
| | | | | | | 2.2(s) |
| I-A.67 | S | 8-Cl | 2-S(CH₂)₃CH₃ | 1 | CH₃ | 7.3(d), 7.2(m), 7.1(s), 6.8(dd), |
| | | | | | | 3.6(s), 2.9(m), 2.6(s), 2.3(s), 1.6(m), |
| | | | | | | 1.4(m), 0.9(t) |
| I-A.68 | S | 8-Cl | 2-S(CH₂)₂CH₃ | 1 | CH₃ | 7.3(d), 7.2(m), 7.1(d), 6.8(dd), 3.6(s), |
| | | | | | | 2.9(m), 2.6(s), 2.3(s), 1.7(m), |
| | | | | | | 1.0(t) |
| I-A.69 | S | 8-CH₃ | 2-F | 1 | (CH₂)₂CH₃ | 7.5(dd), 7.3(d), 7.0(m), 6.9(s), 6.7(d), |
| | | | | | | 3.5(s), 2.5(s), 2.3(t), 2.2(s), |
| | | | | | | 1.5(m), 0.9(t) |
| I-A.70 | S | 8-CH₃ | 2-F | 1 | CH₂CH₃ | 7.4(dd), 7.2(s), 7.0(m), 6.9(s), 6.7(d), |
| | | | | | | 3.6(s), 2.6(s), 2.5(q), 2.3(s), |
| | | | | | | 1.1(t) |
| I-A.71 | S | 8-F | 2-Br | 1 | CH₃ | 131-134 |
| I-A.72 | S | 8-F | 2-Br | 1 | (CH₂)₂CH₃ | 7.4(m), 7.3(m), 6.7(dd), 6.6(dd), |
| | | | | | | 3.5(s), 2.6(s), 2.3(t), 1.5(m), 0.8(t) |
| I-A.73 | S | 8-F | 2-Cl | 1 | CH₃ | 7.4(d), 7.3(m), 6.7(dd), 6.6(dt), |
| | | | | | | 3.6(s), 2.6(s), 2.3(s) |
| I-A.74 | S | 7-Cl | 2-Cl | 1 | CH₃ | 81-83 |
| I-A.75 | S | 7-Cl | 2-Cl | 1 | (CH₂)₂CH₃ | MS: 406 |
| I-A.76 | S | 7-Cl | 2-Br | 1 | CH₃ | 112-115 |
| I-A.77 | S | 7-Cl | 2-Br | 1 | (CH₂)₂CH₃ | 77-80 |
| I-A.78 | S | 7-Cl | 2-Br | 1 | CH₂CF₃ | 64-66 |
| I-B.1 | O | H | 2-NO₂ | 1 | CH₂CH₃ | 139-141 |
| I-B.2 | O | 8-CH₃ | 2-Cl | 1 | CH₃ | 138-139 |
| I-B.3 | O | 8-Cl | 2-OCH₃ | 1 | CH₃ | 153-154 |
| I-B.4 | O | H | 2-OCH₃ | 1 | CH₃ | 124-125 |
| I-B.5 | O | H | 2-NH₂ | 1 | CH₂CH₃ | 88-90 |
| I-B.6 | O | 8-Cl | 2-SCH₃ | 1 | CH₃ | 76-78 |
| I-B.7 | O | 8-Cl | 3-SO₂CH₃ | 1 | CH₃ | 120-123 |
| I-B.8 | O | 8-SCH₃ | 3-CF₃ | 1 | CH₃ | 7.5(s), 7.4(m), 7.1(m), 6.9(m), 3.5(m), |
| | | | | | | 2.5(m), 2.4(s), 2.3(s) |
| I-B.9 | O | H | 2-SCH₃ | 1 | CH₃ | 62-64 |
| I-B.10 | O | 8-SCH₃ | 3-OCF₃ | 1 | CH₃ | MS: 424 |
| I-B.11 | O | 7-Cl | 2-SCH₃ | 1 | CH₃ | 168-170 |
| I-B.12 | O | 7-Cl | 2-OCH₂CH₃ | 1 | CH₂CH₃ | 103-105 |
| I-B.13 | O | 8-SCH₃ | 2-F | 1 | CH₃ | 178-180 |
| I-B.14 | O | 7-Cl | 2-SCH₃ | 1 | CH₂CH₃ | 161-163 |
| I-B.15 | O | 7-Cl | 2-OCH₂CH₃ | 1 | CH₃ | 111-113 |
| I-B.16 | O | 8-SCH₃ | 2-F | 1 | CH₂CH₃ | 112-114 |
| I-B.17 | O | 8-SCH₃ | 3-F | 1 | CH₃ | 135-138 |
| I-B.18 | O | 8-SCH₃ | 3-F | 1 | CH₂CH₃ | 113-116 |
| I-B.19 | O | 7-F | 2-SCH₃ | 1 | CH₃ | 150-152 |
| I-B.20 | O | 7-CH₃ | 2-Cl | 1 | CH₃ | 129-131 |
| I-B.21 | O | 8-Cl | 2-CH₃ | 1 | CH₃ | 146-148 |
| I-B.22 | O | 8-F | 2-SCH₃ | 1 | CH₃ | 106-108 |
| I-B.23 | O | 7-Cl | 2-Cl | 1 | H | |
| I-B.24 | O | 8-CH₃ | 2-Br | 1 | CH₃ | 124-126 |
| I-B.25 | O | 7-CH₃ | 2-Br | 1 | CH₃ | 148-151 |
| I-B.26 | O | 8-Cl | 2-SCH₃ | 1 | cyclo-C₃H₅ | 133-135 |
| I-B.27 | O | 8-Cl | 2-SCH₃ | 1 | CH₂CH₃ | 68-70 |
| I-B.28 | O | 8-Cl | 2-SCH₃ | 1 | cyclo-C₆H₁₁ | 80-82 |
| I-B.29 | O | 8-Cl | 2-SCH₃ | 2 | CH₃ | 57-59 |
| I-B.30 | O | 8-Cl | 2-SCH₃ | 1 | CH₂CHCH₂ | 55-57 |
| I-B.31 | O | 8-Cl | 2-SCH₃ | 1 | CH₂CF₃ | 137-139 |
| I-B.32 | O | 8-Cl | 2-SCH₃ | 1 | CH₂-cyclo-C₃H₅ | 133-135 |
| I-B.33 | O | 8-Cl | 2-SCH₃ | 1 | (CH₂)₂CH₃ | 116-118 |
| I-B.34 | O | 8-Cl | 2-SCH₃ | 1 | CH₂CCH | 106-108 |
| I-B.35 | O | 8-Cl | 2-SCH₃ | 1 | CH₂C₆H₅ | 77-79 |
| I-B.36 | O | 8-Cl | 2-SCH₃ | 1 | C₆H₅ | 149-151 |
| I-B.37 | O | 8-Cl | 2-SCH₃ | 1 | 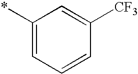 | 88-90 |
| I-B.38 | O | 8-Cl | 2-SCH₃ | 1 | 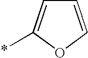 | 102-104 |
| I-B.39 | O | 8-Cl | 2-SCH₃ | 1 | (CH₂)₂OH | 74-76 |
| I-B.40 | O | 8-Cl | 2-SCH₃ | 1 | 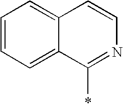 | 108-110 |
| I-B.41 | O | 8-Cl | 2-SCH₃ | 1 | H | 78-80 |
| I-B.42 | O | 8-Cl | 2-Cl | 1 | CH₃ | 133-135 |
| I-B.43 | O | 8-Cl | 2-Cl | 1 | CH₂CH₃ | 78-80 |
| I-B.44 | O | 7-Cl | 2-CH₃ | 1 | CH₃ | 7.2-6.9(m), 3.6(s), 2.6(s), 2.3(s), |
| | | | | | | 2.2(s) |
| I-B.45 | O | 7-Cl | 2-CH₃ | 1 | CH₂CH₃ | 7.2-6.9(m), 3.6(s), 2.6(s), 2.5(q), |
| | | | | | | 1.1(t) |
| I-B.46 | O | 8-Br | 2-SCH₃ | 1 | CH₃ | 133-136 |
| I-B.47 | O | 8-Br | 2-SCH₃ | 1 | CH₂CH₃ | 112-115 |
| I-B.48 | O | 8-Cl | 2-SCH₃ | 1 | C₁₀H₇ | 130-132 |
| I-B.49 | O | 8-Cl | 2-SCH₃ | 1 | (CH₂)₂OCH₃ | 99-101 |
| I-B.50 | O | 8-Cl | 2-SCH₃ | 1 | (CH₂)₂N(CH₃)₂ | 113-115 |
| I-B.51 | O | 8-Cl | 2-SCH₃ | 1 | (CH₂)₂SCH₃ | 108-111 |
| I-B.52 | O | 8-Cl | 2-SCH₃ | 1 | CH(CH₃)₂ | 68-70 |
| I-B.53 | O | 8-F | 2-CH₃ | 1 | CH₃ | oil |
| I-B.54 | O | 8-F | 2-CH₃ | 1 | CH₂CH₃ | oil |
| I-B.55 | O | 8-CH₃ | 2-F | 1 | CH₃ | 118-120 |
| I-B.56 | O | 8-CH₃ | 2-F | 1 | CH₂CH₃ | 7.2(dd), 7.1(dd), 7.0(m), 6.7(d), |
| | | | | | | 3.5(s), 2.5(s), 2.5(4), 2.2(s), 1.1(t) |
| I-B.57 | O | H | 2-F | 1 | CH₃ | 7.2-6.8(m), 3.5(s), 2.5(s), 2.3(s) |
| I-B.58 | O | 7-F | 2-CH₃ | 1 | CH₂CH₃ | 7.2(m), 7.1(m), 6.8(m), 3.5(s), 2.5(s), |
| | | | | | | 2.4(q), 2.3(s), 1.1(t) |
| I-B.59 | O | 8-Cl | 2-SCH₃ | 1 | C₆H₄-3-Cl | 144-146 |
| I-B.60 | O | H | 2-CF₃ | 1 | CH₃ | 59-61 |
| I-B.61 | O | H | 2-CF₃ | 1 | CH₂CH₃ | 56-58 |
| I-B.62 | O | 8-Cl | 2-CF₃ | 1 | CH₃ | 68-70 |
| I-B.63 | O | 8-Cl | 2-CF₃ | 1 | CH₂CH₃ | 102-104 |
| I-B.64 | O | 8-CH₃ | 2-CF₃ | 1 | CH₃ | 88-90 |
| I-B.65 | O | 8-CH₃ | 2-CF₃ | 1 | CH₂CH₃ | 58-60 |
| I-B.66 | O | 7-CH₃ | 2-CF₃ | 1 | CH₃ | 61-63 |
| I-B.67 | O | 7-CH₃ | 2-CF₃ | 1 | CH₂CH₃ | 59-61 |
| I-B.68 | O | 7-Cl | 2-CF₃ | 1 | CH₃ | oil |
| I-B.69 | O | 7-Cl | 2-CF₃ | 1 | (CH₂)₂CH₃ | oil |
| I-B.70 | O | 8-CH₃ | 2-F | 1 | (CH₂)₂CH₃ | MS: 353 |
| I-B.71 | O | 8-Cl | 2-S(CH₂)₂CH₃ | 1 | CH₃ | 7.4(d), 7.2(d), 7.1(m), 7.9(d), 6.8(dd), |
| | | | | | | 3.6(s), 2.8(t), 2.5(s), 2.3(s), |
| | | | | | | 1.6(m), 0.9(t) |
| I-B.72 | O | 8-Cl | 2-S(CH₂)₂CH₃ | 1 | (CH₂)₂CH₃ | 7.4(dd), 7.2(d), 7.1(m), 7.0(d), 6.8(dd), |
| | | | | | | 3.6(d), 2.8(t), 2.5(s), 2.4(t), |
| | | | | | | 1.6(m), 1.5(m), 1.0(t), 0.9(t) |
| I-B.73 | O | 8-Cl | 2-S(CH₂)₃CH₃ | 1 | CH₃ | MS: 416 |
| I-B.74 | O | 8-Cl | 2-SCHCHCH₃ | 1 | CH₃ | MS: 399 |
| I-B.75 | O | 8-Cl | 2-SCH₂CH₃ | 1 | CH₃ | 125-127 |
| I-B.76 | O | 8-Cl | 2-SCH₂CH₃ | 1 | (CH₂)₂CH₃ | 104-106 |
| I-B.77 | O | 8-F | 2-SCH₃ | 1 | (CH₂)₂CH₃ | 115-117 |
| I-B.78 | O | 8-Cl | 2-OH | 1 | CH₃ | 247-249 |
| I-B.79 | O | 8-CH₃ | 2-Cl | 1 | (CH₂)₂CH₃ | 108-110 |
| I-B.80 | O | 8-CH₃ | 2-Cl | 1 | (CH₂)₂CH₃ | 61-63 |
| I-B.81 | O | 8-CH₃ | 2-Cl | 1 | CH₂CHCH₂ | 129-131 |
| I-B.82 | O | 8-CH₃ | 2-Cl | 2 | CH₃ | 61-63 |
| I-B.83 | O | 8-CH₃ | 2-Cl | 1 | CH₂CF₃ | 115-119 |
| I-B.84 | O | 8-CH₃ | 2-Cl | 1 | CH(CH₃)₂ | 73-75 |
| I-B.85 | O | 8-CH₃ | 2-Cl | 1 | CH₂CCH | 70-73 |
| I-B.86 | O | 8-CH₃ | 2-Cl | 1 | C₆H₁₁ | 149-152 |
| I-B.87 | O | 8-CH₃ | 2-Cl | 1 | CH₂-cyclo-C₃H₅ | 93-96 |
| I-B.88 | O | 7-F | 2-Br | 1 | CH₃ | 79-81 |
| I-B.89 | O | 7-F | 2-Br | 1 | CH₂CH₃ | 123-126 |
| I-B.90 | O | 7-F | 2-Br | 1 | (CH₂)₂CH₃ | 131-133 |
| I-B.91 | O | 7-F | 2-Br | 1 | CH₂CCH | 166-169 |
| I-B.92 | O | 8-Cl | 2-SCF₃ | 1 | CH₃ | 60-62 |
| I-B.93 | O | 7-F | 2-SCH₃ | 1 | CH₂CH₃ | 143-145 |
| I-B.94 | O | 7-F | 2-SCH₃ | 1 | (CH₂)₂CH₃ | 99-102 |
| I-B.95 | O | 7-F | 2-SCH₃ | 1 | CH₂CCH | 71-73 |
| I-B.96 | O | 8-CH₂CH₃ | 2-Cl | 1 | CH₃ | 7.4(dd), 7.3(d), 7.2(d), 7.0(d), 6.9(dd), |
| | | | | | | 3.5(s), 2.5(m), 2.4(s), 1.2(t) |
| I-B.97 | O | 8-Cl | 2-OCH₂CH₃ | 1 | CH₃ | 133-135 |
| I-B.98 | O | 8-Cl | 2-OCH₂CH₃ | 1 | (CH₂)₂CH₃ | oil |
| I-B.99 | O | 7-Cl | 2-Cl | 1 | CH₃ | 145-147 |
| I-B.100 | O | 7-Cl | 2-Cl | 1 | CH₂CH₃ | 155-157 |
| I-B.101 | O | 8-Br | 2-CF₃ | 1 | CH₃ | 73-75 |
| I-B.102 | O | 8-Br | 2-CF₃ | 1 | (CH₂)₂CH₃ | oil |
| I-B.103 | O | 8-CH₃ | 2-Cl | 1 | 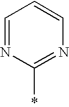 | 165-167 |
| I-B.104 | O | 8-CH₃ | 2-Cl | 1 | 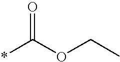 | 83-85 |
| I-B.105 | O | 7-Cl | 2-Cl | 1 | CH₂CCH | 180-183 |
| I-B.106 | O | 7-Cl | 2-Cl | 1 | (CH₂)₂CH₃ | 157-160 |
| I-B.107 | O | 8-F | 2-Br | 1 | (CH₂)₂CH₃ | oil |
| I-B.108 | O | 8-F | 2-Br | 1 | CH₃ | 143-145 |
| I-B.109 | O | 7-F | 2-Br | 1 | CH₂CF₃ | 153-155 |
| I-B.110 | O | 8-F | 2-Br | 1 | CH₂CF₃ | 160-163 |
| I-B.111 | O | 8-F | 2-Br | 1 | CH₂CH₃ | 145-148 |
| I-B.112 | O | 7-Cl | 2-Br | 1 | CH₃ | 158-160 |
| I-B.113 | O | 7-Cl | 2-Br | 1 | CH₂CH₃ | 175-178 |
| I-B.114 | O | 7-Cl | 2-Br | 1 | (CH₂)₂CH₃ | 149-152 |
| I-B.115 | O | 7-Cl | 2-Br | 1 | CH₂CF₃ | 158-160 |
| I-B.116 | O | 7-F | 2-OCF₃ | 1 | CH₃ | MS: 395 |
| I-B.117 | O | 7-CH₃, 8-Cl | 2-Cl | 1 | CH₃ | 183-184 |
| I-B.118 | O | 7-CH₃, 8-Cl | 2-Cl | 1 | CH₂CH₃ | 155-156 |
| I-B.119 | O | 7-CH₃, 8-Cl | 2-NO₂ | 1 | CH₃ | 214-215 |
| I-B.120 | O | 7-CH₃, 8-Cl | 2-NO₂ | 1 | CH₂CH₃ | 151-152 |
| I-B.121 | O | 7-F | 2-NO₂ | 1 | CH₃ | 112-114 |
| I-B.122 | O | 7-F | 2-NO₂ | 1 | CH₂CH₃ | 74-77 |
| I-B.123 | O | 7-F | SO₂NHCH₃ | 1 | CH₃ | 92-94 |
| I-B.124 | O | 8-CH₃ | 2-Cl | 1 | (CH₂)₂OH | MS: 372 |
| I-B.125 | O | 8-CH₃ | 2-Cl | 1 | 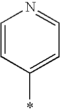 | MS: 405 |
| I-B.126 | O | 8-CH₃ | 2-Cl | 1 | 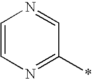 | MS: 406 |
| I-B.127 | O | 8-CH₃ | 2-Cl | 1 | 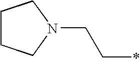 | MS: 425 |
| I-B.128 | O | 8-CH₃ | 2-Cl | 1 | 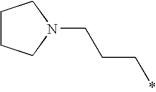 | MS: 439 |
| I-B.129 | O | 8-CH₃ | 2-Cl | 1 | 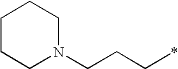 | MS: 453 |
| I-B.130 | O | 8-CH₃ | 2-Cl | 1 | 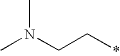 | MS: 399 |
| I-B.131 | O | 8-CH₃ | 2-Cl | 1 | 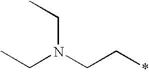 | MS: 427 |
| I-B.132 | O | 8-CH₃ | 2-Cl | 1 | 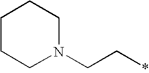 | MS: 439 |
| I-B.133 | O | 8-CH₃ | 2-Cl | 1 | 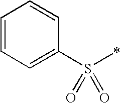 | MS: = 469 |
| I-B.134 | O | 8-CH₃ | 2-Cl | 1 | 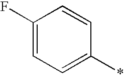 | MS: 422 |
| I-B.135 | O | 8-CH₃ | 2-Cl | 1 | 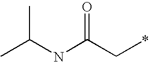 | MS: 427 |
| I-B.136 | O | 8-CH₃ | 2-Cl | 1 | 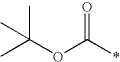 | MS: 428 |
| I-B.137 | O | 8-CH₃ | 2-CONH₂ | 1 | CH₃ | 122-124 |
| I-B.138 | O | 7-F | 2-NHCOCH₃ | 1 | CH₂CH₃ | 102-104 |
| I-B.139 | O | 8-CH₃ | 2-CN | 1 | CH₃ | 148-151 |
| I-B.140 | O | 8-F | 2-NO₂ | 1 | CH₃ | oil |
| I-B.141 | O | 8-F | 2-NH₂ | 1 | CH₃ | 78-79 |
| I-B.142 | O | 7-F | 2-NHCOCH₃ | 1 | CH₃ | 120-122 |
| I-C.1 | NH | H | H | 1 | CH₃ | 177-179 |
| I-C.2 | NH | H | H | 1 | CH₂CH₃ | 164-166 |
| I-C.3 | NH | H | 2-SCH₃ | 1 | CH₃ | 82-84 |
| I-C.4 | NH | 8-Cl | 2-SCH₃ | 1 | CH₃ | 182-184 |
| I-C.5 | NH | 7-Cl | 2-SCH₃ | 1 | CH₃ | 138-140 |
| I-C.6 | NH | H | 2-Br | 1 | CH₃ | 193-195 |
| I-C.7 | NH | H | 2-OCH₃ | 1 | CH₃ | 89-91 |
| I-C.8 | NH | 8-CH₃ | 2-Cl | 1 | CH₃ | 195 |
| I-C.9 | NH | 7-F | 2-SCH₃ | 1 | CH₃ | 7.2(m), 6.8(m), 6.6(m), 3.5(s), 2.5(s), |
| | | | | | | 2.4(s), 2.3(s) |
| I-D.1 | CH₂ | H | H | 1 | CH₂CHCH₂ | 102-104 |
| I-D.2 | CH₂ | H | H | 1 | (CH₂)₃CH₃ | 90-92 |
| I-D.3 | CH₂ | H | H | 1 | CH₂CH₂ | 96-98 |
| I-D.4 | CH₂ | H | H | 1 | (CH₂)₂CH₂ | 110-112 |
| I-D.5 | CH₂ | H | H | 1 | CH(CH₃)₂ | 7.4(d), 7.3(t), 7.3(d), 7.2(t), 7.1(m), |
| | | | | | | 6.9(t), 3.6(d), 3.5(d), 3.5(m), |
| | | | | | | 2.7(m), 2.6(m), 1.0(d) |
| I-D.6 | CH₂ | H | H | 1 | Cyclo-C₆H₁₁ | 108-110 |
| I-D.7 | CH₂ | H | H | 1 | H | 64-65 |
| I-D.8 | CH₂ | H | H | 1 | CH₂CCH | 132-134 |
| I-D.9 | C═O | H | H | 1 | CH₃ | 131-133 |
| I-D.10 | CH₂ | H | H | 1 | CH₃ | 130-132 |
| I-D.11 | CHOH | H | H | 1 | CH₃ | 196-198 |
| I-D.12 | CH₂ | 8-F | H | 1 | CH₃ | 117-119 |
| I-D.13 | CH₂ | 8-F | H | 1 | CH(CH₃)₂ | 101-103 |
| I-D.14 | CH₂ | 8-SCH₃ | H | 1 | CH₃ | 68-70 |
| I-D.15 | CH₂ | H | H | 1 | CH₂CH₂OH | 129-131 |
| I-D.16 | CH₂ | H | H | 1 | CH₂CH₂Cl | 137-139 |
| I-D.17 | CH₂ | H | H | 1 | CH₃, O⁻ | 185-187 |
| | | | | | (amine oxide) | |
| I-D.18 | CH₂ | H | H | 1 | CH₂-cyclo-C₃H₅ | 133-135 |
| I-D.19 | CH₂ | 8-SOCH₃ | H | 1 | CH₃ | 191-193 |
| I-D.20 | CH₂ | H | 3-CH₃ | 1 | CH₃ | 69-71 |
| I-D.21 | CH₂ | H | 2-CH₃ | 1 | CH₃ | 62-64 |
| I-D.22 | CH₂ | H | 2-F | 1 | CH₃ | 106-108 |
| I-D.23 | CH₂ | 8-Cl | 2-SCH₃ | 1 | CH₃ | 62-64 |

Examples of Action Against Plant, Structural and Human Health Pests

The action of the compounds of the formula I against pests was demonstrated by the following experiments:

Nematicidal Evaluation

Test Procedures for Root-Knot Nematode Solution Assay (Meloidogyne incognita):

To microtiter plates containing about 1.0 mg of compound, 80:20 acetone was added to each well and the solution was mixed to obtain the desired compound concentration. The aqueous nematode suspension containing 20 to 50 Meloidogyne incognita J2 larvae per 50 ml was added to each plate. The plates were then sealed and they were placed in an incubator at 27° C. and about 50% relative humidity. After 72 hours, the population mortality was read, whereby immobility of nematodes was regarded as mortality.

In this test, compound I-A.51 at 100 ppm showed 100% mortality compared to untreated controls.

Test Procedures for Soybean Cyst Nematode Solution Assay (Heterodera glycine):

To microtiter plates containing about 150 mg of compound, 80:20 acetone was added to each well and the solution was mixed to obtain the desired compound concentration. The nematode suspension of J2 Heterodera glycines larvae was added to the plate. The plates were then sealed and placed in an incubator at 27° C. and about 50% relative humidity. After 72 hours, the population mortality was read, whereby immobility of nematodes was regarded as mortality.

Activity Against Insects and Arachnids

Southern Armyworm (Spodoptera eridania), 2nd instar Larvae

The active compounds were formulated for testing the activity against insects and arachnids as a 10.000 ppm solution in a mixture of 35% acetone and water, which was diluted with water, if needed.

A Sieva lima bean leaf expanded to 7-8 cm in length is dipped in the test solution with agitation for 3 seconds and allowed to dry in a hood. The leaf is then placed in a 100×10 mm petri dish containing a damp filter paper on the bottom and ten 2nd instar caterpillars. At 5 days, observations are made of mortality, reduced feeding, or any interference with normal molting.

Bean aphid (aphis fabae)

The active compounds were formulated in 50:50 acetone:water and 100 ppm Kinetic® surfactant.

Nasturtium plants grown in Metro mix in the 1^{st} leaf-pair stage (variety ‘Mixed Jewle’) were infested with approximately 2-30 laboratory-reared aphids by placing infested cut plants on top of the test plants. The cut plants were removed after 24 hr. Each plant was dipped into the test solution to provide complete coverage of the foliage, stem, protruding seed surface and surrounding cube surface and allowed to dry in the fume hood. The treated plants were kept at about 25° C. with continuous fluorescent light. Aphid mortality was determined after 3 days.

Cotton aphid (aphis gossypii)

The active compounds were formulated in 50:50 acetone:water and 100 ppm Kinetic® surfactant.

Cotton plants at the cotyledon stage (one plant per pot) were infested by placing a heavily infested leaf from the main colony on top of each cotyledon. The aphids were allowed to transfer to the host plant overnight, and the leaf used to transfer the aphids was removed. The cotyledons were dipped in the test solution and allowed to dry. After 5 days, mortality counts were made.

In this test, compounds I-A.9, I-A.26, I-A.43, I-A.47, I-A.48, I-A.49, I-A.50, I-B.2, I-B.3, I-B.6, I-B.19, and I-B.115 at 300 ppm showed over 90% mortality in comparison with untreated controls.

Green Peach Aphid (myzus persicae)

The active compounds were formulated in 50:50 acetone:water and 100 ppm Kinetic® surfactant.

Pepper plants in the 2^{nd} leaf-pair stage (variety ‘California Wonder’) were infested with approximately 40 laboratory-reared aphids by placing infested leaf sections on top of the test plants. The leaf sections were removed after 24 hr. The leaves of the intact plants were dipped into gradient solutions of the test compound and allowed to dry. Test plants were maintained under fluorescent light (24 hour photoperiod) at about 25° C. and 20-40% relative humidity. Aphid mortality on the treated plants, relative to mortality on check plants, was determined after 5 days.

In this test, compounds I-A.9, I-A.10, I-A.27, I-A.29, I-A.30, I-A.43 I-A.48, I-A.49, I-A.50, I-B.2, I-B.3, I-B.6, I-B.19, I-B.116 at 300 ppm showed over 90% mortality in comparison with untreated controls.

Silverleaf whitefly (bemisia argentifolii)

The active compounds were formulated in 50:50 acetone:water and 100 ppm Kinetic® surfactant.

Selected cotton plants were grown to the cotyledon state (one plant per pot). The cotyledons were dipped into the test solution to provide complete coverage of the foliage and placed in a well-vented area to dry. Each pot with treated seedling was placed in a plastic cup and 10 to 12 whitefly adults (approximately 3-5 day old) were introduced. The cups were covered with a re-usable screened lid (150 micron mesh polyester screen PeCap from Tetko Inc). Test plants were maintained in the holding room at about 25° C. and 20-40% relative humidity for 3 days avoiding direct exposure to the fluorescent light (24 hour photoperiod) to prevent trapping of heat inside the cup. Mortality was assessed 3 days after treatment of the plants.

In this test, compounds I-A.19, I-A.43, I-A.48, I-A.49, I-A.50, and I-B.116 at 300 ppm showed over 90% mortality compared to untreated controls.

Yellowfever mosquitos (aedes aegypti)

The test compound (1 Vol % in acetone) was applied to water in glass dishes containing 4th instar aedes aegypti. The test dishes were maintained at about 25° C. and observed daily for mortality. Each test weas replicated in 3 test dishes.

In this test, compound I-B.23 at 50 ppm after 6 days showed over 90% mortality compared to untreated controls.

Orchid Thrips (dichromothrips corbetti)

The test compound was diluted to a concentration of 300 or 500 ppm in a 1:1 mixture of acetone:water plus 0.01 % Kinetic® surfactant.

Thrips potency was evaluated by using a floral-immersion technique. Plastic petri dishes were used as test arenas. All petals of individual orchid flowers were dipped into the treatment solution for approximately 3 seconds and allowed to dry for 2 hours. Treated flowers were placed into individual petri dishes along with 10-15 adult thrips. The petri dishes were covered with lids and held under continuous light and a temperature of about 28° C. for 4 days. The numbers of live thrips were counted on each flower, and along inner walls of each petri dish. The level of thrips mortality was extrapolated from pre-treatment thrips numbers.

In this test, compound I-B.2 at 500 ppm and compound I-B.142 at 300 ppm showed over 90% mortality compared to untreated controls.

1-9. (canceled)

10. A method for combating or controlling insects, arachnids or nematodes comprising contacting an insect, arachnid or nematode or their food supply, habitat or breeding grounds with a pesticidally effective amount of at least one compound of formula I or a composition comprising at least one compound of formula I: 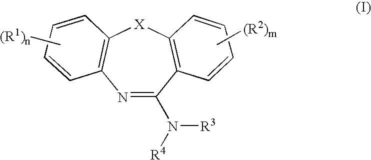
wherein
X is sulfur, oxygen, sulfinyl (S═O), sulfonyl (SO₂), NR^{a}, or CR^{b}R^{c};
R^{a} is hydrogen, C₁-C₆-alkyl, C₂-C₆-alkenyl, or C₂-C₆-alkynyl, wherein the carbon atoms in these groups may be substituted by 1 to 3 groups R^{#} wherein
R^{#} is halogen, cyano, nitro, hydroxy, mercapto, amino, C₁-C₆-alkylcarbonylamino, carboxyl, C₁-C₆-alkyl, C₁-C₆-alkoxy, C₂-C₆-alkenyloxy, C₂-C₆-alkynyloxy, C₁-C₆-haloalkoxy, or C₁-C₆-alkylthio;
phenyl or benzyl, each unsubstituted or substituted with any combination of 1 to 5 halogen, 1 to 3 C₁-C₆-alkyl, C₁-C₆-haloalkyl, C₁-C₆-alkylthio, C₁-C₆-haloalkylthio, C₁-C₆-alkoxy or C₁-C₆-haloalkoxy groups;
R^{b}, R^{c} are each independently hydrogen, C₁-C₆-alkyl, C₂-C₆-alkenyl, C₂-C₆-alkinyl, C₁-C₆-hydroxyalkyl, wherein the carbon atoms in these groups may be substituted by 1 to 3 groups R^{#}, or
phenyl, unsubstituted or substituted with any combination of 1 to 5 halogen, 1 to 3 C₁-C₆-alkyl, C₁-C₆-haloalkyl, C₁-C₆-alkoxy or C₁-C₆-haloalkoxy groups, or
CR^{b}R^{c} represents C═O or C═CR^{j}R^{k}, wherein R^{j} and R^{k} each independently are hydrogen, halogen, C₁-C₆-alkyl, C₁-C₆-haloalkyl, or C₃-C₆-cycloalkyl;
R¹, R² are each independently halogen, hydroxy, mercapto, amino, cyano, nitro, C₁-C₆-alkyl, C₁-C₆-alkoxy, C₁-C₆-alkylamino, di(C₁-C₆-alkyl)amino, C₁-C₈-alkylthio, C₂-C₆-alkenyl, C₂-C₆-alkenyloxy, C₂-C₆-alkenylamino, C₂-C₆-alkenylthio, C₂-C₆-alkynyl, C₂-C₆-alkynyloxy, C₂-C₆-alkynylamino, C₂-C₆-alkynylthio, C₁-C₆-alkylsulfonyl, C₁-C₆-alkylsulfoxyl, C₂-C₆-alkenylsulfonyl, C₂-C₆-alkynylsulfoxyl, formyl, C₁-C₆-alkylcarbonyl, hydroxycarbonyl, C₁-C₆-alkoxycarbonyl, carbonyloxy, C₁-C₆-alkylcarbonyloxy, phenyloxy, C₁-C₆-alkylcarbonylamino, C(O)NR^{d}R^{e}, or (SO₂)NR^{d}R^{e}, wherein the carbon atoms in the aliphatic and aromatic groups may be substituted by 1 to 3 groups R^{#} and wherein R^{d} and R^{e} are each independently groups as listed for R^{a}; or
C(═NOR^{f})-Gₚ-R^{f′}, wherein R^{f′} and R^{f} are each independently hydrogen or C₁-C₆-alkyl, G is oxygen, sulfur or NR^{f} and p is 0 or 1; or
a mono- or bicyclic 5- to 10-membered aromatic ring system which may contain 1 to 4 heteroatoms selected from oxygen, sulfur and nitrogen and which is unfused or fused to the aromatic group to which it is bonded and which, when unfused, is bonded directly or through an oxygen, sulfur, C₁-C₆-alkyl, or C₁-C₆-alkoxy linkage, and which is unsubstituted or substituted with any combination of 1 to 5 groups R^{#}; or
C₃-C₁₂-cycloalkyl, which is bonded directly or through an oxygen, sulfur or C₁-C₆-alkyl linkage, and which is unsubstituted or substituted with any combination of 1 to 5 groups R^{#};
R³, R⁴are each independently hydrogen, C₁-C₆-alkyl, C₁-C₆-haloalkyl, C₁-C₆-alkylamino, C₁-C₆-alkoxy, C₃-C₆-cycloalkyl, wherein the carbon atoms in these groups may be substituted with any combination of 1 to 3 groups R^{#}, or C(O)R^{g}, C(O)NR^{h}Rⁱ, or C(S)NR^{h}Rⁱ,
R^{g} is hydrogen, C₁-C₆-alkyl, C₁-C₆-alkoxy, or
phenyl or benzyl, each unsubstituted or substituted with any combination of 1 to 5 halogen, 1 to 3 C₁-C₆-alkyl, C₁-C₆-haloalkyl, C₁-C₆-alkylthio, C₁-C₆-haloalkylthio, C₁-C₆-alkoxy or C₁-C₆-haloalkoxy groups;
R^{h}, Rⁱ are each independently groups as listed for R^{a};
or R³ and R⁴ together with the nitrogen atom to which they are attached form a saturated or partially saturated mono- or bicyclic 5- to 10-membered ringsystem containing 1 to 3 heteroatoms selected from nitrogen and oxygen or 5-membered hetaryl containing 1 to 4 nitrogen atoms, wherein the carbon and/or nitrogen atoms in the saturated, partially saturated or aromatic rings are unsubstituted or substituted with any combination of 1 to 4 groups selected from amino, C₁-C₆-alkyl, C₂-C₆-alkenyl, C₂-C₆-alkynyl, C₁-C₆-alkoxy, C₂-C₆-alkenyloxy, C₂-C₆-alkynyloxy, C₁-C₆-alkylthio, C₂-C₆-alkenylthio, C₂-C₆-alkynylthio, C₁-C₆-alkylamino, di(C₁-C₆-alkyl)amino, C₂-C₆-alkenylamino, C₂-C₆-alkynylamino, C₁-C₆-hydroxyalkyl, hydroxycarbonyl-C₁-C₄-alkyl, C₁-C₆-alkoxycarbonyl-C₁-C₄-alkyl, formyl-C₁-C₄-alkyl, formyl-C₁-C₄-alkoxy, C₁-C₆-alkylcarbonyl-C₁-C₄-alkoxy, C₃-C₆-cycloalkyl, which is bonded directly or via an oxygen, sulfur or C₁-C₆-alkyl linkage, and C₅-C₈-cycloalkenyl, wherein the carbon atoms in these aliphatic groups can be substituted by 1 to 4 groups selected from halogen, cyano, hydroxy and nitro; or phenyl or benzyl which may be substituted by halogen, C₁-C₄-alkyl or C₁-C₄-haloalkyl; or
R³ and R⁴ together form the chains —(CH₂)₂N⁺(O⁻)(CH₂)₂— or —(CH₂)₃N⁺(O⁻)(CH₂)₂—;
m is 0, 1, 2, 3 or 4;
n is 0, 1, 2, 3 or 4;
or the enantiomers or diastereomers, salts or esters thereof.

11. A method for protecting growing plants from attack or infestation by insects, arachnids or nematodes comprising contacting a plant, or soil or water in which the plant is growing, with a pesticidally effective amount of at least one compound of formula I or a composition comprising at least one compound of formula I: 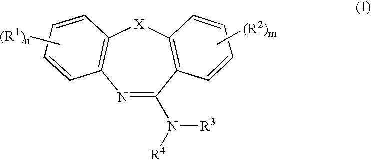
wherein
X is sulfur, oxygen, sulfinyl (S═O), sulfonyl (SO₂), NR^{a}, or CR^{b}R^{c};
R^{a} is hydrogen, C₁-C₆-alkyl, C₂-C₆-alkenyl, or C₂-C₆-alkynyl, wherein the carbon atoms in these groups may be substituted by 1 to 3 groups R^{#} wherein
R^{#} is halogen, cyano, nitro, hydroxy, mercapto, amino, C₁-C₆-alkylcarbonylamino, carboxyl, C₁-C₆-alkyl, C₁-C₆-alkoxy, C₂-C₆-alkenyloxy, C₂-C₆-alkynyloxy, C₁-C₆-haloalkoxy, or C₁-C₆-alkylthio;
phenyl or benzyl, each unsubstituted or substituted with any combination of 1 to 5 halogen, 1 to 3 C₁-C₆-alkyl, C₁-C₆-haloalkyl, C₁-C₆-alkylthio, C₁-C₆-haloalkylthio, C₁-C₆-alkoxy or C₁-C₆-haloalkoxy groups;
R^{b}, R^{c} are each independently hydrogen, C₁-C₆-alkyl, C₂-C₆-alkenyl, C₂-C₆-alkinyl, C₁-C₆-hydroxyalkyl, wherein the carbon atoms in these groups may be substituted by 1 to 3 groups R^{#}, or
phenyl, unsubstituted or substituted with any combination of 1 to 5 halogen, 1 to 3 C₁-C₆-alkyl, C₁-C₆-haloalkyl, C₁-C₆-alkoxy or C₁-C₆-haloalkoxy groups, or
CR^{b}R^{c} represents C═O or C=CR^{j}R^{k}, wherein R^{j} and R^{k} each independently are hydrogen, halogen, C₁-C₆-alkyl, C₁-C₆-haloalkyl, or C₃-C₆-cycloalkyl;
R¹, R²are each independently halogen, hydroxy, mercapto, amino, cyano, nitro, C₁-C₆-alkyl, C₁-C₆-alkoxy, C₁-C₆-alkylamino, di(C₁-C₆-alkyl)amino, C₁-C₈-alkylthio, C₂-C₆-alkenyl, C₂-C₆-alkenyloxy, C₂-C₆-alkenylamino, C₂-C₆-alkenylthio, C₂-C₆-alkynyl, C₂-C₆-alkynyloxy, C₂-C₆-alkynylamino, C₂-C₆-alkynylthio, C₁-C₆-alkylsulfonyl, C₁-C₆-alkylsulfoxyl, C₂-C₆-alkenylsulfonyl, C₂-C₆-alkynylsulfoxyl, formyl, C₁-C₆-alkylcarbonyl, hydroxycarbonyl, C₁-C₆-alkoxycarbonyl, carbonyloxy, C₁-C₆-alkylcarbonyloxy, phenyloxy, C₁-C₆-alkylcarbonylamino, C(O)NR^{d}R^{e}, or (SO₂)NR^{d}R^{c}, wherein the carbon atoms in the aliphatic and aromatic groups may be substituted by 1 to 3 groups R^{#} and wherein R^{d} and R^{e} are each independently groups as listed for R^{a}; or
C(═NOR^{f})-Gₚ-R^{f′}, wherein R^{f′} and R^{f} are each independently hydrogen or C₁-C₆-alkyl, G is oxygen, sulfur or NR^{f} and p is 0 or 1; or
a mono- or bicyclic 5- to 10-membered aromatic ring system which may contain 1 to 4 heteroatoms selected from oxygen, sulfur and nitrogen and which is unfused or fused to the aromatic group to which it is bonded and which, when unfused, is bonded directly or through an oxygen, sulfur, C₁-C₆-alkyl, or C₁-C₆-alkoxy linkage, and which is unsubstituted or substituted with any combination of 1 to 5 groups R^{#}; or
C₃-C₁₂-cycloalkyl, which is bonded directly or through an oxygen, sulfur or C₁-C₆-alkyl linkage, and which is unsubstituted or substituted with any combination of 1 to 5 groups R^{#};
R³, R⁴ are each independently hydrogen, C₁-C₆-alkyl, C₁-C₆-haloalkyl, C₁-C₆-alkylamino, C₁-C₆-alkoxy, C₃-C₆-cycloalkyl, wherein the carbon atoms in these groups may be substituted with any combination of 1 to 3 groups R^{#}, or C(O)R^{g}, C(O)NR^{h}Rⁱ, or C(S)NR^{h}Rⁱ,
R^{g} is hydrogen, C₁-C₆-alkyl, C₁-C₆-alkoxy, or
phenyl or benzyl, each unsubstituted or substituted with any combination of 1 to 5 halogen, 1 to 3 C₁-C₆-alkyl, C₁-C₆-haloalkyl, C₁-C₆-alkylthio, C₁-C₆-haloalkylthio, C₁-C₆-alkoxy or C₁-C₆-haloalkoxy groups;
R^{h}, Rⁱ are each independently groups as listed for R^{a};
or R³ and R⁴ together with the nitrogen atom to which they are attached form a saturated or partially saturated mono- or bicyclic 5- to 10-membered ringsystem containing 1 to 3 heteroatoms selected from nitrogen and oxygen or 5-membered hetaryl containing 1 to 4 nitrogen atoms, wherein the carbon and/or nitrogen atoms in the saturated, partially saturated or aromatic rings are unsubstituted or substituted with any combination of 1 to 4 groups selected from amino, C₁-C₆-alkyl, C₂-C₆-alkenyl, C₂-C₆-alkynyl, C₁-C₆-alkoxy, C₂-C₆-alkenyloxy, C₂-C₆-alkynyloxy, C₁-C₆-alkylthio, C₂-C₆-alkenylthio, C₂-C₆-alkynylthio, C₁-C₆-alkylamino, di(C₁-C₆-alkyl)amino, C₂-C₆-alkenylamino, C₂-C₆-alkynylamino, C₁-C₆-hydroxyalkyl, hydroxycarbonyl-C₁-C₄-alkyl, C₁-C₆-alkoxycarbonyl-C₁-C₄-alkyl, formyl-C₁-C₄-alkyl, formyl-C₁-C₄-alkoxy, C₁-C₆-alkylcarbonyl-C₁-C₄-alkoxy, C₃-C₆-cycloalkyl, which is bonded directly or via an oxygen, sulfur or C₁-C₆-alkyl linkage, and C₅-C₈-cycloalkenyl, wherein the carbon atoms in these aliphatic groups can be substituted by 1 to 4 groups selected from halogen, cyano, hydroxy and nitro; or
phenyl or benzyl which may be substituted by halogen, C₁-C₄-alkyl or C₁-C₄-haloalkyl; or
R³ and R⁴ together form the chains —(CH₂)₂N⁺(O⁻)(CH₂)₂— or —(CH₂)₃N⁺(O⁻)(CH₂)₂—;
m is 0, 1, 2, 3 or 4;
n is 0, 1, 2, 3 or 4;
or the enantiomers or diastereomers, salts or esters thereof.

12. Compounds of formula I-A 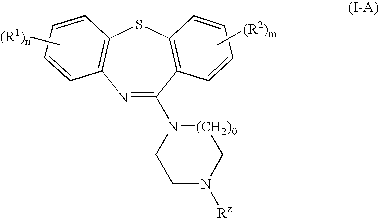
wherein
R¹, R² are each independently halogen, hydroxy, mercapto, amino, cyano, nitro, C₁-C₆-alkyl, C₁-C₆-alkoxy; C₁-C₆-alkylamino, di(C₁-C₆-alkyl)amino, C₁-C₈-alkylthio, C₂-C₆-alkenyl, C₂-C₆-alkenyloxy, C₂-C₆-alkenylamino, C₂-C₆-alkenylthio, C₂-C₆-alkynyl, C₂-C₆-alkynyloxy, C₂-C₆-alkynylamino, C₂-C₆-alkynylthio, C₁-C₆-alkylsulfonyl, C₂-C₆-alkenylsulfonyl, formyl, or C₁-C₆-alkylcarbonyl, wherein the carbon atoms in the aliphatic and aromatic groups may be substituted by 1 to 3 groups selected from halogen, cyano, nitro, hydroxy, mercapto, amino, C₁-C₆-alkyl, C₁-C₆-alkoxy, C₂-C₆-alkenyloxy, C₂-C₆-alkynyloxy, C₁-C₆-haloalkoxy, or C₁-C₆-alkylthio;
R^{z} is hydrogen, C₁-C₆-alkyl, C₂-C₆-alkenyl, C₂-C₆-alkynyl, C₁-C₆-hydroxyalkyl, C₃-C₆-cycloalkyl, C₃-C₆-cycloalkyl-C₁-C₆-alkyl, or C₅-C₈-cycloalkenyl, wherein the carbon atoms in these aliphatic groups can be substituted by 1 to 4 groups selected from halogen, cyano, hydroxy and nitro; and wherein the group [N—R^{z}] may be present as amine oxide [N⁺(O⁻)—R^{z}];
m is 1, 2, 3, or 4;
n is 1, 2, 3, or 4; and
o is 1 or 2.

13. Compounds of formula I-A according to claim 12 wherein R¹ and R² each independently are halogen, C₁-C₆-alkyl, C₁-C₆-haloalkyl, methoxy, C₁-C₆-haloalkoxy, C₁-C₈-alkylthio, C₁-C₆-haloalkylthio, C₂-C₆-alkenylthio, or C₂-C₆-alkynylthio.

14. Compounds of formula I-B 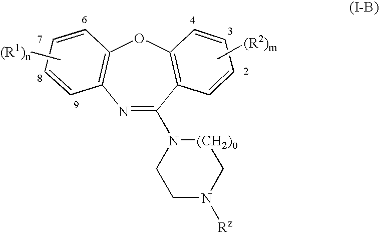
wherein
R^{z} is hydrogen, C₁-C₆-alkyl, C₂-C₆-alkenyl, C₂-C₆-alkynyl, C₁-C₆-hydroxyalkyl, C₃-C₆-cycloalkyl, C₃-C₆-cycloalkyl-C₁-C₆-alkyl, or C₅-C₈-cycloalkenyl, wherein the carbon atoms in these aliphatic groups can be substituted by 1 to 4 groups selected from halogen, cyano, hydroxy and nitro; and wherein the group [N—R^{z}] may be present as amine oxide [N⁺(O⁻)—R^{z}];
m is 1, 2, 3, or 4;
n is 1, 2, 3, or 4; and
o is 1 or 2
and R¹ and R² each independently are halogen, C₁-C₆-alkyl, C₁-C₆-haloalkyl, methoxy, C₁-C₆-haloalkoxy, C₁-C₈-alkylthio, C₁-C₆-haloalkylthio, C₂-C₆-alkenylthio, or C₂-C₆-alkynylthio, with the proviso that
when R¹ is 2-chloro then R² is not 8-chloro or 8-methoxy; and
when R¹ is 4-chloro then R² is not 8-chloro; and
when R¹ is 4-methyl then R² is not 7-, 8-, or 9-chloro.

15. Compounds of formula I-C 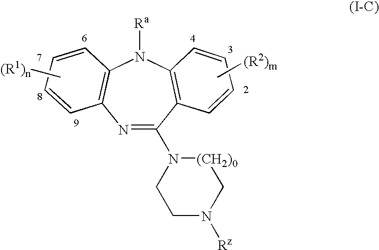
wherein R^{a} is hydrogen or C₁-C₆-alkyl and
R^{z} is hydrogen, C₁-C₆-alkyl, C₂-C₆-alkenyl, C₂-C₆-alkynyl, C₁-C₆-hydroxyalkyl, C₃-C₆-cycloalkyl, C₃-C₆-cycloalkyl-C₁-C₆-alkyl, or C₅-C₈-cycloalkenyl, wherein the carbon atoms in these aliphatic groups can be substituted by 1 to 4 groups selected from halogen, cyano, hydroxy and nitro; and wherein the group [N—R^{z}] may be present as amine oxide [N⁺(O⁻)—R^{z}];
m is 1, 2, 3, or 4;
n is 1, 2, 3, or 4;and
o is 1 or 2
and R¹ and R² each independently are halogen, C₁-C₆-alkyl, C₁-C₆-haloalkyl, methoxy, C₁-C₆-haloalkoxy, C₁-C₈-alkylthio, C₁-C₆-haloalkylthio, C₂-C₆-alkenylthio, or C₂-C₆-alkynylthio, with the proviso that
not both of R¹ or R² are halogen and
when R¹ is 2-chloro then R² is not 8-methyl, 8-methylthio, or 8-methoxy; and
when R¹ is 2-methoxy, then R² is not 8-chloro; and
when R¹ is 2-methyl then R² is not 8-chloro.

16. Compounds of formula I-D 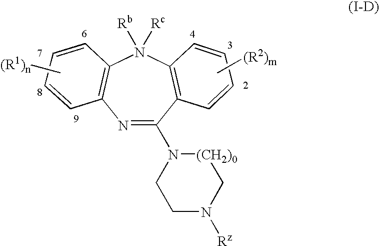
wherein R^{b} and R^{c} are each independently hydrogen, methyl or CR^{b}R^{c} represents C═CH₂, and
R^{z} is hydrogen, C₁-C₆-alkyl, C₂-C₆-alkenyl, C₂-C₆-alkynyl, C₁-C₆-hydroxyalkyl, C₃-C₆-cycloalkyl, C₃-C₆-cycloalkyl-C₁-C₆-alkyl, or C₅-C₈-cycloalkenyl, wherein the carbon atoms in these aliphatic groups can be substituted by 1 to 4 groups selected from halogen, cyano, hydroxy and nitro; and wherein the group [N—R^{z}] may be present as amine oxide [N⁺(O⁻)—R^{z}];
m is 1, 2, 3, or 4;
n is 1, 2, 3, or 4; and
o is 1 or 2
and R¹ and R² each independently are halogen, C₁-C₆-alkyl, C₁-C₆-haloalkyl, methoxy, C₁-C₆-haloalkoxy, C₁-C₈-alkylthio, C₁-C₆-haloalkylthio, C₂-C₆-alkenylthio, or C₂-C₆-alkynylthio.

17. Compositions comprising at least one compound of formula I-A as defined in claim 12 or an enantiomer or diastereomer, salt or ester thereof and an agronomically acceptable carrier.

18. Compositions comprising at least one compound of formula I-A as defined in claim 13 or an enantiomer or diastereomer, salt or ester thereof and an agronomically acceptable carrier.

19. Compositions comprising at least one compound of formula I-B as defined in claim 14 or an enantiomer or diastereomer, salt or ester thereof and an agronomically acceptable carrier.

20. Compositions comprising at least one compound of formula I-C as defined in claim 15 or an enantiomer or diastereomer, salt or ester thereof and an agronomically acceptable carrier.

21. Compositions comprising at least one compound of formula I-D as defined in claim 16 or an enantiomer or diastereomer, salt or ester thereof and an agronomically acceptable carrier.
